(19) United States
(12) Patent Application Publication
(10) Pub. No.: US 2026/0084998 A1
(43) Pub. Date: Mar. 26, 2026

(54) ALKALI-FREE GLASS SHEET

(71) Applicant: NIPPON ELECTRIC GLASS CO., LTD., Otsu-shi, Shiga (JP)

(72) Inventor: Mayu NISHIMIYA, Otsu-shi Shiga (JP)

(73) Assignee: NIPPON ELECTRIC GLASS CO., LTD., Otsu-shi, Shiga (JP)

(21) Appl. No.: 19/109,212

(22) PCT Filed: Aug. 28, 2023
(86) PCT No.: PCT/JP2023/030878

§ 371 Date: Mar. 6, 2025

(30) Foreign Application Priority Data
Sep. 12, 2022 (JP) 2022-144406

(51) Int. Cl. C03C 3/093; C03C 3/087; G11B 5/73

(52) U.S. Cl. CPC C03C 3/093; C03C 3/087; G11B 5/73921

(57) ABSTRACT

An alkali-free glass sheet according to the present invention contains, as a glass composition, in mol %, from 60% to 77% of SiO₂, from 8% to 20% of Al₂O₃, from 0% to 10% of B₂O₃, from 0% to 0.5% of Li₂O+Na₂O+K₂O, from 0% to 12% of MgO, from 0% to 12% of CaO, from 0% to 12% of SrO, from 0% to 12% of BaO, from 10% to 25% of MgO+CaO+SrO+BaO, and from 0.1 ppm by mass to 1000 ppm by mass of MoO₃.

### TECHNICAL FIELD

The present invention relates to an alkali-free glass sheet, and particularly relates to an alkali-free glass sheet suitable for an organic EL display or the like.

### BACKGROUND ART

Electronic devices such as organic EL displays are thin, excellent in displaying moving image, and low in power consumption, and are thus used for applications such as displays of flexible devices and mobile phones.

Glass sheets are widely used as substrates of organic EL displays. Glass sheets for this application are mainly required to have the following characteristics, as described in Patent Literature 1.
(1) In order to prevent alkali ions from diffusing into a semiconductor material formed in a heat treatment step, alkali metal oxides are hardly contained, that is, alkali-free glass (glass in which the content of alkali metal oxides in the glass composition is 0.5 mol % or less) is used,
(2) in order to reduce the cost of the glass sheet, the glass sheet is formed by an overflow down-draw method in which the surface quality is easily improved, and the glass sheet is excellent in productivity, particularly excellent in meltability and devitrification resistance, and
(3) in a low temperature poly silicon (LTPS) process and an oxide TFT process, a strain point is high to reduce thermal shrinkage of the glass sheet.

In addition, magnetic recording medium such as magnetic disks and optical disks are used in various information devices.

Glass sheets are widely used as substrates for the magnetic recording medium in place of known aluminum alloy substrates. In recent years, a magnetic recording medium using an energy assisted magnetic recording system, that is, an energy assisted magnetic recording medium has been studied in order to meet the need for a further increase in recording density. For the energy assisted magnetic recording medium, a glass sheet is also used, and a magnetic layer or the like is formed on the surface of the glass sheet. In the energy assisted magnetic recording medium, an ordered alloy having a large magnetic anisotropy coefficient Ku (hereinafter referred to as “high Ku”) is used as a magnetic material of the magnetic layer. A glass sheet used as a substrate for a magnetic recording medium is disclosed in Patent Literature 2.

### CITATION LIST

### Patent Literature

Patent Literature 1: JP2012-106919A
Patent Literature 2: JP2021-086643A

### SUMMARY OF INVENTION

### Technical Problem

Organic EL devices are also widely used in organic EL televisions. There is a strong demand for organic EL televisions to be large and thin, and there is an increasing demand for high-resolution displays such as 8K displays. Thus, glass sheets for these applications are required to have thermal dimensional stability capable of withstanding the demand for high resolution while being increased in size and reduced in thickness. Further, organic EL televisions are required to be low in cost in order to reduce the difference in price from liquid crystal displays, and glass sheets are also required to be low in cost. However, when a glass sheet is increased in size and reduced in thickness, the glass sheet easily warps, and the manufacturing cost increases.

A glass sheet formed by a glass manufacturer undergoes steps such as cutting, annealing, inspection, and cleaning, and during these steps, the glass sheet is loaded into and unloaded from a cassette in which a plurality of shelves are formed. In this cassette, opposite sides of the glass sheet are usually placed on shelves formed on the left and right inner surfaces and held in a horizontal direction. However, a large and thin glass sheet has a large deflection amount. Therefore, when the glass sheet is loaded into the cassette, a part of the glass sheet comes into contact with the cassette and is damaged, or when the glass sheet is unloaded, the glass sheet is likely to swing greatly and become unstable. Since a cassette having such a form is also used by an electronic device manufacturer, a similar problem occurs. To solve this problem, it is effective to increase the Young's modulus of the glass sheet to reduce the deflection amount.

In addition, as described above, in the LTPS or oxide TFT process for obtaining a high-resolution display, it is necessary to increase the strain point of the glass sheet in order to reduce the thermal shrinkage of the large glass sheet.

However, in increasing the Young's modulus and the strain point of the glass sheet, the balance of the glass composition is lost, and the productivity decreases, and particularly, the devitrification resistance remarkably decreases, and the liquidus viscosity increases. Thus, the glass sheet cannot be formed by the overflow down-draw method. In addition, the meltability tends to decrease, the forming temperature of the glass tends to increase, and the life of the formed body tends to be shortened. As a result, the cost of an original sheet for the glass sheet increases.

In addition, the glass sheet for a magnetic recording medium is required to have high rigidity (in other words, Young's modulus) in order not to cause large deformation during high-speed rotation. More specifically, in a disk-shaped magnetic recording medium, information is written and read in the direction of rotation while the medium is rotated at a high speed around the central axis and the magnetic head is moved in the radial direction. In recent years, the number of rotations for increasing the write speed and the read speed has been increasing from 5400 rpm to 7200 rpm and further to 10000 rpm. In a disk-shaped magnetic recording medium, positions for recording information are assigned in advance in accordance with the distance from the central axis. Thus, when the glass sheet is deformed during rotation, a positional deviation of the magnetic head occurs, and accurate reading becomes difficult.

In recent years, a dynamic flying height (DFH) mechanism has been mounted on a magnetic head to achieve a remarkable reduction (that is, reduction in flying height) in the gap between a recording and reproducing element portion of the magnetic head and the surface of the magnetic recording medium, to achieve a further increase in recording density. The DFH mechanism is a mechanism in which a heating unit such as an extremely small heater is provided in the vicinity of the recording and reproducing element portion of the magnetic head, and only the periphery of the element portion is thermally expanded toward a medium surface direction. By providing such a mechanism, the distance between the magnetic head and the magnetic layer of the medium is reduced, and thus a signal of a smaller magnetic particle can be picked up, which enables achievement of an increase in recording density. On the other hand, since the gap between the recording and reproducing element portion of the magnetic head and the surface of the magnetic recording medium becomes extremely small, for example, 2 nm or less, the magnetic head may collide with the surface of the magnetic recording medium even with a slight impact. This tendency becomes more remarkable as the rotation speed becomes higher. Thus, during the high-speed rotation, it is important to prevent the occurrence of warping and flapping (that is, fluttering) of the glass sheet that causes the collision.

Further, in order to increase the degree of ordering (that is, regularity) of the magnetic layer to achieve a high Ku, a base material including a glass sheet may be subjected to a heat treatment at a high temperature of about 800° C. during or before or after formation of the magnetic layer. Since the higher the recording density is, the higher the temperature is required in this heat treatment, the glass sheet is required to have higher heat resistance, that is, a higher strain point than a known glass sheet for a magnetic recording medium. After the magnetic layer is formed, laser irradiation may be performed on the base material including a glass sheet. Such heat treatment and laser irradiation are also aimed at increasing the annealing temperature and coercive force of the magnetic layer containing a FePt-based alloy or the like.

However, as described above, in increasing the Young's modulus and the strain point of the glass sheet, the balance of the glass composition is lost, and the productivity decreases, and particularly, the devitrification resistance remarkably decreases, and the liquidus viscosity increases. Thus, the glass sheet cannot be formed by the overflow down-draw method. In addition, the meltability tends to decrease, the forming temperature of the glass tends to increase, and the life of the formed body tends to be shortened. As a result, the cost of an original sheet for the glass sheet increases. Further, when a low-purity raw material is used to reduce the cost of the original sheet, the ultraviolet light transmittance generally tends to decrease. Thus, among manufacturing steps for a display or a magnetic recording medium, the yield particularly tends to decrease in a laser peeling step.

Therefore, the present invention has been made in view of the above circumstances, and a technical object thereof is to provide an alkali-free glass sheet that is excellent in productivity and sufficiently high in strain point and Young's modulus.

### Solution to Problem

As a result of repeating various experiments, the inventor of the present invention has found that the above technical problem can be solved by strictly regulating the glass composition of an alkali-free glass sheet, and proposes the finding as the present invention.

(1) An alkali-free glass sheet according to the present invention contains, as a glass composition, in mol %, from 60% to 77% of SiO₂, from 8% to 20% of Al₂O₃, from 0% to 10% of B₂O₃, from 0% to 0.5% of Li₂O+Na₂O+K₂O, from 0% to 12% of MgO, from 0% to 12% of CaO, from 0% to 12% of SrO, from 0% to 12% of BaO, from 10% to 25% of MgO+CaO+SrO+BaO, and from 0.1 ppm by mass to 1000 ppm by mass of MoO₃. Here, “Li₂O+Na₂O+K₂O” refers to the total amount of Li₂O, Na₂O, and K₂O. “MgO+CaO+SrO+BaO” refers to the total amount of MgO, CaO, SrO, and BaO.

(2) An alkali-free glass sheet according to the present invention contains, as a glass composition, in mol %, from 65% to 77% of SiO₂, from 10% to 17% of Al₂O₃, from 0% to 9% of B₂O₃, from 0% to 0.5% of Li₂O+Na₂O+K₂O, from 0% to 12% of MgO, from 0% to 12% of CaO, from 0% to 10% of SrO, from 0% to 10% of BaO, from 10% to 25% of MgO+CaO+SrO+BaO, and from 0.1 ppm by mass to 1000 ppm by mass of MoO₃.

(3) It is preferable that, in the above configuration (1) or (2), the glass composition does not substantially contain As₂O₃ and Sb₂O₃, and further contains from 0.001 mol % to 1 mol % of SnO₂. Here, “does not substantially contain As₂O₃” refers to a case where the content of As₂O₃ is 0.05 mol % or less. “Does not substantially contain Sb₂O₃” refers to a case where the content of Sb₂O₃ is 0.05 mol % or less.

(4) It is preferable that, in the above configurations (1) to (3), a mol % ratio Fe₂O₃/MoO₃ is from 0.001 to 1.5 as a glass composition.

(5) It is preferable that, in the above configurations (1) to (4), a mol % ratio TiO₂/MoO₃ is from 0.001 to 1.5 as a glass composition.

(6) It is preferable that, in the above configurations (1) to (5), a Young's modulus is 70 GPa or more, a strain point is 650° C. or higher, and a liquidus temperature is 1400° C. or lower. Here, the “Young's modulus” refers to a value measured by a bending resonance method. Note that, 1 GPa corresponds to about 101.9 Kgf/mm². The “strain point” refers to a value measured based on the method in ASTM C336. The “liquidus temperature” refers to a temperature at which crystals precipitate after a glass powder that has passed through a standard 30-mesh sieve (500 μm) and remained on a 50-mesh sieve (300 μm) is charged into a platinum boat and then kept in a temperature gradient furnace for 24 hours.

(7) It is preferable that, in the above configurations (1) to (6), the strain point is 700° C. or higher.

(8) It is preferable that, in the above configurations (1) to (7), the Young's modulus is more than 75 GPa.

(9) It is preferable that, in the above configurations (1) to (8), a specific Young's modulus is 30 GPa/g-cm³ or more. Here, the “specific Young's modulus” is a value obtained by dividing the Young's modulus by the density.

(10) It is preferable that, in the above configurations (1) to (9), an average thermal expansion coefficient in a temperature range of from 30° C. to 380° C. is from 30×10⁻⁷/° C. to 50×10⁻⁷/° C. Here, the “average thermal expansion coefficient in a temperature range of from 30° C. to 380° C.” can be measured with a dilatometer.

(11) It is preferable that, in the above configurations (1) to (10), an annealing point is 730° C. or higher. Here, the “annealing point” refers to a value measured based on the method in ASTM C336.

(12) It is preferable that, in the above configurations (1) to (11), the liquidus viscosity is 10^{3.5} dPa·s or more. Here, the “liquidus viscosity” refers to a viscosity of glass at a liquidus temperature and can be measured by a platinum sphere pull up method.

(13) It is preferable that the alkali-free glass sheet in the above configurations (1) to (12) is used for an organic EL device.

(14) It is preferable that the alkali-free glass sheet in the above configurations (1) to (12) is used for a magnetic recording medium.

### Advantageous Effects of Invention

With the above configurations, it is possible to provide an alkali-free glass sheet that is excellent in productivity and sufficiently high in strain point and Young's modulus.

### BRIEF DESCRIPTION OF DRAWINGS

FIG. 1: FIG. 1 is a top perspective view showing an example of the shape of a glass substrate for a magnetic recording medium.

### DESCRIPTION OF EMBODIMENTS

An alkali-free glass sheet according to the present invention contains, as a glass composition, from 60% to 77% of SiO₂, from 8% to 20% of Al₂O₃, from 0% to 10% of B₂O₃, from 0% to 0.5% of Li₂O+Na₂O+K₂O, from 0% to 12% of MgO, from 0% to 12% of CaO, from 0% to 12% of SrO, from 0% to 12% of BaO, from 10% to 25% of MgO+CaO+SrO+BaO, and from 0.1 ppm by mass to 1000 ppm by mass of MoO₃. The reason for limiting the content of each component as described above is as follows. Note that, in the description of the content of each component, “%” represents “mol %” unless otherwise indicated. Unless otherwise specified, “from X % to Y %” means X % or more and Y % or less.

SiO₂ is a component that forms a glass network. When the content of SiO₂ is too low, the thermal expansion coefficient increases, and the density increases. Thus, the lower limit amount of SiO₂ is preferably 60%, more preferably 61%, still more preferably 61.5%, still more preferably 62%, still more preferably 62.5%, still more preferably 63%, still more preferably 63.5%, still more preferably 64%, still more preferably 64.5%, still more preferably 65%, still more preferably 65.5%, still more preferably 66%, still more preferably 66.5%, still more preferably 66.8%, still more preferably 67%, still more preferably 67.3%, and particularly preferably 67.5%. On the other hand, when the content of SiO₂ is too high, the Young's modulus decreases, the viscosity in high temperature further increases, the amount of heat required at the time of melting increases, the melting cost increases, and the introduced raw material of SiO₂ remains unmolten, which may cause a decrease in yield. In addition, devitrified crystals such as cristobalite tend to precipitate, and the liquidus viscosity tends to decrease. Thus, the upper limit amount of SiO₂ is preferably 77%, more preferably 76.5%, still more preferably 76%, still more preferably 75.5%, still more preferably 75%, still more preferably 74.5%, still more preferably 74%, still more preferably 73.5%, still more preferably 73%, still more preferably 72.5%, still more preferably 72%, still more preferably 71.5%, still more preferably 71%, still more preferably 70.5%, and particularly preferably 70%.

Al₂O₃ is a component that forms a glass network, a component that increases the Young's modulus, and is a component that further increases the strain point. When the content of Al₂O₃ is too low, the Young's modulus tends to decrease, and the strain point tends to decrease. Thus, the lower limit amount of Al₂O₃ is preferably 8%, more preferably 8.5%, still more preferably 9%, still more preferably 9.5%, still more preferably 10%, still more preferably 10.5%, still more preferably 11%, still more preferably 11.5%, and particularly preferably 12%. On the other hand, when the content of Al₂O₃ is too high, devitrified crystals such as mullite tend to precipitate, and the liquidus viscosity tends to decrease. Thus, the upper limit amount of Al₂O₃ is preferably 20%, more preferably 19%, still more preferably 18.5%, still more preferably 18%, still more preferably 17.5%, still more preferably 17%, still more preferably 16.5%, still more preferably 16%, still more preferably 15.5%, and particularly preferably 15%.

B₂O₃ is a component that improves the chipping resistance, and can also provide the effects of improving the meltability and the devitrification resistance. Thus, the lower limit amount of B₂O₃ is preferably 0%, more preferably more than 0%, still more preferably 0.1%, still more preferably 0.2%, still more preferably 0.3%, still more preferably 0.4%, still more preferably 0.5%, still more preferably 0.6%, still more preferably 0.8%, still more preferably 0.9%, still more preferably 1%, still more preferably 1.2%, still more preferably 1.5%, still more preferably 1.8%, still more preferably 2%, and particularly preferably more than 2%. On the other hand, when the content of B₂O₃ is too high, the Young's modulus and the strain point tend to decrease. Thus, the upper limit amount of B₂O₃ is preferably 10%, more preferably 9.5%, still more preferably 9%, still more preferably 8.5%, still more preferably 8%, still more preferably 7.5%, still more preferably 7%, still more preferably 6.5%, still more preferably 6%, and particularly preferably 5.5%.

Li₂O, Na₂O, and K₂O are components inevitably mixed from the glass raw material, and the total amount thereof is from 0% to 0.5%, preferably from 0% to 0.1%, more preferably from 0% to 0.09%, still more preferably from 0.005% to 0.08%, still more preferably from 0.008% to 0.06%, and particularly preferably from 0.01% to 0.05%. When the total amount of Li₂O, Na₂O, and K₂O is too high, alkali ions may diffuse into a semiconductor material formed during a heat treatment step. Note that, the individual contents of Li₂O, Na₂O, and K₂O are each preferably from 0% to 0.3%, more preferably from 0% to 0.1%, still more preferably from 0% to 0.08%, still more preferably from 0% to 0.07%, still more preferably from 0% to 0.05%, and particularly preferably from 0.001% to 0.04%.

MgO is a component that remarkably increases the Young's modulus among alkaline earth metal oxides. When the content of MgO is too low, the meltability and the Young's modulus tend to decrease. Thus, the lower limit amount of MgO is preferably 0%, more preferably 0.5%, still more preferably 10%, still more preferably 1.5%, still more preferably 2%, still more preferably 2.5%, still more preferably 3%, and particularly preferably 3.5%. On the other hand, when the content of MgO is too high, devitrified crystals such as mullite tend to precipitate, and the liquidus viscosity tends to decrease. Thus, the upper limit amount of MgO is preferably 12%, more preferably 11.5%, still more preferably 11%, still more preferably 10.5%, still more preferably 10%, still more preferably 9.8%, still more preferably 9.5%, still more preferably 9.3%, still more preferably 9%, still more preferably 8.8%, still more preferably 8.5%, still more preferably 8.3%, still more preferably 8%, still more preferably 7.8%, still more preferably 7.5%, still more preferably 7.3%, still more preferably 7%, and particularly preferably 6.8%.

CaO is a component that decreases the viscosity in high temperature and remarkably improves the meltability without lowering the strain point. It is also a component that increases the Young's modulus. When the content of CaO is too low, the meltability tends to decrease. Thus, the lower limit amount of CaO is preferably 0%, more preferably 0.5%, still more preferably 1%, still more preferably 1.5%, still more preferably 2%, still more preferably 2.5%, still more preferably 3%, and particularly preferably 3.5%. On the other hand, when the content of CaO is too high, the liquidus temperature increases. Thus, the upper limit amount of CaO is preferably 12%, more preferably 11.5%, still more preferably 11%, still more preferably 10.5%, still more preferably 10%, still more preferably 9.8%, still more preferably 9.5%, still more preferably 9.3%, still more preferably 9%, still more preferably 8.8%, still more preferably 8.5%, still more preferably 8.3%, still more preferably 8%, still more preferably 7.8%, still more preferably 7.5%, still more preferably 7.3%, still more preferably 7%, and particularly preferably 6.8%.

SrO is a component that improves the devitrification resistance, decreases the viscosity in high temperature, and improves the meltability without lowering the strain point. It is also a component that reduces a decrease in liquidus viscosity. Thus, the lower limit amount of SrO is preferably 0%, more preferably 0.5%, still more preferably 1%, still more preferably 1.5%, still more preferably 2%, still more preferably 2.5%, still more preferably 3%, and particularly preferably 3.5%. On the other hand, when the content of SrO is too high, the thermal expansion coefficient and the density tend to increase. Thus, the upper limit amount of SrO is preferably 12%, more preferably 11%, still more preferably 10%, still more preferably 9%, still more preferably 8%, still more preferably 7%, still more preferably 6%, still more preferably 5.5%, still more preferably 5.3%, still more preferably 5%, still more preferably 4.8%, still more preferably 4.5%, still more preferably 4.3%, and particularly preferably 4%.

BaO is a component that improves the devitrification resistance. Thus, the lower limit amount of BaO is preferably 0%, more preferably 0.5%, still more preferably 1%, still more preferably 1.5%, still more preferably 2%, still more preferably 2.5%, still more preferably 3%, and particularly preferably 3.5%. On the other hand, when the content of BaO is too high, the Young's modulus tends to decrease, and the density tends to increase. As a result, the specific Young's modulus increases, and the glass sheet tends to warp. Thus, the upper limit amount of BaO is preferably 12%, more preferably 11%, still more preferably 10%, still more preferably 9%, still more preferably 8%, still more preferably 7%, still more preferably 6%, still more preferably 5.5%, still more preferably 5.3%, still more preferably 5%, still more preferably 4.8%, still more preferably 4.5%, still more preferably 4.3%, and particularly preferably 4%.

MgO, CaO, SrO, and BaO are components that increase the density and the thermal expansion coefficient. When the content of MgO+CaO+SrO+BaO is too low, the thermal expansion coefficient tends to decrease. Thus, the lower limit amount of MgO+CaO+SrO+BaO is preferably 10%, more preferably 10.2%, still more preferably 10.5%, still more preferably 10.8%, still more preferably 11%, still more preferably 11.3%, still more preferably 11.5%, still more preferably 11.8%, and particularly preferably 12%. On the other hand, when the content of MgO+CaO+SrO+BaO is too high, the density tends to increase. Thus, the upper limit amount of MgO+CaO+SrO+BaO is preferably 25%, more preferably 24.5%, still more preferably 24%, still more preferably 23.5%, still more preferably 23%, still more preferably 22.5%, and particularly preferably 22%.

MoO₃ is a component that absorbs ultraviolet light (light having a wavelength of from 200 nm to 300 nm). In addition, MoO₃ is a component that reduces the amount of water in the glass. In particular, by melting the raw material batch by electric melting and heating and by incorporating MoO₃, the amount of water in the glass can be further reduced. When the amount of water in the glass is reduced, the liquidus viscosity and the strain point are increased, and the devitrification resistance and the heat resistance of the glass can be improved. The lower limit amount of MoO₃ is preferably 0.1 ppm by mass, more preferably 0.4 ppm by mass, still more preferably 0.8 ppm by mass, still more preferably 1 ppm by mass, still more preferably 2 ppm by mass, still more preferably 3 ppm by mass, still more preferably 5 ppm by mass, still more preferably 7 ppm by mass, still more preferably 9 ppm by mass, still more preferably 10 ppm by mass, still more preferably 12 ppm by mass, still more preferably 15 ppm by mass, still more preferably 17 ppm by mass, still more preferably 18 ppm by mass, still more preferably 19 ppm by mass, still more preferably 20 ppm by mass, still more preferably 21 ppm by mass, still more preferably 22 ppm by mass, and particularly preferably 25 ppm by mass. On the other hand, when the content of MoO₃ is too high, the ultraviolet light transmittance decreases, and the yield tends to decrease particularly in a laser peeling step among manufacturing steps for a display. Thus, the upper limit amount of MoO₃ is preferably 1000 ppm by mass, more preferably 900 ppm by mass, still more preferably 800 ppm by mass, still more preferably 700 ppm by mass, still more preferably 600 ppm by mass, still more preferably 500 ppm by mass, still more preferably 450 ppm by mass, still more preferably 430 ppm by mass, still more preferably 400 ppm by mass, still more preferably 380 ppm by mass, still more preferably 350 ppm by mass, still more preferably 330 ppm by mass, still more preferably 300 ppm by mass, still more preferably 280 ppm by mass, and particularly preferably 250 ppm by mass.

Suitable content ranges of the respective components can be appropriately combined to obtain a suitable glass composition range, and among them, in order to optimize the effects of the present invention, it is particularly preferable that the glass composition contains, in mol %, from 65% to 77% of SiO₂, from 10% to 17% of AlO₃, from 0% to 9% of B₂O₃, from 0% to 0.5% of Li₂O+Na₂O+K₂O, from 0% to 12% of MgO, from 0% to 12% of CaO, from 0% to 10% of SrO, from 0% to 10% of BaO, from 10% to 25% of MgO+CaO+SrO+BaO, and from 0.1 ppm by mass to 1000 ppm by mass of MoO₃.

In addition to the above components, the following components may be added as an optional component, for example. Note that, the total content of components other than the above components is preferably 10% or less, and particularly 5% or less, from the viewpoint of accurately achieving the effects of the present invention.

P₂O₅ is a component that increases the strain point, and is a component that can remarkably reduce precipitation of alkaline earth aluminosilicate-based devitrified crystals such as anorthite. However, when a large amount of P₂O₅ is contained, the glass tends to undergo phase separation. The content of P₂O₅ is preferably from 0% to 2.5%, more preferably from 0% to 1.5%, still more preferably from 0% to 0.5%, still more preferably from 0% to 0.3%, and particularly preferably from 0% to less than 0.1%.

Fe₂O₃ is a component inevitably mixed from the glass raw material, and is a component that decreases the electrical resistivity. The content of Fe₂O₃ is preferably from 0 mol % to 0.1 mol %, from 0.0001 mol % to 0.09 mol %, particularly preferably from 0.001 mol % to 0.08 mol %. When the content of Fe₂O₃ is too low, the raw material cost tends to increase. On the other hand, when the content of Fe₂O₃ is too high, the electrical resistivity of the molten glass increases, and it is difficult to perform electric melting.

The mol % ratio Fe₂O₃/MoO₃ is a composition ratio related to the transmittance and the strain point. The smaller the mol % ratio, the easier it is to lower the strain point, and the larger the mol % ratio, the easier it is to decrease the transmittance of visible light to ultraviolet light. The mol % ratio Fe₂O₃/MoO₃ is preferably from 0.001 to 1.5, more preferably from 0.005 to 1.4, still more preferably from 0.01 to 1.3, and even more preferably from 0.015 to 1.25.

ZnO is a component that increases the Young's modulus. However, when a large amount of ZnO is contained, the glass tends to undergo devitrification and the strain point tends to decrease. The content of ZnO is preferably from 0% to 3%, more preferably from 0% to 2%, still more preferably from 0% to 1%, still more preferably from 0% to 0.8%, still more preferably from 0% to 0.5%, and particularly preferably from 0% to less than 0.5%.

TiO₂ is a component that lowers the viscosity in high temperature and improves the meltability, and is a component that prevents solarization. However, when a large amount of TiO₂ is contained, the glass is colored, and the transmittance tends to decrease. The content of TiO₂ is preferably from 0% to 2.5%, more preferably from 0.0005% to 1%, still more preferably from 0.001% to 0.5%, and particularly preferably from 0.005% to 0.1%.

The mol % ratio TiO₂/MoO₃ is a composition ratio related to the transmittance and the strain point. The smaller the mol % ratio, the easier it is to lower the strain point, and the larger the mol % ratio, the easier it is to decrease the transmittance of visible light to ultraviolet light. The mol % ratio Fe₂O₃/MoO₃ is preferably from 0.001 to 1.5, more preferably from 0.005 to 1.4, still more preferably from 0.01 to 1.3, and particularly preferably from 0.015 to 1.25.

ZrO₂ is a component that increases the Young's modulus. However, when a large amount of ZrO₂ is contained, the glass tends to undergo devitrification. The content of ZrO₂ is preferably from 0% to 2.5%, more preferably from 0.0005% to 1%, still more preferably from 0.001% to 0.5%, and particularly preferably from 0.005% to 0.1%.

Y₂O₃, Nb₂O₅, and La₂O₃ have a function of increasing the strain point, the Young's modulus, and the like. The total amount and individual content of these components are preferably from 0% to 5%, more preferably from 0% to 1%, still more preferably from 0% to 0.5%, and particularly preferably from more than 0% to less than 0.5%. When the total amount and individual content of Y₂O₃, Nb₂O₅, and La₂O₃ are too high, the density and the raw material cost tend to increase.

SnO₂ is a component having a good fining action in a high temperature range, is a component that increases the strain point, and is a component that decreases the viscosity in high temperature. The content of SnO₂ is preferably from 0% to 1%, from 0.001% to 1%, from 0.01% to 0.5%, and particularly from 0.05% to 0.3%. When the content of SnO₂ is too high, devitrified crystals of SnO₂ tend to precipitate. Note that, when the content of SnO₂ is lower than 0.001%, it is difficult to obtain the above effects.

As described above, SnO₂ is suitable as a fining agent. However, as long as the glass characteristics are not impaired, F, SO₃, C, or a metal powder such as Al or Si may be added up to 5% for each (preferably up to 1%, particularly preferably up to 0.5%), instead of SnO₂ or together with SnO₂, as fining agents. CeO₂, F, and the like can also be added as fining agents up to 5% for each (preferably up to 1%, particularly preferably up to 0.5%).

As₂O₃ and Sb₂O₃ are also effective as fining agents. However, As₂O₃ and Sb₂O₃ are components that increase the burden to the environment. As₂O₃ is also a component that decreases the solarization resistance. Thus, the alkali-free glass sheet according to the present invention preferably does not substantially contain these components.

Cl is a component that facilitates initial melting of a glass batch. In addition, the addition of Cl can facilitate the action of the fining agent. As a result, it is possible to extend the life of the glass manufacturing kiln while reducing the melting cost. However, when the content of Cl is too high, the strain point tends to decrease. Thus, the content of Cl is preferably from 0% to 3%, more preferably from 0.0005% to 1%, and particularly preferably from 0.001% to 0.5%. Note that, as a raw material for introducing Cl, a raw material such as a chloride of an alkaline earth metal oxide, an example being strontium chloride, or aluminum chloride can be used.

The alkali-free glass sheet according to the present invention preferably has the following properties.

The average thermal expansion coefficient in a temperature range of from 30° C. to 380° C. is preferably from 30×10⁻⁷/° C. to 50×10⁻⁷/° C., more preferably from 32×10⁻⁷/° C. to 48×10⁻⁷/° C., still more preferably from 33×10⁻⁷/° C. to 45×10⁻⁷/° C., still more preferably from 34×10⁻⁷/° C. to 44×10⁻⁷/° C., and particularly preferably from 35×10⁻⁷/° C. to 43×10⁻⁷/° C. This makes it easy to match the thermal expansion coefficient of Si used in TFT.

The Young's modulus is preferably 70 GPa or more, more preferably 71 GPa or more, still more preferably 71.5 GPa or more, still more preferably 72 GPa or more, still more preferably 72.5 GPa or more, still more preferably 73 GPa or more, still more preferably 73.5 GPa or more, still more preferably 74 GPa or more, still more preferably 74.5 GPa or more, and particularly preferably 75 GPa or more. When the Young's modulus is too low, defects due to warping of the glass sheet tend to occur. On the other hand, the upper limit thereof is 120 GPa or less, for example.

The specific Young's modulus is preferably 29 GPa/g·cm⁻³ or more, more preferably 29.5 GPa/g·cm⁻³ or more, still more preferably 30 GPa/g·cm⁻³ or more, still more preferably 30.5 GPa/g·cm⁻³ or more, still more preferably 31 GPa/g·cm⁻³ or more, still more preferably 31.3 GPa/g·cm⁻³ or more, still more preferably 31.5 GPa/g·cm⁻³ or more, still more preferably 31.8 GPa/g·cm⁻³ or more, still more preferably 32 GPa/g·cm⁻³ or more, still more preferably 32.3 GPa/g·cm⁻³ or more, and particularly preferably 32.5 GPa/g·cm⁻³ or more. When the specific Young's modulus is too low, defects due to warping of the glass sheet tend to occur. On the other hand, the upper limit thereof is 37 GPa/g·cm⁻³ or less, for example.

The strain point is preferably 650° C. or higher, more preferably 660° C. or higher, still more preferably 670° C. or higher, still more preferably 680° C. or higher, still more preferably 685° C. or higher, still more preferably 690° C. or higher, and particularly preferably 700° C. or higher. This makes it possible to reduce the thermal shrinkage of the glass sheet in the LTPS process. On the other hand, the upper limit thereof is 820° C. or lower, for example.

The annealing point is preferably 680° C. or higher, more preferably 690° C. or higher, still more preferably 700° C. or higher, still more preferably 710° C. or higher, still more preferably 720° C. or higher, still more preferably 730° C. or higher, still more preferably 735° C. or higher, still more preferably 740° C. or higher, and particularly preferably 750° C. or higher. This makes it possible to reduce the thermal shrinkage of the glass sheet in the LTPS process. On the other hand, the upper limit thereof is 900° C. or lower, for example.

The liquidus temperature is preferably 1400° C. or lower, more preferably 1380° C. or lower, still more preferably 1350° C. or lower, still more preferably 1300° C. or lower, still more preferably 1290° C. or lower, still more preferably 1285° C. or lower, still more preferably 1280° C. or lower, still more preferably 1275° C. or lower, and particularly preferably 1270° C. or lower. In addition, the liquidus temperature is preferably 1160° C. or higher, and more preferably 1170° C. or higher. A particularly preferred range for the liquidus temperature is from 1180° C. to 1260° C. This makes it easy to prevent a situation where devitrified crystals are formed during glass manufacturing to decrease the productivity. Further, the glass sheet can be easily formed by the overflow down-draw method, and thus the surface quality of the glass sheet can be easily improved and the manufacturing cost of the glass sheet can be reduced. Note that, the liquidus temperature is an index of the devitrification resistance, and the lower the liquidus temperature is, the better the devitrification resistance is.

The liquidus viscosity is preferably 10^{3.3} dPa·s or more, more preferably 10^{3.4} dPa·s or more, still more preferably 10^{3.5} dPa·s or more, still more preferably 10^{3.6} dPa·s or more, still more preferably 10^{3.7} dPa·s or more, still more preferably 10^{3.8} dPa·s or more, still more preferably 10^{3.9} dPa·s or more, still more preferably 10^{4.0} dPa·s or more, still more preferably 10^{4.1} dPa·s or more, still more preferably 10^{4.2} dPa·s or more, and still more preferably 10^{4.3} dPa·s or more. In addition, the liquidus viscosity is preferably 10^{7.4} dPa·s or less, and more preferably 10^{7.2} dPa·s or less. A particularly preferred range for the liquidus viscosity is from 10^{4.5} dPa·s to 10^{7.0} dPa·s. With the liquidus viscosity within these ranges, devitrification is less likely to occur during forming, and thus the glass sheet is easily formed by the overflow down-draw method. As a result, the surface quality of the glass sheet can be improved, and the manufacturing cost of the glass sheet can be reduced. Note that, the liquidus viscosity is an index of the devitrification resistance and the formability, and the higher the liquidus viscosity is, the higher the devitrification resistance and the formability are.

The temperature at a viscosity in high temperature of 10^{2.5} dPa·s is preferably 1750° C. or lower, more preferably 1730° C. or lower, still more preferably 1710° C. or lower, and particularly preferably 1600° C. or lower. When the temperature at a viscosity in high temperature of 10^{2.5} dPa·s is too high, it is difficult to melt the glass batch, and the manufacturing cost of the glass sheet increases. On the other hand, the lower limit thereof is 1680° C. or higher, for example. Note that, the temperature at a viscosity in high temperature of 10^{2.5} dPa·s corresponds to the melting temperature, and the lower the temperature is, the better the meltability is.

A β-OH value is an index that indicates the amount of water in glass, and, when the β-OH value is decreased, the strain point can be increased. Even when the glass compositions are the same, the smaller the β-OH value is, the smaller the thermal shrinkage at a temperature equal to or lower than the strain point is. The β-OH value is preferably 0.35/mm or less, more preferably 0.30/mm or less, still more preferably 0.28/mm or less, still more preferably 0.25/mm or less, still more preferably 0.22/mm or less, still more preferably 0.20/mm or less, still more preferably 0.19/mm or less, still more preferably 0.18/mm or less, still more preferably 0.17/mm or less, still more preferably 0.16/mm or less, and particularly preferably 0.15/mm or less. Note that, when the β-OH value is too small, the meltability tends to decrease. Thus, the β-OH value is preferably 0.01/mm or more, more preferably 0.03/mm or more, still more preferably 0.05/mm or more, and particularly preferably 0.07/mm or more.

Examples of a method for decreasing the β-OH value include the following. (1) Selecting a raw material having a low water content. (2) Adding a component (MoO₃, Cl, SO₃ or the like) for decreasing the β-OH value to the glass. (3) Decreasing the amount of water in a furnace atmosphere. (4) Performing N₂ bubbling in molten glass. (5) Adopting a small melting furnace. (6) Increasing a flow rate of the molten glass. (7) Adopting an electric melting method.

Note that, the “β-OH value” refers to a value obtained by substituting the transmittance of the glass measured by using FT-IR according to the following Equation 1.

$$β - OH value = ( 1 / X ) log ( {T}_{1} / {T}_{2} ) \qquad [ Math . 1 ]$$

X: sheet thickness (mm)
T₁: transmittance (%) at a reference wavelength of 3846 cm⁻¹
T₂: minimum transmittance (%) near an absorption wavelength of hydroxy groups of 3600 cm⁻¹

The alkali-free glass sheet according to the present invention is preferably formed by an overflow down-draw method. The overflow down-draw method is a method for manufacturing a glass sheet by causing molten glass to overflow from both sides of a heat-resistant forming structure, and drawing and forming the overflowing molten glass downward while joining the overflowing molten glass at a lower end of the forming structure. In the overflow down-draw method, the surface to be the surface of the glass sheet does not come into contact with the forming refractory and is formed in a free surface state. Therefore, it is possible to inexpensively manufacture an unpolished glass sheet with good surface quality, and it is also easy to reduce the thickness thereof.

The alkali-free glass sheet according to the present invention is also preferably formed by a float method. A large glass sheet can be manufactured at a low cost.

When the alkali-free glass sheet according to the present invention is used for a magnetic recording medium, the surface thereof is preferably a polished surface. When the glass surface is polished, a total sheet thickness variation TTV can be reduced. As a result, a magnetic film can be properly formed, which is suitable for a substrate for a magnetic recording medium. On the other hand, when the alkali-free glass sheet is used for an organic EL device, the surface thereof is preferably a fire-polished surface (that is, unpolished surface) formed by the overflow down-draw method.

In the alkali-free glass sheet according to the present invention, the sheet thickness is not particularly limited, and when used for an organic EL device, it is preferably less than 0.7 mm, 0.6 mm or less, less than 0.6 mm, and particularly 0.5 mm or less. As the sheet thickness decreases, the weight of the organic EL device can be reduced. On the other hand, the lower limit thereof is 0.05 mm or more, for example. The sheet thickness can be adjusted by a flow rate at the time of manufacturing glass, a sheet pulling speed at the time of manufacturing glass, and the like. On the other hand, when the alkali-free glass sheet is used for a magnetic recording medium, the sheet thickness is preferably 1.5 mm or less, 1.2 mm or less, from 0.2 mm to 1.0 mm, and particularly preferably from 0.3 mm to 0.9 mm. When the sheet thickness is too large, etching needs to be performed to obtain a desired sheet thickness, and there is a possibility that the processing cost increases.

In the alkali-free glass sheet according to the present invention, the average surface roughness Ra of the surface is preferably 1.0 nm or less, 0.5 nm or less, and particularly preferably 0.2 nm or less. When the average surface roughness Ra of the surface is large, in a manufacturing step for a display, it is difficult to accurately pattern the electrodes or the like, and as a result, the probability that circuit electrodes are disconnected or short-circuited increases, making it difficult to ensure the reliability of the display or the like. Here, the “average surface roughness Ra of the surface” refers to the average surface roughness Ra of the main surface (both surfaces) excluding end surfaces, and can be measured using, for example, an atomic force microscope (AFM).

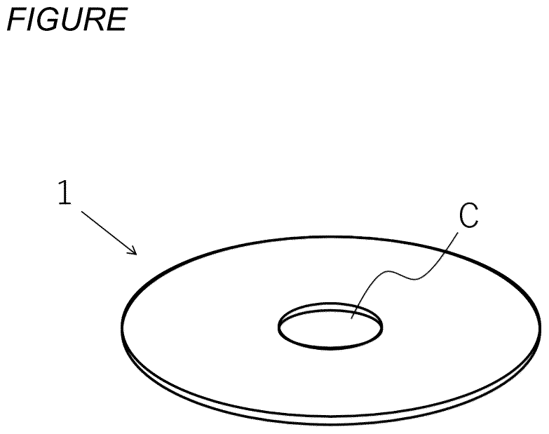

In addition, when the alkali-free glass sheet according to the present invention is used as a substrate of a display panel for an organic EL television, or a carrier for manufacturing an organic EL display panel, the shape is preferably rectangular. Further, it is preferable to use the alkali-free glass sheet according to the present invention as a substrate for a magnetic recording medium particularly an energy assisted magnetic recording medium. The base material including the glass substrate can withstand a heat treatment at a high temperature of about 800° C. during or before or after formation of the magnetic layer on the substrate in order to increase the degree of ordering (regularity) of the magnetic layer to achieve a high Ku, and in addition, the substrate can withstand the impact caused by the high rotation of the magnetic recording medium. The alkali-free glass sheet according to the present invention is processed into a disk substrate 1 as illustrated in FIG. 1 by performing processing such as cutting. When the disk substrate 1 is used as a glass substrate for a magnetic recording medium as described above, the disk substrate 1 preferably has a disk shape and more preferably has a circular opening C formed in the center thereof.

### Examples

Hereinafter, the present invention will be described based on Examples. Note that, the following Examples are merely illustrative. The present invention is not limited to the following Examples in any way.

Tables 1 to 22 show Examples of the present invention (Sample Nos. 1 to 330).

TABLE 1

| | | No. 1 | No. 2 | No. 3 | No. 4 | No. 5 | No. 6 | No. 7 | No. 8 |
|---|---|---|---|---|---|---|---|---|---|
| Glass | SiO₂ | 70.8 | 67.8 | 68.0 | 65.1 | 65.0 | 61.9 | 62.0 | 61.9 |
| composition | Al₂O₃ | 9.0 | 12.1 | 9.0 | 15.0 | 12.0 | 15.0 | 11.9 | 8.9 |
| (mol %) | B₂O₃ | 7.9 | 7.8 | 7.7 | 7.5 | 7.7 | 7.8 | 7.8 | 8.0 |
| | Li₂O | 0.000 | 0.000 | 0.000 | 0.000 | 0.000 | 0.000 | 0.000 | 0.000 |
| | Na₂O | 0.020 | 0.015 | 0.016 | 0.015 | 0.020 | 0.027 | 0.017 | 0.015 |
| | K₂O | 0.002 | 0.001 | 0.001 | 0.002 | 0.002 | 0.002 | 0.001 | 0.001 |
| | MgO | 4.1 | 4.2 | 5.2 | 4.1 | 5.1 | 5.1 | 6.2 | 7.2 |
| | CaO | 4.0 | 4.0 | 5.1 | 4.0 | 5.0 | 5.1 | 6.0 | 7.0 |
| | SrO | 2.0 | 2.0 | 2.5 | 2.0 | 2.5 | 2.5 | 3.0 | 3.4 |
| | BaO | 2.0 | 2.0 | 2.5 | 2.0 | 2.5 | 2.5 | 3.0 | 3.5 |
| | SnO₂ | 0.1 | 0.1 | 0.1 | 0.1 | 0.1 | 0.1 | 0.1 | 0.1 |
| | Fe₂O₃ | 0.006 | 0.006 | 0.006 | 0.006 | 0.006 | 0.007 | 0.006 | 0.006 |
| | TiO₂ | 0.010 | 0.010 | 0.010 | 0.010 | 0.009 | 0.010 | 0.009 | 0.010 |
| | ZrO₂ | 0.001 | 0.001 | 0.001 | 0.001 | 0.001 | 0.001 | 0.001 | 0.001 |
| | MoO₃ | 0.00055 | 0.00047 | 0.00023 | 0.00024 | 0.00043 | 0.00029 | 0.00071 | 0.00094 |
| Glass | MoO₃ | 12 | 10 | 5 | 5 | 9 | 6 | 15 | 20 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.022 | 0.016 | 0.018 | 0.017 | 0.022 | 0.029 | 0.019 | 0.017 |
| MgO + CaO + SrO + | 12.2 | 12.3 | 15.3 | 12.2 | 15.2 | 15.2 | 18.2 | 21.1 |
| BaO | | | | | | | | |
| mol % ratio | 10.50 | 13.51 | 27.06 | 27.08 | 15.03 | 22.53 | 9.02 | 6.75 |
| Fe₂O₃/MoO₃ | | | | | | | | |
| mol % ratio | 17.99 | 21.61 | 43.28 | 43.31 | 22.03 | 33.03 | 13.22 | 10.79 |
| TiO₂/MoO₃ | | | | | | | | |
| CTE [×10⁻⁷/° C.] | 34.0 | 33.6 | 38.3 | 33.2 | 38.1 | 37.6 | 42.4 | 46.5 |
| ρ [g/cm³] | 2.463 | 2.490 | 2.528 | 2.520 | 2.549 | 2.574 | 2.612 | 2.661 |
| E [GPa] | 72 | 75 | 75 | 78 | 76 | 79 | 78 | 79 |
| E/ρ [GPa/g · cm⁻³] | 29.3 | 30.1 | 29.5 | 31.1 | 29.9 | 30.5 | 30.0 | 29.6 |
| Ps [° C.] | 671 | 689 | 663 | 701 | 681 | 696 | 672 | 651 |
| Ta [° C.] | 731 | 748 | 717 | 759 | 737 | 752 | 724 | 699 |
| Ts [° C.] | 988 | 991 | 952 | 987 | 947 | 968 | 937 | 898 |
| 10⁴ dPa · s [° C.] | 1348 | 1308 | 1284 | 1289 | 1275 | 1254 | 1228 | 1179 |
| 10³ dPa · s[° C.] | 1523 | 1475 | 1452 | 1440 | 1432 | 1398 | 1376 | 1326 |
| 10^{2.5} dPa · s [° C.] | 1633 | 1580 | 1560 | 1538 | 1534 | 1492 | 1472 | 1424 |
| TL [° C.] | 1161 | 1209 | 1171 | 1388 | 1086 | 1289 | 1071 | 1079 |
| Log₁₀ ηTL | 5.5 | 4.9 | 4.9 | 3.3 | 5.7 | 3.7 | 5.6 | 5.0 |
| T % (320 nm) | 78.5 | 77.7 | 77.7 | 77.6 | 77.7 | 77.7 | 77.6 | 77.7 |

| | | No. 9 | No. 10 | No. 11 | No. 12 | No. 13 | No. 14 | No. 15 |
|---|---|---|---|---|---|---|---|---|
| Glass | SiO₂ | 70.8 | 67.7 | 67.8 | 64.9 | 61.9 | 61.8 | 73.7 |
| composition | Al₂O₃ | 12.0 | 15.0 | 12.0 | 14.9 | 14.9 | 11.9 | 12.0 |
| (mol %) | B₂O₃ | 5.0 | 4.9 | 5.0 | 5.0 | 4.9 | 5.0 | 2.0 |
| | Li₂O | 0.000 | 0.000 | 0.000 | 0.000 | 0.000 | 0.000 | 0.000 |
| | Na₂O | 0.015 | 0.017 | 0.014 | 0.014 | 0.015 | 0.013 | 0.015 |
| | K₂O | 0.001 | 0.001 | 0.001 | 0.001 | 0.001 | 0.001 | 0.001 |
| | MgO | 4.1 | 4.1 | 5.1 | 5.1 | 6.1 | 7.2 | 4.1 |
| | CaO | 4.0 | 4.0 | 5.0 | 5.0 | 6.0 | 7.0 | 4.0 |
| | SrO | 2.0 | 2.1 | 2.5 | 2.5 | 3.0 | 3.5 | 2.0 |
| | BaO | 2.0 | 2.0 | 2.5 | 2.5 | 3.0 | 3.5 | 2.0 |
| | SnO₂ | 0.1 | 0.1 | 0.1 | 0.1 | 0.1 | 0.1 | 0.1 |
| | Fe₂O₃ | 0.006 | 0.006 | 0.006 | 0.006 | 0.007 | 0.007 | 0.006 |
| | TiO₂ | 0.010 | 0.009 | 0.010 | 0.010 | 0.010 | 0.009 | 0.011 |
| | ZrO₂ | 0.001 | 0.001 | 0.001 | 0.001 | 0.001 | 0.001 | 0.001 |
| | MoO₃ | 0.00075 | 0.00048 | 0.00094 | 0.00038 | 0.00029 | 0.00038 | 0.00028 |
| Glass | MoO₃ | 16 | 10 | 20 | 8 | 6 | 8 | 6 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.017 | 0.018 | 0.015 | 0.015 | 0.016 | 0.014 | 0.016 |
| MgO + CaO + SrO + | 12.1 | 12.3 | 15.2 | 15.2 | 18.2 | 21.2 | 12.1 |
| BaO | | | | | | | |
| mol % ratio | 8.44 | 13.52 | 6.75 | 16.89 | 22.57 | 18.01 | 22.50 |
| Fe₂O₃/MoO₃ | | | | | | | |
| mol % ratio | 13.50 | 19.83 | 10.79 | 27.02 | 33.09 | 24.75 | 38.98 |
| TiO₂/MoO₃ | | | | | | | |
| CTE [×10⁻⁷/° C.] | 33.1 | 32.7 | 37.6 | 37.0 | 41.4 | 45.6 | 32.5 |
| ρ [g/cm³] | 2.503 | 2.535 | 2.562 | 2.587 | 2.645 | 2.686 | 2.518 |
| E [GPa] | 77 | 81 | 78 | 81 | 82 | 81 | 80 |
| E/ρ [GPa/g · cm⁻³] | 31.0 | 31.8 | 30.6 | 31.4 | 31.0 | 30.3 | 31.9 |
| Ps [° C.] | 715 | 725 | 703 | 718 | 708 | 681 | 752 |
| Ta [° C.] | 776 | 784 | 761 | 775 | 762 | 733 | 815 |
| Ts [° C.] | 1025 | 1018 | 995 | 999 | 975 | 940 | 1069 |
| 10⁴ dPa · s [° C.] | 1361 | 1328 | 1318 | 1293 | 1256 | 1220 | 1427 |
| 10³ dPa · s[° C.] | 1538 | 1487 | 1479 | 1442 | 1398 | 1366 | 1605 |
| 10^{2.5} dPa · s [° C.] | 1653 | 1594 | 1582 | 1537 | 1490 | 1461 | 1722 |
| TL [° C.] | 1207 | 1334 | 1174 | 1279 | 1213 | 1154 | 1327 |
| Log₁₀ ηTL | 5.3 | 4.0 | 5.3 | 4.1 | 4.4 | 4.6 | 4.7 |
| T % (320 nm) | 77.7 | 77.7 | 77.7 | 77.7 | 77.6 | 76.9 | 77.7 |

TABLE 2

| | | No. 16 | No. 17 | No. 18 | No. 19 | No. 20 | No. 21 | No. 22 | No. 23 |
|---|---|---|---|---|---|---|---|---|---|
| Glass | SiO₂ | 70.8 | 67.7 | 67.8 | 64.7 | 64.7 | 64.8 | 64.7 | 64.7 |
| composition | Al₂O₃ | 12.0 | 15.1 | 12.0 | 15.0 | 12.0 | 12.0 | 14.1 | 14.0 |
| (mol %) | B₂O₃ | 2.0 | 1.9 | 2.0 | 2.0 | 2.0 | 5.0 | 3.9 | 3.9 |
| | Li₂O | 0.000 | 0.000 | 0.000 | 0.000 | 0.000 | 0.000 | 0.000 | 0.000 |
| | Na₂O | 0.012 | 0.017 | 0.014 | 0.012 | 0.012 | 0.015 | 0.015 | 0.013 |
| | K₂O | 0.001 | 0.001 | 0.001 | 0.001 | 0.001 | 0.001 | 0.001 | 0.001 |
| | MgO | 5.1 | 5.1 | 6.1 | 6.1 | 7.1 | 6.1 | 6.1 | 5.1 |
| | CaO | 5.0 | 5.0 | 6.0 | 6.0 | 7.1 | 6.0 | 7.1 | 8.1 |
| | SrO | 2.5 | 2.5 | 3.0 | 3.0 | 3.5 | 3.0 | 2.0 | 2.0 |
| | BaO | 2.5 | 2.5 | 3.0 | 3.0 | 3.5 | 3.0 | 2.0 | 2.0 |
| | SnO₂ | 0.1 | 0.1 | 0.1 | 0.1 | 0.1 | 0.1 | 0.1 | 0.1 |
| | Fe₂O₃ | 0.006 | 0.006 | 0.006 | 0.007 | 0.007 | 0.006 | 0.007 | 0.007 |
| | TiO₂ | 0.010 | 0.010 | 0.010 | 0.010 | 0.009 | 0.011 | 0.010 | 0.010 |
| | ZrO₂ | 0.001 | 0.001 | 0.001 | 0.001 | 0.001 | 0.001 | 0.001 | 0.001 |
| | MoO₃ | 0.00075 | 0.00038 | 0.00071 | 0.00029 | 0.00038 | 0.00076 | 0.00470 | 0.00038 |
| Glass | MoO₃ | 16 | 8 | 15 | 6 | 8 | 16 | 100 | 8 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.014 | 0.018 | 0.015 | 0.013 | 0.014 | 0.016 | 0.016 | 0.014 |
| MgO + CaO + SrO + | 15.1 | 15.2 | 18.2 | 18.2 | 21.2 | 18.2 | 17.2 | 17.2 |
| BaO | | | | | | | | |
| mol % ratio | 8.44 | 16.89 | 9.01 | 24.02 | 18.00 | 8.45 | 1.44 | 18.03 |
| Fe₂O₃/MoO₃ | | | | | | | | |
| mol % ratio | 13.49 | 27.01 | 14.41 | 33.02 | 24.74 | 14.63 | 2.16 | 27.03 |
| TiO₂/MoO₃ | | | | | | | | |
| CTE [×10⁻⁷/° C.] | 37.0 | 36.6 | 41.3 | 40.8 | 45.2 | 41.9 | 38.9 | 39.7 |
| ρ [g/cm³] | 2.574 | 2.604 | 2.637 | 2.660 | 2.700 | 2.622 | 2.585 | 2.587 |
| E [GPa] | 81 | 84 | 82 | 84 | 83 | 80 | 83 | 82 |
| E/ρ [GPa/g · cm⁻³] | 31.4 | 32.1 | 31.1 | 31.7 | 30.8 | 30.6 | 32.0 | 31.9 |
| Ps [° C.] | 736 | 748 | 720 | 736 | 708 | 690 | 717 | 716 |
| Ta [° C.] | 796 | 807 | 777 | 792 | 762 | 745 | 772 | 771 |
| Ts [° C.] | 1035 | 1034 | 1003 | 1007 | 976 | 966 | 993 | 992 |
| 10⁴ dPa · s [° C.] | 1369 | 1342 | 1316 | 1297 | 1267 | 1267 | 1282 | 1283 |
| 10³ dPa · s[° C.] | 1536 | 1495 | 1476 | 1444 | 1416 | 1421 | 1430 | 1433 |
| 10^{2.5} dPa · s [° C.] | 1641 | 1593 | 1577 | 1538 | 1513 | 1522 | 1526 | 1529 |
| TL [° C.] | 1201 | 1337 | 1189 | 1257 | 1217 | 1130 | 1177 | 1216 |
| Log₁₀ ηTL | 5.5 | 4.0 | 5.1 | 4.4 | 4.4 | 4.0 | 5.0 | 4.6 |
| T % (320 nm) | 77.7 | 77.7 | 77.7 | 76.9 | 76.9 | 77.7 | 76.8 | 76.9 |

| | | No. 24 | No. 25 | No. 26 | No. 27 | No. 28 | No. 29 | No. 30 |
|---|---|---|---|---|---|---|---|---|
| Glass | SiO₂ | 64.8 | 64.8 | 64.7 | 64.8 | 65.7 | 65.8 | 65.9 |
| composition | Al₂O₃ | 14.0 | 14.0 | 14.0 | 14.0 | 13.1 | 13.0 | 13.0 |
| (mol %) | B₂O₃ | 3.8 | 3.9 | 4.0 | 3.9 | 3.8 | 3.8 | 3.9 |
| | Li₂O | 0.000 | 0.000 | 0.000 | 0.000 | 0.000 | 0.000 | 0.000 |
| | Na₂O | 0.015 | 0.013 | 0.012 | 0.014 | 0.012 | 0.012 | 0.015 |
| | K₂O | 0.001 | 0.001 | 0.001 | 0.001 | 0.001 | 0.001 | 0.001 |
| | MgO | 5.1 | 4.1 | 4.1 | 4.1 | 7.2 | 6.1 | 6.1 |
| | CaO | 7.1 | 9.1 | 8.1 | 7.1 | 7.1 | 8.1 | 7.1 |
| | SrO | 2.5 | 2.0 | 2.5 | 3.0 | 1.5 | 1.5 | 2.0 |
| | BaO | 2.5 | 2.0 | 2.5 | 3.0 | 1.5 | 1.5 | 2.0 |
| | SnO₂ | 0.1 | 0.1 | 0.1 | 0.1 | 0.1 | 0.1 | 0.1 |
| | Fe₂O₃ | 0.007 | 0.007 | 0.007 | 0.007 | 0.007 | 0.007 | 0.007 |
| | TiO₂ | 0.009 | 0.009 | 0.010 | 0.010 | 0.010 | 0.010 | 0.010 |
| | ZrO₂ | 0.001 | 0.001 | 0.001 | 0.001 | 0.001 | 0.001 | 0.001 |
| | MoO₃ | 0.00043 | 0.00094 | 0.00143 | 0.00087 | 0.00069 | 0.00065 | 0.00089 |
| Glass | MoO₃ | 9 | 20 | 30 | 18 | 15 | 14 | 19 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.016 | 0.014 | 0.014 | 0.015 | 0.013 | 0.014 | 0.016 |
| MgO + CaO + SrO + | 17.3 | 17.2 | 17.2 | 17.2 | 17.3 | 17.2 | 17.2 |
| BaO | | | | | | | |
| mol % ratio | 16.05 | 7.67 | 4.81 | 7.53 | 10.20 | 10.93 | 7.59 |
| Fe₂O₃/MoO₃ | | | | | | | |
| mol % ratio | 22.05 | 9.92 | 7.21 | 11.04 | 14.39 | 15.43 | 11.37 |
| TiO₂/MoO₃ | | | | | | | |
| CTE [×10⁻⁷/° C.] | 39.8 | 40.3 | 40.5 | 41.2 | 40.4 | 38.9 | 39.1 |
| ρ [g/cm³] | 2.608 | 2.590 | 2.611 | 2.632 | 2.553 | 2.555 | 2.577 |
| E [GPa] | 82 | 82 | 81 | 81 | 83 | 83 | 82 |
| E/ρ [GPa/g · cm⁻³] | 31.4 | 31.7 | 31.1 | 30.8 | 32.4 | 32.3 | 31.8 |
| Ps [° C.] | 715 | 716 | 715 | 715 | 712 | 713 | 712 |
| Ta [° C.] | 770 | 771 | 771 | 771 | 767 | 768 | 767 |
| Ts [° C.] | 992 | 992 | 993 | 994 | 989 | 991 | 989 |
| 10⁴ dPa · s [° C.] | 1288 | 1284 | 1293 | 1287 | 1282 | 1282 | 1285 |
| 10³ dPa · s[° C.] | 1439 | 1434 | 1444 | 1437 | 1433 | 1432 | 1438 |
| 10^{2.5} dPa · s [° C.] | 1536 | 1531 | 1544 | 1534 | 1531 | 1530 | 1539 |
| TL [° C.] | 1205 | 1230 | 1210 | 1215 | 1184 | 1185 | 1181 |
| Log₁₀ ηTL | 4.8 | 4.5 | 4.7 | 4.6 | 4.9 | 4.9 | 5.0 |
| T % (320 nm) | 76.8 | 76.0 | 76.8 | 77.6 | 76.1 | 76.1 | 76.9 |

TABLE 3

| | | No. 31 | No. 32 | No. 33 | No. 34 | No. 35 | No. 36 | No. 37 | No. 38 |
|---|---|---|---|---|---|---|---|---|---|
| Glass | SiO₂ | 65.8 | 65.6 | 65.6 | 66.9 | 66.9 | 66.7 | 67.3 | 67.0 |
| composition | Al₂O₃ | 13.0 | 13.1 | 13.0 | 12.0 | 12.1 | 12.1 | 12.0 | 12.0 |
| (mol %) | B₂O₃ | 3.8 | 4.0 | 4.0 | 3.7 | 3.7 | 3.8 | 3.6 | 3.7 |
| | Li₂O | 0.000 | 0.000 | 0.000 | 0.000 | 0.000 | 0.000 | 0.000 | 0.000 |
| | Na₂O | 0.015 | 0.013 | 0.015 | 0.013 | 0.012 | 0.015 | 0.020 | 0.018 |
| | K₂O | 0.001 | 0.001 | 0.001 | 0.001 | 0.001 | 0.002 | 0.002 | 0.001 |
| | MgO | 5.1 | 5.1 | 5.1 | 8.2 | 7.2 | 7.2 | 6.1 | 6.1 |
| | CaO | 9.1 | 7.8 | 7.4 | 7.0 | 8.1 | 7.1 | 9.0 | 8.0 |
| | SrO | 1.5 | 2.2 | 2.4 | 1.0 | 1.0 | 1.5 | 1.0 | 1.5 |
| | BaO | 1.5 | 2.2 | 2.4 | 1.0 | 1.0 | 1.5 | 1.0 | 1.5 |
| | SnO₂ | 0.1 | 0.1 | 0.1 | 0.1 | 0.1 | 0.1 | 0.1 | 0.1 |
| | Fe₂O₃ | 0.007 | 0.007 | 0.007 | 0.007 | 0.007 | 0.007 | 0.007 | 0.007 |
| | TiO₂ | 0.010 | 0.010 | 0.010 | 0.010 | 0.010 | 0.009 | 0.010 | 0.010 |
| | ZrO₂ | 0.001 | 0.001 | 0.001 | 0.001 | 0.001 | 0.001 | 0.001 | 0.001 |
| | MoO₃ | 0.00060 | 0.00038 | 0.00057 | 0.00045 | 0.00023 | 0.00023 | 0.00041 | 0.00032 |
| Glass | MoO₃ | 13 | 8 | 12 | 10 | 5 | 5 | 9 | 7 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.016 | 0.014 | 0.016 | 0.014 | 0.014 | 0.017 | 0.022 | 0.019 |
| MgO + CaO + SrO + | 17.2 | 17.2 | 17.2 | 17.3 | 17.3 | 17.3 | 17.1 | 17.2 |
| BaO | | | | | | | | |
| mol % ratio | 11.79 | 19.15 | 12.00 | 15.31 | 30.65 | 30.66 | 17.04 | 21.88 |
| Fe₂O₃/MoO₃ | | | | | | | | |
| mol % ratio | 16.64 | 27.02 | 17.99 | 21.61 | 43.25 | 39.67 | 24.04 | 30.87 |
| TiO₂/MoO₃ | | | | | | | | |
| CTE [×10⁻⁷/° C.] | 39.4 | 40.0 | 39.9 | 36.7 | 37.6 | 38.0 | 38.4 | 38.7 |
| ρ [g/cm³] | 2.558 | 2.594 | 2.586 | 2.520 | 2.522 | 2.545 | 2.526 | 2.544 |
| E [GPa] | 82 | 81 | 81 | 83 | 82 | 82 | 82 | 81 |
| E/ρ [GPa/g · cm⁻³] | 32.0 | 31.3 | 31.5 | 32.8 | 32.7 | 32.2 | 32.5 | 31.9 |
| Ps [° C.] | 712 | 709 | 708 | 708 | 708 | 708 | 707 | 706 |
| Ta [° C.] | 767 | 765 | 764 | 763 | 763 | 763 | 762 | 762 |
| Ts [° C.] | 989 | 989 | 989 | 986 | 987 | 989 | 986 | 987 |
| 10⁴ dPa · s [° C.] | 1284 | 1292 | 1289 | 1291 | 1291 | 1287 | 1286 | 1291 |
| 10³ dPa · s[° C.] | 1437 | 1447 | 1443 | 1445 | 1452 | 1442 | 1442 | 1446 |
| 10^{2.5} dPa · s [° C.] | 1536 | 1548 | 1543 | 1546 | 1556 | 1542 | 1544 | 1550 |
| TL [° C.] | 1208 | 1209 | 1190 | 1217 | 1232 | 1222 | 1211 | 1185 |
| Log₁₀ ηTL | 4.7 | 4.7 | 4.9 | 4.6 | 4.5 | 4.6 | 4.7 | 5.0 |
| T % (320 nm) | 76.0 | 76.1 | 76.9 | 76.1 | 76.0 | 76.0 | 76.0 | 76.1 |

| | | No. 39 | No. 40 | No. 41 | No. 42 | No. 43 | No. 44 | No. 45 |
|---|---|---|---|---|---|---|---|---|
| Glass | SiO₂ | 66.8 | 65.8 | 65.8 | 65.8 | 65.8 | 65.8 | 65.7 |
| composition | Al₂O₃ | 12.0 | 14.0 | 14.0 | 14.0 | 14.0 | 14.0 | 14.0 |
| (mol %) | B₂O₃ | 3.8 | 2.9 | 2.9 | 2.9 | 2.9 | 3.0 | 3.0 |
| | Li₂O | 0.000 | 0.000 | 0.000 | 0.000 | 0.000 | 0.000 | 0.000 |
| | Na₂O | 0.027 | 0.017 | 0.015 | 0.015 | 0.017 | 0.014 | 0.016 |
| | K₂O | 0.002 | 0.001 | 0.001 | 0.001 | 0.001 | 0.001 | 0.001 |
| | MgO | 6.1 | 6.1 | 5.1 | 5.1 | 4.1 | 4.1 | 4.1 |
| | CaO | 7.0 | 7.1 | 8.1 | 7.1 | 9.1 | 8.1 | 7.1 |
| | SrO | 2.0 | 2.0 | 2.0 | 2.5 | 2.0 | 2.5 | 3.0 |
| | BaO | 2.0 | 2.0 | 2.0 | 2.5 | 2.0 | 2.5 | 3.0 |
| | SnO₂ | 0.1 | 0.1 | 0.1 | 0.1 | 0.1 | 0.1 | 0.1 |
| | Fe₂O₃ | 0.007 | 0.007 | 0.007 | 0.007 | 0.007 | 0.007 | 0.007 |
| | TiO₂ | 0.010 | 0.009 | 0.009 | 0.011 | 0.010 | 0.009 | 0.010 |
| | ZrO₂ | 0.001 | 0.001 | 0.001 | 0.001 | 0.001 | 0.001 | 0.001 |
| | MoO₃ | 0.00028 | 0.00070 | 0.00094 | 0.00076 | 0.00047 | 0.00095 | 0.00029 |
| Glass | MoO₃ | 6 | 15 | 20 | 16 | 10 | 20 | 6 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.029 | 0.019 | 0.017 | 0.017 | 0.018 | 0.015 | 0.017 |
| MgO + CaO + SrO + | 17.2 | 17.2 | 17.2 | 17.2 | 17.2 | 17.2 | 17.2 |
| BaO | | | | | | | |
| mol % ratio | 24.00 | 9.62 | 7.66 | 9.03 | 15.34 | 7.22 | 24.05 |
| Fe₂O₃/MoO₃ | | | | | | | |
| mol % ratio | 35.98 | 13.22 | 9.91 | 14.66 | 21.64 | 9.92 | 36.06 |
| TiO₂/MoO₃ | | | | | | | |
| CTE [×10⁻⁷/° C.] | 39.3 | 38.7 | 39.6 | 40.0 | 40.2 | 40.6 | 41.1 |
| ρ [g/cm³] | 2.567 | 2.589 | 2.592 | 2.613 | 2.593 | 2.616 | 2.637 |
| E [GPa] | 81 | 83 | 83 | 83 | 83 | 82 | 82 |
| E/ρ [GPa/g · cm⁻³] | 31.6 | 32.2 | 32.1 | 31.6 | 31.9 | 31.5 | 31.0 |
| Ps [° C.] | 706 | 726 | 727 | 726 | 727 | 725 | 725 |
| Ta [° C.] | 762 | 781 | 782 | 782 | 783 | 782 | 782 |
| Ts [° C.] | 988 | 1003 | 1003 | 1004 | 1004 | 1005 | 1006 |
| 10⁴ dPa · s [° C.] | 1292 | 1297 | 1297 | 1302 | 1300 | 1303 | 1307 |
| 10³ dPa · s[° C.] | 1450 | 1447 | 1448 | 1453 | 1450 | 1456 | 1459 |
| 10^{2.5} dPa · s [° C.] | 1552 | 1544 | 1545 | 1550 | 1548 | 1554 | 1558 |
| TL [° C.] | 1162 | 1227 | 1247 | 1216 | 1251 | 1253 | 1249 |
| Log₁₀ ηTL | 5.2 | 4.6 | 4.4 | 4.8 | 4.4 | 4.4 | 4.5 |
| T % (320 nm) | 76.9 | 76.8 | 76.0 | 76.8 | 76.0 | 76.8 | 76.8 |

TABLE 4

| | | No. 46 | No. 47 | No. 48 | No. 49 | No. 50 | No. 51 | No. 52 | No. 53 |
|---|---|---|---|---|---|---|---|---|---|
| Glass | SiO₂ | 66.8 | 66.8 | 66.8 | 66.8 | 66.8 | 66.7 | 68.0 | 67.7 |
| composition | Al₂O₃ | 13.0 | 13.0 | 13.0 | 13.0 | 13.0 | 13.0 | 12.1 | 12.1 |
| (mol %) | B₂O₃ | 2.9 | 2.9 | 2.9 | 2.9 | 2.9 | 2.9 | 2.9 | 2.8 |
| | Li₂O | 0.000 | 0.000 | 0.000 | 0.000 | 0.000 | 0.000 | 0.000 | 0.000 |
| | Na₂O | 0.014 | 0.012 | 0.012 | 0.015 | 0.015 | 0.013 | 0.015 | 0.013 |
| | K₂O | 0.001 | 0.001 | 0.001 | 0.001 | 0.001 | 0.001 | 0.001 | 0.001 |
| | MgO | 7.2 | 6.1 | 6.1 | 5.1 | 5.1 | 5.1 | 8.2 | 7.2 |
| | CaO | 7.0 | 8.1 | 7.1 | 9.1 | 8.1 | 7.1 | 7.1 | 8.1 |
| | SrO | 1.5 | 1.5 | 2.0 | 1.5 | 2.0 | 2.5 | 0.4 | 1.0 |
| | BaO | 1.5 | 1.5 | 2.0 | 1.5 | 2.0 | 2.5 | 1.0 | 1.0 |
| | SnO₂ | 0.1 | 0.1 | 0.1 | 0.1 | 0.1 | 0.1 | 0.1 | 0.1 |
| | Fe₂O₃ | 0.007 | 0.007 | 0.007 | 0.007 | 0.007 | 0.007 | 0.007 | 0.007 |
| | TiO₂ | 0.010 | 0.010 | 0.009 | 0.010 | 0.010 | 0.010 | 0.011 | 0.010 |
| | ZrO₂ | 0.001 | 0.001 | 0.001 | 0.001 | 0.001 | 0.001 | 0.001 | 0.001 |
| | MoO₃ | 0.00037 | 0.00083 | 0.00070 | 0.00065 | 0.00089 | 0.00061 | 0.00036 | 0.00054 |
| Glass | MoO₃ | 8 | 18 | 15 | 14 | 19 | 13 | 8 | 12 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.015 | 0.013 | 0.014 | 0.016 | 0.016 | 0.014 | 0.016 | 0.014 |
| MgO + CaO + SrO + | 17.2 | 17.2 | 17.2 | 17.2 | 17.2 | 17.2 | 16.8 | 17.3 |
| BaO | | | | | | | | |
| mol % ratio | 19.16 | 8.50 | 9.60 | 10.95 | 7.59 | 11.10 | 19.35 | 12.78 |
| Fe₂O₃/MoO₃ | | | | | | | | |
| mol % ratio | 27.03 | 12.00 | 13.20 | 15.45 | 11.38 | 16.64 | 29.59 | 18.03 |
| TiO₂/MoO₃ | | | | | | | | |
| CTE [×10⁻⁷/° C.] | 38.0 | 38.4 | 39.0 | 39.3 | 39.6 | 39.4 | 36.0 | 37.5 |
| ρ [g/cm³] | 2.559 | 2.555 | 2.581 | 2.563 | 2.581 | 2.604 | 2.524 | 2.527 |
| E [GPa] | 84 | 84 | 83 | 83 | 82 | 82 | 84 | 84 |
| E/ρ [GPa/g · cm⁻³] | 32.7 | 32.7 | 32.2 | 32.5 | 31.9 | 31.6 | 33.2 | 33.1 |
| Ps [° C.] | 723 | 722 | 721 | 721 | 720 | 720 | 718 | 717 |
| Ta [° C.] | 779 | 777 | 777 | 777 | 776 | 776 | 774 | 773 |
| Ts [° C.] | 1001 | 1000 | 1002 | 1000 | 1001 | 1003 | 998 | 998 |
| 10⁴ dPa · s [° C.] | 1300 | 1301 | 1305 | 1303 | 1306 | 1309 | 1304 | 1304 |
| 10³ dPa · s[° C.] | 1453 | 1455 | 1460 | 1457 | 1462 | 1466 | 1461 | 1461 |
| 10^{2.5} dPa · s [° C.] | 1552 | 1554 | 1563 | 1557 | 1562 | 1567 | 1570 | 1570 |
| TL [° C.] | 1199 | 1208 | 1210 | 1239 | 1216 | 1211 | 1244 | 1258 |
| Log₁₀ ηTL | 4.9 | 4.8 | 4.9 | 4.6 | 4.8 | 4.9 | 4.5 | 4.4 |
| T % (320 nm) | 76.0 | 76.1 | 76.9 | 76.0 | 76.8 | 76.8 | 75.9 | 76.0 |

| | | No. 54 | No. 55 | No. 56 | No. 57 | No. 58 | No. 59 | No. 60 |
|---|---|---|---|---|---|---|---|---|
| Glass | SiO₂ | 67.7 | 67.7 | 67.6 | 65.6 | 65.8 | 64.8 | 65.0 |
| composition | Al₂O₃ | 12.1 | 12.1 | 12.1 | 13.1 | 13.0 | 14.0 | 14.0 |
| (mol %) | B₂O₃ | 2.8 | 2.8 | 2.9 | 3.8 | 3.9 | 3.8 | 3.7 |
| | Li₂O | 0.000 | 0.000 | 0.000 | 0.000 | 0.000 | 0.000 | 0.000 |
| | Na₂O | 0.012 | 0.017 | 0.030 | 0.024 | 0.027 | 0.016 | 0.030 |
| | K₂O | 0.001 | 0.002 | 0.002 | 0.004 | 0.004 | 0.002 | 0.005 |
| | MgO | 7.2 | 6.1 | 6.2 | 5.1 | 5.1 | 7.2 | 6.1 |
| | CaO | 7.1 | 8.1 | 7.1 | 8.1 | 7.1 | 6.1 | 6.0 |
| | SrO | 1.5 | 1.5 | 2.0 | 2.0 | 2.5 | 2.0 | 2.5 |
| | BaO | 1.5 | 1.5 | 2.0 | 2.0 | 2.5 | 2.0 | 2.5 |
| | SnO₂ | 0.1 | 0.1 | 0.1 | 0.1 | 0.1 | 0.1 | 0.1 |
| | Fe₂O₃ | 0.007 | 0.007 | 0.007 | 0.007 | 0.007 | 0.007 | 0.006 |
| | TiO₂ | 0.010 | 0.010 | 0.010 | 0.009 | 0.010 | 0.010 | 0.010 |
| | ZrO₂ | 0.001 | 0.001 | 0.001 | 0.001 | 0.001 | 0.001 | 0.001 |
| | MoO₃ | 0.00082 | 0.00064 | 0.00088 | 0.00061 | 0.00038 | 0.00056 | 0.00048 |
| Glass | MoO₃ | 18 | 14 | 19 | 13 | 8 | 12 | 10 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.014 | 0.019 | 0.032 | 0.028 | 0.031 | 0.018 | 0.035 |
| MgO + CaO + SrO + | 17.3 | 17.3 | 17.3 | 17.4 | 17.2 | 17.3 | 17.2 |
| BaO | | | | | | | |
| mol % ratio | 8.52 | 10.95 | 7.60 | 11.18 | 18.03 | 12.02 | 13.54 |
| Fe₂O₃/MoO₃ | | | | | | | |
| mol % ratio | 12.02 | 15.46 | 11.39 | 15.36 | 27.03 | 18.02 | 21.65 |
| TiO₂/MoO₃ | | | | | | | |
| CTE [×10⁻⁷/° C.] | 37.9 | 38.6 | 39.1 | 39.7 | 40.0 | 38.3 | 39.3 |
| ρ [g/cm³] | 2.548 | 2.551 | 2.572 | 2.578 | 2.599 | 2.582 | 2.603 |
| E [GPa] | 83 | 83 | 83 | 82 | 82 | 83 | 82 |
| E/ρ [GPa/g · cm⁻³] | 32.7 | 32.5 | 32.1 | 31.8 | 31.4 | 32.2 | 31.6 |
| Ps [° C.] | 716 | 717 | 715 | 712 | 710 | 718 | 716 |
| Ta [° C.] | 772 | 773 | 771 | 768 | 766 | 772 | 772 |
| Ts [° C.] | 999 | 1001 | 999 | 990 | 991 | 991 | 993 |
| 10⁴ dPa · s [° C.] | 1306 | 1306 | 1315 | 1292 | 1294 | 1283 | 1288 |
| 10³ dPa · s[° C.] | 1464 | 1465 | 1483 | 1446 | 1448 | 1432 | 1438 |
| 10^{2.5} dPa · s [° C.] | 1567 | 1568 | 1592 | 1548 | 1548 | 1530 | 1535 |
| TL [° C.] | 1222 | 1221 | 1234 | 1201 | 1198 | 1193 | 1200 |
| Log₁₀ ηTL | 4.7 | 4.7 | 4.7 | 4.8 | 4.9 | 4.8 | 4.8 |
| T % (320 nm) | 76.0 | 76.0 | 76.8 | 76.8 | 76.9 | 76.8 | 77.6 |

TABLE 5

| | | No. 61 | No. 62 | No. 63 | No. 64 | No. 65 | No. 66 | No. 67 | No. 68 |
|---|---|---|---|---|---|---|---|---|---|
| Glass | SiO₂ | 65.9 | 65.8 | 64.9 | 64.7 | 65.8 | 65.7 | 66.7 | 66.7 |
| composition | Al₂O₃ | 13.0 | 13.1 | 14.1 | 14.0 | 13.1 | 13.0 | 12.1 | 12.0 |
| (mol %) | B₂O₃ | 3.8 | 3.8 | 3.6 | 3.9 | 3.8 | 3.9 | 3.8 | 4.0 |
| | Li₂O | 0.000 | 0.000 | 0.000 | 0.000 | 0.000 | 0.000 | 0.000 | 0.000 |
| | Na₂O | 0.024 | 0.023 | 0.020 | 0.032 | 0.020 | 0.018 | 0.016 | 0.015 |
| | K₂O | 0.004 | 0.005 | 0.004 | 0.003 | 0.003 | 0.003 | 0.003 | 0.001 |
| | MgO | 7.2 | 6.1 | 6.1 | 6.1 | 6.1 | 6.1 | 7.2 | 6.1 |
| | CaO | 6.1 | 6.1 | 7.1 | 7.1 | 7.0 | 7.1 | 6.1 | 6.1 |
| | SrO | 2.0 | 2.5 | 4.1 | 0.0 | 4.0 | 0.0 | 2.0 | 2.5 |
| | BaO | 2.0 | 2.5 | 0.0 | 4.0 | 0.0 | 4.0 | 2.0 | 2.5 |
| | SnO₂ | 0.1 | 0.1 | 0.1 | 0.1 | 0.1 | 0.1 | 0.1 | 0.1 |
| | Fe₂O₃ | 0.007 | 0.007 | 0.007 | 0.006 | 0.007 | 0.006 | 0.007 | 0.006 |
| | TiO₂ | 0.010 | 0.010 | 0.010 | 0.010 | 0.010 | 0.010 | 0.010 | 0.010 |
| | ZrO₂ | 0.001 | 0.001 | 0.001 | 0.001 | 0.001 | 0.001 | 0.001 | 0.001 |
| | MoO₃ | 0.00023 | 0.00024 | 0.00042 | 0.00033 | 0.00028 | 0.00071 | 0.00093 | 0.00075 |
| Glass | MoO₃ | 5 | 5 | 9 | 7 | 6 | 15 | 20 | 16 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.029 | 0.028 | 0.024 | 0.035 | 0.023 | 0.021 | 0.019 | 0.017 |
| MgO + CaO + SrO + | 17.3 | 17.3 | 17.3 | 17.3 | 17.2 | 17.3 | 17.3 | 17.1 |
| BaO | | | | | | | | |
| mol % ratio | 28.84 | 28.85 | 17.08 | 19.33 | 25.59 | 9.03 | 7.21 | 8.45 |
| Fe₂O₃/MoO₃ | | | | | | | | |
| mol % ratio | 43.24 | 43.26 | 24.10 | 30.92 | 36.11 | 14.44 | 10.81 | 13.51 |
| TiO₂/MoO₃ | | | | | | | | |
| CTE [×10⁻⁷/° C.] | 38.5 | 39.6 | 38.7 | 39.0 | 38.7 | 39.3 | 38.4 | 39.2 |
| ρ [g/cm³] | 2.573 | 2.596 | 2.556 | 2.609 | 2.547 | 2.601 | 2.563 | 2.586 |
| E [GPa] | 82 | 81 | 83 | 82 | 83 | 81 | 82 | 81 |
| E/ρ [GPa/g · cm⁻³] | 32.0 | 31.4 | 32.6 | 31.3 | 32.4 | 31.2 | 31.8 | 31.2 |
| Ps [° C.] | 712 | 710 | 718 | 715 | 713 | 710 | 707 | 707 |
| Ta [° C.] | 767 | 766 | 773 | 771 | 768 | 766 | 762 | 762 |
| Ts [° C.] | 990 | 991 | 990 | 992 | 988 | 990 | 988 | 989 |
| 10⁴ dPa · s [° C.] | 1288 | 1294 | 1281 | 1285 | 1282 | 1291 | 1291 | 1296 |
| 10³ dPa · s[° C.] | 1440 | 1450 | 1430 | 1434 | 1432 | 1443 | 1450 | 1455 |
| 10^{2.5} dPa · s [° C.] | 1539 | 1551 | 1528 | 1531 | 1531 | 1542 | 1552 | 1556 |
| TL [° C.] | 1193 | 1178 | 1220 | 1186 | 1213 | 1162 | 1170 | 1180 |
| Log₁₀ ηTL | 4.9 | 5.1 | 4.6 | 4.9 | 4.6 | 5.2 | 5.1 | 5.0 |
| T % (320 nm) | 76.9 | 76.9 | 76.0 | 77.7 | 76.0 | 77.6 | 76.8 | 77.7 |

| | | No. 69 | No. 70 | No. 71 | No. 72 | No. 73 | No. 74 | No. 75 |
|---|---|---|---|---|---|---|---|---|
| Glass | SiO₂ | 65.8 | 65.7 | 65.7 | 65.9 | 65.8 | 64.8 | 64.7 |
| composition | Al₂O₃ | 14.0 | 14.0 | 14.0 | 12.9 | 14.0 | 14.0 | 14.1 |
| (mol %) | B₂O₃ | 2.9 | 2.9 | 3.1 | 2.9 | 3.9 | 4.8 | 4.7 |
| | Li₂O | 0.000 | 0.000 | 0.000 | 0.000 | 0.000 | 0.000 | 0.000 |
| | Na₂O | 0.015 | 0.020 | 0.018 | 0.027 | 0.017 | 0.015 | 0.015 |
| | K₂O | 0.002 | 0.002 | 0.001 | 0.002 | 0.001 | 0.001 | 0.001 |
| | MgO | 7.1 | 6.1 | 5.1 | 7.1 | 6.1 | 6.1 | 6.2 |
| | CaO | 6.1 | 6.1 | 6.1 | 6.0 | 6.1 | 6.1 | 6.1 |
| | SrO | 2.0 | 2.5 | 3.0 | 2.5 | 2.0 | 2.0 | 4.1 |
| | BaO | 2.0 | 2.5 | 3.0 | 2.5 | 2.0 | 2.0 | 0.0 |
| | SnO₂ | 0.1 | 0.1 | 0.1 | 0.1 | 0.1 | 0.1 | 0.1 |
| | Fe₂O₃ | 0.007 | 0.006 | 0.007 | 0.007 | 0.007 | 0.006 | 0.007 |
| | TiO₂ | 0.009 | 0.009 | 0.010 | 0.009 | 0.009 | 0.009 | 0.009 |
| | ZrO₂ | 0.001 | 0.001 | 0.001 | 0.001 | 0.001 | 0.001 | 0.001 |
| | MoO₃ | 0.00047 | 0.00085 | 0.00072 | 0.00066 | 0.00089 | 0.00094 | 0.00037 |
| Glass | MoO₃ | 10 | 18 | 15 | 14 | 19 | 20 | 8 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.017 | 0.022 | 0.019 | 0.029 | 0.019 | 0.017 | 0.017 |
| MgO + CaO + SrO + | 17.2 | 17.2 | 17.1 | 18.2 | 16.2 | 16.2 | 16.3 |
| BaO | | | | | | | |
| mol % ratio | 14.42 | 7.52 | 9.02 | 10.31 | 7.60 | 6.77 | 18.05 |
| Fe₂O₃/MoO₃ | | | | | | | |
| mol % ratio | 19.83 | 11.02 | 13.23 | 14.17 | 10.44 | 9.92 | 24.81 |
| TiO₂/MoO₃ | | | | | | | |
| CTE [×10⁻⁷/° C.] | 38.2 | 39.3 | 40.4 | 40.1 | 37.6 | 37.5 | 37.4 |
| ρ [g/cm³] | 2.586 | 2.610 | 2.633 | 2.612 | 2.571 | 2.566 | 2.536 |
| E [GPa] | 84 | 83 | 82 | 83 | 82 | 82 | 82 |
| E/ρ [GPa/g · cm⁻³] | 32.5 | 31.8 | 31.3 | 31.8 | 32.1 | 31.8 | 32.5 |
| Ps [° C.] | 727 | 726 | 725 | 717 | 721 | 711 | 713 |
| Ta [° C.] | 782 | 782 | 782 | 772 | 777 | 767 | 768 |
| Ts [° C.] | 1002 | 1010 | 1006 | 993 | 999 | 989 | 988 |
| 10⁴ dPa · s [° C.] | 1298 | 1303 | 1308 | 1293 | 1301 | 1282 | 1278 |
| 10³ dPa · s[° C.] | 1449 | 1454 | 1461 | 1446 | 1457 | 1431 | 1426 |
| 10^{2.5} dPa · s [° C.] | 1547 | 1552 | 1559 | 1545 | 1551 | 1527 | 1522 |
| TL [° C.] | 1200 | 1205 | 1191 | 1222 | 1195 | 1188 | 1178 |
| Log₁₀ ηTL | 4.9 | 4.9 | 5.1 | 4.6 | 5.0 | 4.9 | 5.0 |
| T % (320 nm) | 76.8 | 77.6 | 77.6 | 76.8 | 76.8 | 77.6 | 76.8 |

TABLE 6

| | | No. 76 | No. 77 | No. 78 | No. 79 | No. 80 | No. 81 | No. 82 | No. 83 |
|---|---|---|---|---|---|---|---|---|---|
| Glass | SiO₂ | 64.6 | 64.7 | 66.5 | 66.5 | 66.4 | 67.6 | 67.5 | 64.7 |
| composition | Al₂O₃ | 14.1 | 13.1 | 13.1 | 13.1 | 14.1 | 12.1 | 12.0 | 14.1 |
| (mol %) | B₂O₃ | 4.8 | 4.7 | 3.9 | 4.0 | 3.0 | 2.9 | 3.1 | 3.8 |
| | Li₂O | 0.000 | 0.000 | 0.000 | 0.000 | 0.000 | 0.000 | 0.000 | 0.000 |
| | Na₂O | 0.017 | 0.014 | 0.016 | 0.014 | 0.012 | 0.012 | 0.015 | 0.015 |
| | K₂O | 0.001 | 0.001 | 0.001 | 0.001 | 0.001 | 0.001 | 0.001 | 0.001 |
| | MgO | 6.2 | 6.2 | 6.2 | 6.2 | 6.2 | 6.1 | 6.2 | 7.2 |
| | CaO | 6.1 | 7.1 | 7.1 | 6.1 | 6.1 | 7.1 | 7.1 | 6.1 |
| | SrO | 0.0 | 2.0 | 1.0 | 2.0 | 2.0 | 4.0 | 0.0 | 4.0 |
| | BaO | 4.0 | 2.0 | 2.0 | 2.0 | 2.0 | 0.0 | 4.0 | 0.0 |
| | SnO₂ | 0.1 | 0.1 | 0.1 | 0.1 | 0.1 | 0.1 | 0.1 | 0.1 |
| | Fe₂O₃ | 0.003 | 0.004 | 0.004 | 0.004 | 0.004 | 0.004 | 0.003 | 0.004 |
| | TiO₂ | 0.001 | 0.002 | 0.001 | 0.002 | 0.002 | 0.001 | 0.002 | 0.001 |
| | ZrO₂ | 0.001 | 0.001 | 0.001 | 0.001 | 0.001 | 0.001 | 0.001 | 0.001 |
| | MoO₃ | 0.00057 | 0.00047 | 0.00023 | 0.00033 | 0.00042 | 0.00032 | 0.00028 | 0.00069 |
| Glass | MoO₃ | 12 | 10 | 5 | 7 | 9 | 7 | 6 | 15 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.018 | 0.015 | 0.017 | 0.015 | 0.013 | 0.014 | 0.016 | 0.016 |
| MgO + CaO + SrO + | 16.3 | 17.4 | 16.4 | 16.3 | 16.3 | 17.3 | 17.3 | 17.3 |
| BaO | | | | | | | | |
| mol % ratio | 6.01 | 8.12 | 16.23 | 11.58 | 9.01 | 12.89 | 12.01 | 5.41 |
| Fe₂O₃/MoO₃ | | | | | | | | |
| mol % ratio | 1.50 | 3.61 | 3.61 | 5.15 | 4.00 | 2.58 | 6.00 | 1.20 |
| TiO₂/MoO₃ | | | | | | | | |
| CTE [×10⁻⁷/° C.] | 38.0 | 39.3 | 37.4 | 37.8 | 37.4 | 38.8 | 39.5 | 38.0 |
| ρ [g/cm³] | 2.594 | 2.572 | 2.549 | 2.564 | 2.576 | 2.547 | 2.599 | 2.553 |
| E [GPa] | 81 | 81 | 82 | 82 | 84 | 83 | 81 | 84 |
| E/ρ [GPa/g · cm⁻³] | 31.2 | 31.6 | 32.1 | 31.9 | 32.4 | 32.5 | 31.3 | 33.1 |
| Ps [° C.] | 713 | 704 | 715 | 715 | 729 | 716 | 714 | 718 |
| Ta [° C.] | 768 | 758 | 771 | 771 | 786 | 772 | 770 | 772 |
| Ts [° C.] | 991 | 978 | 997 | 998 | 1010 | 997 | 999 | 989 |
| 10⁴ dPa · s [° C.] | 1284 | 1273 | 1299 | 1306 | 1321 | 1308 | 1314 | 1276 |
| 10³ dPa · s[° C.] | 1433 | 1424 | 1452 | 1462 | 1481 | 1468 | 1475 | 1422 |
| 10^{2.5} dPa · s [° C.] | 1529 | 1523 | 1555 | 1564 | 1583 | 1572 | 1578 | 1519 |
| TL [° C.] | 1171 | 1160 | 1170 | 1213 | 1219 | 1245 | 1186 | 1178 |
| Log₁₀ ηTL | 5.1 | 5.1 | 5.2 | 4.8 | 4.9 | 4.5 | 5.1 | 4.9 |
| T % (320 nm) | 83.3 | 82.5 | 82.5 | 82.5 | 82.5 | 81.7 | 83.3 | 82.5 |

| | | No. 84 | No. 85 | No. 86 | No. 87 | No. 88 | No. 89 | No. 90 |
|---|---|---|---|---|---|---|---|---|
| Glass | SiO₂ | 64.6 | 65.6 | 66.4 | 65.6 | 66.4 | 66.5 | 67.3 |
| composition | Al₂O₃ | 14.0 | 14.1 | 14.2 | 14.1 | 14.2 | 14.1 | 14.2 |
| (mol %) | B₂O₃ | 3.9 | 3.9 | 3.9 | 3.9 | 3.9 | 2.9 | 3.1 |
| | Li₂O | 0.000 | 0.000 | 0.000 | 0.000 | 0.000 | 0.000 | 0.000 |
| | Na₂O | 0.013 | 0.015 | 0.013 | 0.012 | 0.020 | 0.017 | 0.030 |
| | K₂O | 0.001 | 0.001 | 0.001 | 0.001 | 0.002 | 0.002 | 0.002 |
| | MgO | 7.2 | 6.2 | 6.2 | 6.2 | 6.2 | 6.2 | 6.2 |
| | CaO | 6.1 | 7.1 | 7.2 | 6.1 | 6.1 | 7.1 | 7.1 |
| | SrO | 0.0 | 1.0 | 0.0 | 1.5 | 0.5 | 1.0 | 0.0 |
| | BaO | 4.0 | 2.0 | 2.0 | 2.5 | 2.5 | 2.0 | 2.0 |
| | SnO₂ | 0.1 | 0.1 | 0.1 | 0.1 | 0.1 | 0.1 | 0.1 |
| | Fe₂O₃ | 0.003 | 0.004 | 0.004 | 0.003 | 0.003 | 0.003 | 0.003 |
| | TiO₂ | 0.002 | 0.002 | 0.002 | 0.002 | 0.002 | 0.001 | 0.002 |
| | ZrO₂ | 0.001 | 0.001 | 0.001 | 0.001 | 0.001 | 0.001 | 0.001 |
| | MoO₃ | 0.00095 | 0.00075 | 0.00056 | 0.00094 | 0.00122 | 0.00112 | 0.00079 |
| Glass | MoO₃ | 20 | 16 | 12 | 20 | 26 | 24 | 17 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.014 | 0.016 | 0.014 | 0.014 | 0.023 | 0.019 | 0.032 |
| MgO + CaO + SrO + | 17.3 | 16.3 | 15.4 | 16.3 | 15.4 | 16.4 | 15.4 |
| BaO | | | | | | | |
| mol % ratio | 3.60 | 5.08 | 6.76 | 3.16 | 2.43 | 2.63 | 3.72 |
| Fe₂O₃/MoO₃ | | | | | | | |
| mol % ratio | 1.80 | 2.25 | 3.00 | 1.80 | 1.39 | 0.75 | 2.12 |
| TiO₂/MoO₃ | | | | | | | |
| CTE [×10⁻⁷/° C.] | 38.6 | 37.2 | 35.3 | 37.7 | 36.0 | 37.2 | 35.4 |
| ρ [g/cm³] | 2.608 | 2.557 | 2.530 | 2.577 | 2.552 | 2.563 | 2.536 |
| E [GPa] | 83 | 83 | 83 | 83 | 83 | 84 | 84 |
| E/ρ [GPa/g · cm⁻³] | 31.8 | 32.5 | 32.9 | 32.1 | 32.4 | 32.8 | 33.2 |
| Ps [° C.] | 716 | 719 | 723 | 719 | 723 | 730 | 733 |
| Ta [° C.] | 771 | 776 | 780 | 775 | 779 | 786 | 790 |
| Ts [° C.] | 992 | 998 | 1004 | 999 | 1005 | 1009 | 1015 |
| 10⁴ dPa · s [° C.] | 1286 | 1291 | 1305 | 1295 | 1304 | 1310 | 1322 |
| 10³ dPa · s[° C.] | 1434 | 1442 | 1464 | 1444 | 1456 | 1462 | 1482 |
| 10^{2.5} dPa · s [° C.] | 1531 | 1538 | 1571 | 1542 | 1553 | 1561 | 1592 |
| TL [° C.] | 1207 | 1192 | 1270 | 1189 | 1266 | 1221 | 1285 |
| Log₁₀ ηTL | 4.7 | 4.9 | 4.3 | 5.0 | 4.3 | 4.8 | 4.3 |
| T % (320 nm) | 83.3 | 82.5 | 82.5 | 84.1 | 84.1 | 84.1 | 84.1 |

TABLE 7

| | | No. 91 | No. 92 | No. 93 | No. 94 | No. 95 | No. 96 | No. 97 | No. 98 |
|---|---|---|---|---|---|---|---|---|---|
| Glass | SiO₂ | 66.4 | 65.5 | 66.7 | 66.3 | 66.8 | 66.8 | 67.2 | 67.6 |
| composition | Al₂O₃ | 13.1 | 14.1 | 14.0 | 14.5 | 14.0 | 14.0 | 13.5 | 13.1 |
| (mol %) | B₂O₃ | 4.1 | 3.9 | 3.0 | 2.9 | 2.9 | 2.9 | 3.0 | 2.9 |
| | Li₂O | 0.000 | 0.000 | 0.000 | 0.000 | 0.000 | 0.000 | 0.000 | 0.000 |
| | Na₂O | 0.024 | 0.027 | 0.016 | 0.030 | 0.016 | 0.015 | 0.015 | 0.020 |
| | K₂O | 0.004 | 0.004 | 0.002 | 0.005 | 0.003 | 0.001 | 0.002 | 0.002 |
| | MgO | 6.2 | 6.2 | 6.1 | 6.1 | 6.1 | 6.1 | 6.1 | 6.2 |
| | CaO | 5.1 | 5.1 | 6.1 | 6.1 | 6.0 | 6.0 | 6.1 | 6.1 |
| | SrO | 2.5 | 2.5 | 2.0 | 2.0 | 3.0 | 1.0 | 2.0 | 2.0 |
| | BaO | 2.5 | 2.5 | 2.0 | 2.0 | 1.0 | 3.0 | 2.0 | 2.0 |
| | SnO₂ | 0.1 | 0.1 | 0.1 | 0.1 | 0.1 | 0.1 | 0.1 | 0.1 |
| | Fe₂O₃ | 0.003 | 0.003 | 0.003 | 0.003 | 0.006 | 0.006 | 0.006 | 0.006 |
| | TiO₂ | 0.002 | 0.002 | 0.002 | 0.002 | 0.003 | 0.009 | 0.008 | 0.008 |
| | ZrO₂ | 0.001 | 0.001 | 0.001 | 0.001 | 0.001 | 0.001 | 0.001 | 0.001 |
| | MoO₃ | 0.00095 | 0.00076 | 0.00056 | 0.00094 | 0.00089 | 0.00137 | 0.00108 | 0.00173 |
| Glass | MoO₃ | 20 | 16 | 12 | 20 | 19 | 29 | 23 | 37 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.028 | 0.031 | 0.018 | 0.035 | 0.019 | 0.017 | 0.017 | 0.022 |
| MgO + CaO + SrO + | 16.3 | 16.3 | 16.2 | 16.2 | 16.2 | 16.1 | 16.2 | 16.3 |
| BaO | | | | | | | | |
| mol % ratio | 3.15 | 3.94 | 6.01 | 3.61 | 6.64 | 4.35 | 5.49 | 3.43 |
| Fe₂O₃/MoO₃ | | | | | | | | |
| mol % ratio | 1.80 | 2.25 | 3.00 | 1.80 | 2.85 | 6.21 | 7.05 | 4.90 |
| TiO₂/MoO₃ | | | | | | | | |
| CTE [×10⁻⁷/° C.] | 38.2 | 37.9 | 37.2 | 37.0 | 37.1 | 37.2 | 36.8 | 37.3 |
| ρ [g/cm³] | 2.561 | 2.584 | 2.576 | 2.581 | 2.563 | 2.589 | 2.572 | 2.567 |
| E [GPa] | 81 | 82 | 84 | 84 | 84 | 83 | 83 | 83 |
| E/ρ [GPa/g · cm⁻³] | 31.8 | 31.9 | 32.5 | 32.6 | 32.7 | 32.2 | 32.4 | 32.3 |
| Ps [° C.] | 714 | 720 | 731 | 733 | 733 | 733 | 728 | 727 |
| Ta [° C.] | 771 | 776 | 787 | 789 | 789 | 789 | 785 | 784 |
| Ts [° C.] | 998 | 1000 | 1011 | 1011 | 1011 | 1013 | 1010 | 1012 |
| 10⁴ dPa · s [° C.] | 1306 | 1299 | 1312 | 1308 | 1311 | 1317 | 1315 | 1319 |
| 10³ dPa · s[° C.] | 1466 | 1450 | 1466 | 1458 | 1463 | 1471 | 1469 | 1474 |
| 10^{2.5} dPa · s [° C.] | 1572 | 1549 | 1564 | 1556 | 1562 | 1570 | 1568 | 1574 |
| TL [° C.] | 1211 | 1195 | 1202 | 1239 | 1214 | 1208 | 1197 | 1188 |
| Log₁₀ ηTL | 4.8 | 5.0 | 5.0 | 4.6 | 4.9 | 5.0 | 5.1 | 5.2 |
| T % (320 nm) | 84.1 | 84.1 | 83.3 | 83.3 | 78.5 | 78.5 | 78.4 | 78.4 |

| | | | No. | No. | No. | No. | No. | No. |
|---|---|---|---|---|---|---|---|---|
| | | No. 99 | 100 | 101 | 102 | 103 | 104 | 105 |
| Glass | SiO₂ | 66.7 | 65.8 | 68.7 | 67.5 | 67.2 | 67.2 | 68.4 |
| composition | Al₂O₃ | 14.0 | 13.0 | 12.5 | 12.2 | 12.2 | 12.2 | 12.5 |
| (mol %) | B₂O₃ | 3.0 | 3.9 | 2.9 | 2.8 | 3.4 | 2.6 | 2.9 |
| | Li₂O | 0.000 | 0.000 | 0.000 | 0.000 | 0.000 | 0.000 | 0.000 |
| | Na₂O | 0.018 | 0.027 | 0.017 | 0.015 | 0.015 | 0.017 | 0.014 |
| | K₂O | 0.001 | 0.002 | 0.001 | 0.001 | 0.001 | 0.001 | 0.001 |
| | MgO | 5.1 | 6.1 | 7.1 | 7.0 | 7.2 | 8.1 | 8.1 |
| | CaO | 6.1 | 6.1 | 5.2 | 5.8 | 6.4 | 7.3 | 4.5 |
| | SrO | 2.0 | 1.5 | 1.3 | 1.3 | 1.3 | 1.3 | 2.3 |
| | BaO | 3.0 | 3.5 | 2.1 | 3.2 | 2.1 | 1.2 | 1.2 |
| | SnO₂ | 0.1 | 0.1 | 0.1 | 0.1 | 0.1 | 0.1 | 0.1 |
| | Fe₂O₃ | 0.006 | 0.006 | 0.006 | 0.006 | 0.006 | 0.006 | 0.006 |
| | TiO₂ | 0.009 | 0.009 | 0.008 | 0.008 | 0.008 | 0.008 | 0.008 |
| | ZrO₂ | 0.001 | 0.001 | 0.001 | 0.001 | 0.001 | 0.001 | 0.001 |
| | MoO₃ | 0.00139 | 0.00209 | 0.00079 | 0.00047 | 0.00037 | 0.00073 | 0.00078 |
| Glass | MoO₃ | 29 | 44 | 17 | 10 | 8 | 16 | 17 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.019 | 0.029 | 0.019 | 0.017 | 0.017 | 0.018 | 0.015 |
| MgO + CaO + SrO + | 16.2 | 17.2 | 15.8 | 17.3 | 17.0 | 17.9 | 16.1 |
| BaO | | | | | | | |
| mol % ratio | 4.35 | 2.87 | 7.42 | 12.62 | 16.89 | 8.44 | 7.41 |
| Fe₂O₃/MoO₃ | | | | | | | |
| mol % ratio | 6.22 | 4.10 | 9.53 | 16.22 | 22.51 | 11.25 | 10.58 |
| TiO₂/MoO₃ | | | | | | | |
| CTE [×10⁻⁷/° C.] | 38.5 | 39.6 | 35.8 | 38.8 | 37.8 | 38.1 | 35.7 |
| ρ [g/cm³] | 2.606 | 2.610 | 2.547 | 2.596 | 2.555 | 2.544 | 2.535 |
| E [GPa] | 83 | 81 | 83 | 82 | 82 | 84 | 84 |
| E/ρ [GPa/g · cm⁻³] | 31.7 | 31.2 | 32.4 | 31.7 | 32.2 | 33.1 | 33.0 |
| Ps [° C.] | 730 | 714 | 727 | 718 | 713 | 721 | 726 |
| Ta [° C.] | 787 | 727 | 784 | 775 | 768 | 775 | 782 |
| Ts [° C.] | 1014 | 993 | 1014 | 1002 | 994 | 996 | 1010 |
| 10⁴ dPa · s [° C.] | 1318 | 1296 | 1326 | 1310 | 1298 | 1293 | 1318 |
| 10³ dPa · s[° C.] | 1472 | 1449 | 1483 | 1465 | 1456 | 1446 | 1474 |
| 10^{2.5} dPa · s [° C.] | 1571 | 1548 | 1585 | 1566 | 1558 | 1545 | 1574 |
| TL [° C.] | 1204 | 1155 | 1220 | 1158 | 1183 | 1208 | 1247 |
| Log₁₀ ηTL | 5.0 | 5.4 | 4.9 | 5.4 | 5.1 | 4.8 | 4.6 |
| T % (320 nm) | 78.4 | 78.4 | 78.5 | 78.5 | 77.7 | 77.7 | 78.5 |

TABLE 8

| | | No. | No. | No. | No. | No. | No. | No. | No. |
|---|---|---|---|---|---|---|---|---|---|
| | | 106 | 107 | 108 | 109 | 110 | 111 | 112 | 113 |
| Glass | SiO₂ | 68.1 | 67.8 | 67.9 | 67.8 | 66.9 | 67.4 | 67.0 | 66.7 |
| composition | Al₂O₃ | 12.7 | 13.0 | 12.5 | 13.0 | 13.0 | 13.0 | 13.5 | 13.0 |
| (mol %) | B₂O₃ | 5.1 | 2.8 | 2.8 | 2.8 | 3.8 | 3.7 | 2.8 | 3.0 |
| | Li₂O | 0.000 | 0.000 | 0.000 | 0.000 | 0.000 | 0.000 | 0.000 | 0.000 |
| | Na₂O | 0.016 | 0.014 | 0.012 | 0.012 | 0.015 | 0.015 | 0.013 | 0.015 |
| | K₂O | 0.001 | 0.001 | 0.001 | 0.001 | 0.001 | 0.001 | 0.001 | 0.001 |
| | MgO | 5.4 | 5.1 | 6.1 | 5.6 | 6.1 | 6.1 | 5.6 | 5.1 |
| | CaO | 5.2 | 6.6 | 6.6 | 6.6 | 6.6 | 6.5 | 6.6 | 6.6 |
| | SrO | 0.0 | 1.5 | 2.0 | 0.5 | 1.5 | 1.5 | 1.5 | 2.5 |
| | BaO | 3.4 | 3.0 | 2.0 | 3.5 | 2.0 | 1.5 | 2.8 | 3.0 |
| | SnO₂ | 0.1 | 0.1 | 0.1 | 0.1 | 0.1 | 0.1 | 0.1 | 0.1 |
| | Fe₂O₃ | 0.006 | 0.006 | 0.006 | 0.006 | 0.006 | 0.006 | 0.006 | 0.006 |
| | TiO₂ | 0.009 | 0.009 | 0.008 | 0.009 | 0.008 | 0.007 | 0.009 | 0.008 |
| | ZrO₂ | 0.001 | 0.001 | 0.001 | 0.001 | 0.001 | 0.001 | 0.001 | 0.001 |
| | MoO₃ | 0.00071 | 0.00047 | 0.00037 | 0.00076 | 0.00037 | 0.00088 | 0.00137 | 0.00057 |
| Glass | MoO₃ | 15 | 10 | 8 | 16 | 8 | 19 | 29 | 12 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.017 | 0.015 | 0.013 | 0.014 | 0.016 | 0.016 | 0.014 | 0.016 |
| MgO + CaO + SrO + | 14.0 | 16.2 | 16.7 | 16.2 | 16.2 | 15.7 | 16.5 | 17.2 |
| BaO | | | | | | | | |
| mol % ratio | 7.81 | 12.62 | 15.75 | 7.88 | 15.76 | 6.64 | 4.36 | 10.52 |
| Fe₂O₃/MoO₃ | | | | | | | | |
| mol % ratio | 13.21 | 18.02 | 22.50 | 11.26 | 20.25 | 8.53 | 6.22 | 13.52 |
| TiO₂/MoO₃ | | | | | | | | |
| CTE [×10⁻⁷/° C.] | 34.9 | 38.5 | 38.2 | 38.1 | 37.5 | 36.6 | 38.4 | 40.4 |
| ρ [g/cm³] | 2.536 | 2.590 | 2.569 | 2.588 | 2.554 | 2.534 | 2.592 | 2.619 |
| E [GPa] | 79 | 82 | 82 | 82 | 82 | 82 | 83 | 82 |
| E/ρ [GPa/g · cm⁻³] | 31.2 | 31.7 | 32.1 | 31.7 | 32.1 | 32.5 | 32.0 | 31.3 |
| Ps [° C.] | 714 | 726 | 722 | 727 | 717 | 719 | 728 | 721 |
| Ta [° C.] | 772 | 783 | 778 | 784 | 774 | 776 | 784 | 778 |
| Ts [° C.] | 1007 | 1013 | 1006 | 1013 | 999 | 1003 | 1010 | 1004 |
| 10⁴ dPa · s [° C.] | 1325 | 1323 | 1314 | 1322 | 1303 | 1306 | 1315 | 1310 |
| 10³ dPa · s[° C.] | 1485 | 1481 | 1472 | 1481 | 1457 | 1461 | 1470 | 1466 |
| 10^{2.5} dPa · s [° C.] | 1586 | 1582 | 1572 | 1584 | 1556 | 1560 | 1571 | 1566 |
| TL [° C.] | 1197 | 1202 | 1188 | 1181 | 1173 | 1180 | 1200 | 1227 |
| Log₁₀ ηTL | 5.1 | 5.1 | 5.2 | 5.3 | 5.2 | 5.2 | 5.1 | 4.7 |
| T % (320 nm) | 79.3 | 78.5 | 78.5 | 78.5 | 78.5 | 78.5 | 78.4 | 78.5 |

| | | No. | No. | No. | No. | No. | No. | No. |
|---|---|---|---|---|---|---|---|---|
| | | 114 | 115 | 116 | 117 | 118 | 119 | 120 |
| Glass | SiO₂ | 67.2 | 68.7 | 67.3 | 68.1 | 67.8 | 67.9 | 68.1 |
| composition | Al₂O₃ | 12.2 | 12.7 | 12.3 | 12.5 | 12.7 | 12.7 | 13.0 |
| (mol %) | B₂O₃ | 2.8 | 4.4 | 2.8 | 3.0 | 2.9 | 3.0 | 3.0 |
| | Li₂O | 0.000 | 0.000 | 0.000 | 0.000 | 0.000 | 0.000 | 0.000 |
| | Na₂O | 0.013 | 0.012 | 0.020 | 0.017 | 0.030 | 0.024 | 0.027 |
| | K₂O | 0.001 | 0.001 | 0.002 | 0.002 | 0.002 | 0.004 | 0.004 |
| | MgO | 7.1 | 5.0 | 7.2 | 6.1 | 6.1 | 5.9 | 5.8 |
| | CaO | 7.3 | 5.1 | 6.2 | 6.5 | 6.3 | 6.4 | 5.9 |
| | SrO | 1.3 | 3.2 | 1.2 | 1.7 | 1.7 | 1.4 | 1.4 |
| | BaO | 2.2 | 0.8 | 3.0 | 2.0 | 2.3 | 2.6 | 2.6 |
| | SnO₂ | 0.1 | 0.1 | 0.1 | 0.1 | 0.1 | 0.1 | 0.1 |
| | Fe₂O₃ | 0.006 | 0.006 | 0.006 | 0.006 | 0.006 | 0.006 | 0.006 |
| | TiO₂ | 0.007 | 0.008 | 0.009 | 0.008 | 0.008 | 0.008 | 0.008 |
| | ZrO₂ | 0.001 | 0.001 | 0.001 | 0.001 | 0.001 | 0.001 | 0.001 |
| | MoO₃ | 0.00046 | 0.00023 | 0.00023 | 0.00042 | 0.0033 | 0.00028 | 0.00070 |
| Glass | MoO₃ | 10 | 5 | 5 | 9 | 7 | 6 | 15 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.014 | 0.014 | 0.023 | 0.019 | 0.032 | 0.028 | 0.031 |
| MgO + CaO + SrO + | 17.8 | 14.1 | 17.5 | 16.4 | 16.5 | 16.3 | 15.7 |
| BaO | | | | | | | |
| mol % ratio | 13.51 | 25.87 | 25.17 | 14.00 | 18.01 | 21.00 | 8.41 |
| Fe₂O₃/MoO₃ | | | | | | | |
| mol % ratio | 16.21 | 33.25 | 39.54 | 19.99 | 25.72 | 29.99 | 12.01 |
| TiO₂/MoO₃ | | | | | | | |
| CTE [×10⁻⁷/° C.] | 39.1 | 35.2 | 38.9 | 37.7 | 38.1 | 37.8 | 37.3 |
| ρ [g/cm³] | 2.574 | 2.520 | 2.593 | 2.561 | 2.572 | 2.575 | 2.569 |
| E [GPa] | 83 | 80 | 83 | 82 | 82 | 82 | 82 |
| E/ρ [GPa/g · cm⁻³] | 32.4 | 31.9 | 32.0 | 32.2 | 32.1 | 31.9 | 31.8 |
| Ps [° C.] | 717 | 722 | 719 | 726 | 723 | 725 | 728 |
| Ta [° C.] | 773 | 780 | 775 | 783 | 780 | 783 | 786 |
| Ts [° C.] | 996 | 1013 | 1001 | 1010 | 1008 | 1011 | 1016 |
| 10⁴ dPa · s [° C.] | 1300 | 1333 | 1309 | 1318 | 1316 | 1320 | 1326 |
| 10³ dPa · s[° C.] | 1455 | 1495 | 1465 | 1476 | 1473 | 1477 | 1482 |
| 10^{2.5} dPa · s [° C.] | 1556 | 1601 | 1566 | 1576 | 1575 | 1578 | 1583 |
| TL [° C.] | 1192 | 1208 | 1183 | 1201 | 1196 | 1191 | 1207 |
| Log₁₀ ηTL | 5.0 | 5.1 | 5.2 | 5.1 | 5.1 | 5.2 | 5.1 |
| T % (320 nm) | 77.7 | 78.2 | 78.5 | 78.5 | 78.5 | 78.5 | 78.5 |

TABLE 9

| | | No. | No. | No. | No. | No. | No. | No. | No. |
|---|---|---|---|---|---|---|---|---|---|
| | | 121 | 122 | 123 | 124 | 125 | 126 | 127 | 128 |
| Glass | SiO₂ | 67.1 | 67.2 | 67.4 | 67.0 | 68.3 | 68.0 | 68.3 | 67.9 |
| composition | Al₂O₃ | 12.1 | 12.0 | 12.0 | 12.1 | 12.0 | 12.1 | 12.0 | 12.1 |
| (mol %) | B₂O₃ | 2.0 | 2.0 | 1.8 | 2.0 | 2.0 | 2.0 | 1.9 | 2.0 |
| | Li₂O | 0.000 | 0.000 | 0.000 | 0.000 | 0.000 | 0.000 | 0.000 | 0.000 |
| | Na₂O | 0.016 | 0.030 | 0.024 | 0.023 | 0.020 | 0.032 | 0.020 | 0.018 |
| | K₂O | 0.002 | 0.005 | 0.004 | 0.005 | 0.004 | 0.003 | 0.003 | 0.003 |
| | MgO | 6.7 | 6.6 | 6.6 | 6.7 | 6.6 | 6.7 | 6.6 | 6.7 |
| | CaO | 7.1 | 7.1 | 6.0 | 8.1 | 8.1 | 7.1 | 7.1 | 6.1 |
| | SrO | 3.0 | 2.0 | 4.0 | 2.0 | 1.0 | 2.0 | 1.0 | 3.0 |
| | BaO | 2.0 | 3.0 | 2.0 | 2.0 | 2.0 | 2.0 | 3.0 | 2.0 |
| | SnO₂ | 0.1 | 0.1 | 0.1 | 0.1 | 0.1 | 0.1 | 0.1 | 0.1 |
| | Fe₂O₃ | 0.006 | 0.006 | 0.006 | 0.006 | 0.006 | 0.006 | 0.006 | 0.006 |
| | TiO₂ | 0.008 | 0.008 | 0.008 | 0.008 | 0.008 | 0.007 | 0.008 | 0.008 |
| | ZrO₂ | 0.001 | 0.001 | 0.001 | 0.001 | 0.001 | 0.001 | 0.001 | 0.001 |
| | MoO₃ | 0.00093 | 0.00075 | 0.00047 | 0.00092 | 0.00550 | 0.00037 | 0.00074 | 0.00047 |
| Glass | MoO₃ | 20 | 16 | 10 | 20 | 120 | 8 | 16 | 10 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.018 | 0.035 | 0.029 | 0.028 | 0.024 | 0.035 | 0.023 | 0.021 |
| MgO + CaO + SrO + | 18.7 | 18.7 | 18.6 | 18.8 | 17.7 | 17.8 | 17.7 | 17.9 |
| BaO | | | | | | | | |
| mol % ratio | 6.33 | 7.88 | 12.63 | 6.75 | 1.13 | 15.76 | 7.88 | 12.61 |
| Fe₂O₃/MoO₃ | | | | | | | | |
| mol % ratio | 9.04 | 11.25 | 16.23 | 9.00 | 1.50 | 20.25 | 11.26 | 18.00 |
| TiO₂/MoO₃ | | | | | | | | |
| CTE [×10⁻⁷/° C.] | 40.9 | 41.6 | 41.2 | 40.4 | 39.0 | 39.1 | 39.4 | 39.8 |
| ρ [g/cm³] | 2.611 | 2.624 | 2.626 | 2.596 | 2.567 | 2.582 | 2.595 | 2.596 |
| E [GPa] | 84 | 83 | 83 | 84 | 84 | 84 | 83 | 83 |
| E/ρ [GPa/g · cm⁻³] | 32.1 | 31.8 | 31.8 | 32.3 | 32.6 | 32.3 | 32.1 | 32.1 |
| Ps [° C.] | 722 | 721 | 721 | 722 | 725 | 725 | 725 | 726 |
| Ta [° C.] | 777 | 776 | 777 | 778 | 782 | 782 | 782 | 783 |
| Ts [° C.] | 999 | 1000 | 1000 | 999 | 1008 | 1009 | 1009 | 1010 |
| 10⁴ dPa · s [° C.] | 1302 | 1305 | 1304 | 1300 | 1315 | 1323 | 1322 | 1319 |
| 10³ dPa · s[° C.] | 1456 | 1461 | 1460 | 1455 | 1473 | 1480 | 1480 | 1477 |
| 10^{2.5} dPa · s [° C.] | 1557 | 1562 | 1560 | 1554 | 1574 | 1584 | 1582 | 1579 |
| TL [° C.] | 1218 | 1204 | 1236 | 1216 | 1219 | 1201 | 1210 | 1222 |
| Log₁₀ ηTL | 4.7 | 4.9 | 4.6 | 4.7 | 4.8 | 5.1 | 5.0 | 4.9 |
| T % (320 nm) | 78.4 | 78.5 | 78.5 | 77.7 | 77.6 | 78.5 | 78.5 | 78.5 |

| | | No. | No. | No. | No. | No. | No. | No. |
|---|---|---|---|---|---|---|---|---|
| | | 129 | 130 | 131 | 132 | 133 | 134 | 135 |
| Glass | SiO₂ | 67.7 | 68.2 | 69.5 | 67.4 | 67.2 | 67.5 | 67.2 |
| composition | Al₂O₃ | 12.8 | 12.6 | 12.5 | 13.0 | 13.0 | 12.9 | 13.3 |
| (mol %) | B₂O₃ | 3.1 | 4.6 | 5.7 | 3.7 | 3.9 | 3.6 | 3.5 |
| | Li₂O | 0.000 | 0.000 | 0.000 | 0.000 | 0.000 | 0.000 | 0.000 |
| | Na₂O | 0.016 | 0.015 | 0.015 | 0.020 | 0.018 | 0.027 | 0.017 |
| | K₂O | 0.003 | 0.001 | 0.002 | 0.002 | 0.001 | 0.002 | 0.001 |
| | MgO | 5.9 | 5.1 | 1.3 | 6.1 | 6.1 | 6.1 | 6.1 |
| | CaO | 6.5 | 5.4 | 8.6 | 6.5 | 6.5 | 6.5 | 6.5 |
| | SrO | 1.4 | 3.2 | 1.6 | 1.5 | 1.5 | 1.5 | 1.5 |
| | BaO | 2.6 | 0.8 | 0.7 | 1.5 | 1.7 | 1.7 | 1.7 |
| | SnO₂ | 0.1 | 0.1 | 0.1 | 0.1 | 0.1 | 0.1 | 0.1 |
| | Fe₂O₃ | 0.006 | 0.006 | 0.005 | 0.005 | 0.005 | 0.005 | 0.005 |
| | TiO₂ | 0.008 | 0.008 | 0.007 | 0.007 | 0.007 | 0.006 | 0.008 |
| | ZrO₂ | 0.001 | 0.001 | 0.001 | 0.001 | 0.001 | 0.001 | 0.001 |
| | MoO₃ | 0.00094 | 0.00028 | 0.00037 | 0.00028 | 0.00037 | 0.00074 | 0.00046 |
| Glass | MoO₃ | 20 | 6 | 8 | 6 | 8 | 16 | 10 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.019 | 0.017 | 0.017 | 0.022 | 0.019 | 0.029 | 0.019 |
| MgO + CaO + SrO + | 16.3 | 14.5 | 12.2 | 15.7 | 15.9 | 15.9 | 15.9 |
| BaO | | | | | | | |
| mol % ratio | 6.31 | 22.53 | 13.51 | 18.01 | 13.52 | 6.75 | 10.80 |
| Fe₂O₃/MoO₃ | | | | | | | |
| mol % ratio | 9.00 | 30.02 | 18.01 | 24.01 | 18.02 | 7.87 | 16.20 |
| TiO₂/MoO₃ | | | | | | | |
| CTE [×10⁻⁷/° C.] | 38.0 | 35.8 | 34.8 | 36.8 | 37.1 | 37.1 | 37.2 |
| ρ [g/cm³] | 2.575 | 2.524 | 2.465 | 2.534 | 2.542 | 2.544 | 2.546 |
| E [GPa] | 82 | 81 | 77 | 82 | 82 | 83 | 82 |
| E/ρ [GPa/g · cm⁻³] | 31.9 | 32.1 | 31.3 | 32.5 | 32.3 | 32.4 | 32.4 |
| Ps [° C.] | 724 | 719 | 717 | 720 | 720 | 723 | 724 |
| Ta [° C.] | 781 | 777 | 778 | 777 | 776 | 780 | 781 |
| Ts [° C.] | 1010 | 1011 | 1018 | 1004 | 1002 | 1006 | 1006 |
| 10⁴ dPa · s [° C.] | 1322 | 1325 | 1344 | 1311 | 1309 | 1314 | 1309 |
| 10³ dPa · s[° C.] | 1477 | 1485 | 1507 | 1466 | 1462 | 1468 | 1463 |
| 10^{2.5} dPa · s [° C.] | 1576 | 1588 | 1613 | 1564 | 1560 | 1566 | 1561 |
| TL [° C.] | 1178 | 1182 | 1174 | 1174 | 1182 | 1169 | 1197 |
| Log₁₀ ηTL | 5.3 | 5.3 | 5.5 | 5.3 | 5.2 | 5.4 | 5.0 |
| T % (320 nm) | 78.5 | 77.7 | 80.1 | 80.1 | 80.1 | 80.1 | 80.1 |

TABLE 10

| | | No. | No. | No. | No. | No. | No. | No. | No. |
|---|---|---|---|---|---|---|---|---|---|
| | | 136 | 137 | 138 | 139 | 140 | 141 | 142 | 143 |
| Glass | SiO₂ | 67.1 | 67.1 | 67.6 | 68.1 | 67.8 | 68.1 | 67.5 | 67.5 |
| composition | Al₂O₃ | 13.0 | 12.9 | 12.1 | 12.1 | 12.2 | 12.2 | 13.0 | 13.1 |
| (mol %) | B₂O₃ | 3.6 | 3.7 | 2.8 | 2.9 | 2.8 | 2.9 | 3.4 | 3.3 |
| | Li₂O | 0.000 | 0.000 | 0.000 | 0.000 | 0.000 | 0.000 | 0.000 | 0.000 |
| | Na₂O | 0.015 | 0.015 | 0.017 | 0.014 | 0.016 | 0.014 | 0.012 | 0.012 |
| | K₂O | 0.001 | 0.001 | 0.001 | 0.001 | 0.001 | 0.001 | 0.001 | 0.001 |
| | MgO | 6.4 | 6.1 | 7.2 | 6.6 | 7.0 | 6.6 | 6.2 | 6.2 |
| | CaO | 6.5 | 6.5 | 6.3 | 6.2 | 6.3 | 6.2 | 6.5 | 6.5 |
| | SrO | 1.5 | 1.5 | 1.4 | 1.4 | 1.5 | 1.5 | 1.5 | 1.6 |
| | BaO | 1.7 | 2.0 | 2.6 | 2.6 | 2.4 | 2.3 | 1.7 | 1.7 |
| | SnO₂ | 0.1 | 0.1 | 0.1 | 0.1 | 0.1 | 0.1 | 0.1 | 0.1 |
| | Fe₂O₃ | 0.005 | 0.005 | 0.005 | 0.005 | 0.005 | 0.005 | 0.005 | 0.005 |
| | TiO₂ | 0.007 | 0.007 | 0.007 | 0.008 | 0.007 | 0.007 | 0.006 | 0.005 |
| | ZrO₂ | 0.001 | 0.007 | 0.001 | 0.001 | 0.001 | 0.001 | 0.001 | 0.001 |
| | MoO₃ | 0.00037 | 0.00070 | 0.00093 | 0.00074 | 0.00028 | 0.00037 | 0.00074 | 0.00046 |
| Glass | MoO₃ | 8 | 15 | 20 | 16 | 6 | 8 | 16 | 10 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.017 | 0.017 | 0.018 | 0.015 | 0.017 | 0.015 | 0.013 | 0.014 |
| MgO + CaO + SrO + | 16.1 | 16.2 | 17.4 | 16.8 | 17.1 | 16.7 | 15.9 | 16.0 |
| BaO | | | | | | | | |
| mol % ratio | 13.50 | 7.20 | 4.96 | 6.20 | 18.05 | 13.52 | 6.76 | 10.81 |
| Fe₂O₃/MoO₃ | | | | | | | | |
| mol % ratio | 18.00 | 9.60 | 7.21 | 10.14 | 24.06 | 18.02 | 7.88 | 10.80 |
| TiO₂/MoO₃ | | | | | | | | |
| CTE [×10⁻⁷/° C.] | 37.4 | 37.8 | 38.9 | 38.9 | 38.8 | 38.2 | 36.9 | 36.3 |
| ρ [g/cm³] | 2.547 | 2.556 | 2.583 | 2.577 | 2.576 | 2.565 | 2.546 | 2.551 |
| E [GPa] | 83 | 82 | 83 | 83 | 83 | 83 | 83 | 83 |
| E/ρ [GPa/g · cm⁻³] | 32.4 | 32.1 | 32.1 | 32.1 | 32.2 | 32.2 | 32.5 | 32.5 |
| Ps [° C.] | 722 | 721 | 720 | 721 | 722 | 723 | 724 | 725 |
| Ta [° C.] | 778 | 777 | 777 | 778 | 779 | 780 | 781 | 782 |
| Ts [° C.] | 1003 | 1003 | 1002 | 1006 | 1005 | 1009 | 1007 | 1007 |
| 10⁴ dPa · s [° C.] | 1307 | 1308 | 1311 | 1318 | 1315 | 1321 | 1313 | 1314 |
| 10³ dPa · s[° C.] | 1460 | 1462 | 1465 | 1474 | 1470 | 1476 | 1466 | 1469 |
| 10^{2.5} dPa · s [° C.] | 1558 | 1561 | 1564 | 1573 | 1570 | 1576 | 1563 | 1567 |
| TL [° C.] | 1182 | 1172 | 1170 | 1179 | 1178 | 1186 | 1192 | 1184 |
| Log₁₀ ηTL | 5.2 | 5.3 | 5.3 | 5.3 | 5.3 | 5.2 | 5.1 | 5.2 |
| T % (320 nm) | 80.1 | 80.1 | 80.9 | 80.9 | 80.1 | 80.1 | 80.1 | 80.1 |

| | | No. | No. | No. | No. | No. | No. | No. |
|---|---|---|---|---|---|---|---|---|
| | | 144 | 145 | 146 | 147 | 148 | 149 | 150 |
| Glass | SiO₂ | 65.9 | 65.8 | 66.0 | 65.7 | 66.0 | 65.8 | 66.0 |
| composition | Al₂O₃ | 14.9 | 14.9 | 14.9 | 15.0 | 14.8 | 15.0 | 14.9 |
| (mol %) | B₂O₃ | 2.0 | 2.2 | 2.0 | 2.1 | 2.0 | 2.1 | 2.0 |
| | Li₂O | 0.000 | 0.000 | 0.000 | 0.000 | 0.000 | 0.000 | 0.000 |
| | Na₂O | 0.030 | 0.024 | 0.027 | 0.016 | 0.030 | 0.024 | 0.023 |
| | K₂O | 0.002 | 0.004 | 0.004 | 0.002 | 0.005 | 0.004 | 0.005 |
| | MgO | 6.9 | 6.9 | 7.0 | 7.0 | 6.9 | 8.0 | 7.9 |
| | CaO | 6.1 | 6.1 | 4.1 | 4.1 | 4.1 | 6.0 | 6.0 |
| | SrO | 3.0 | 1.0 | 5.0 | 3.0 | 1.0 | 3.0 | 1.0 |
| | BaO | 1.0 | 3.0 | 1.0 | 3.0 | 5.0 | 0.0 | 2.0 |
| | SnO₂ | 0.1 | 0.1 | 0.1 | 0.1 | 0.1 | 0.1 | 0.1 |
| | Fe₂O₃ | 0.007 | 0.007 | 0.007 | 0.007 | 0.006 | 0.007 | 0.007 |
| | TiO₂ | 0.006 | 0.007 | 0.007 | 0.006 | 0.007 | 0.009 | 0.007 |
| | ZrO₂ | 0.001 | 0.001 | 0.001 | 0.001 | 0.001 | 0.002 | 0.001 |
| | MoO₃ | 0.00037 | 0.00043 | 0.00095 | 0.00144 | 0.00088 | 0.00069 | 0.00065 |
| Glass | MoO₃ | 8 | 9 | 20 | 30 | 18 | 15 | 14 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.032 | 0.028 | 0.031 | 0.018 | 0.035 | 0.029 | 0.028 |
| MgO + CaO + SrO + | 17.0 | 17.0 | 17.0 | 17.1 | 17.0 | 17.0 | 17.0 |
| BaO | | | | | | | |
| mol % ratio | 19.07 | 16.81 | 7.21 | 4.75 | 7.41 | 9.55 | 11.43 |
| Fe₂O₃/MoO₃ | | | | | | | |
| mol % ratio | 15.70 | 15.82 | 7.20 | 4.15 | 7.90 | 12.72 | 10.15 |
| TiO₂/MoO₃ | | | | | | | |
| CTE [×10⁻⁷/° C.] | 37.4 | 38.4 | 38.6 | 39.0 | 39.3 | 37.1 | 37.0 |
| ρ [g/cm³] | 2.586 | 2.614 | 2.616 | 2.644 | 2.669 | 2.558 | 2.583 |
| E [GPa] | 86 | 85 | 85 | 84 | 84 | 87 | 86 |
| E/ρ [GPa/g · cm⁻³] | 33.1 | 32.6 | 32.6 | 31.9 | 31.3 | 34.0 | 33.4 |
| Ps [° C.] | 741 | 740 | 741 | 740 | 740 | 741 | 741 |
| Ta [° C.] | 796 | 796 | 798 | 797 | 797 | 796 | 796 |
| Ts [° C.] | 1014 | 1016 | 1017 | 1018 | 1020 | 1011 | 1013 |
| 10⁴ dPa · s [° C.] | 1302 | 1306 | 1306 | 1311 | 1311 | 1296 | 1297 |
| 10³ dPa · s[° C.] | 1448 | 1454 | 1453 | 1460 | 1460 | 1442 | 1443 |
| 10^{2.5} dPa · s [° C.] | 1543 | 1549 | 1548 | 1556 | 1556 | 1536 | 1537 |
| TL [° C.] | 1265 | 1256 | 1269 | 1253 | 1227 | 1295 | 1282 |
| Log₁₀ ηTL | 4.3 | 4.5 | 4.3 | 4.5 | 4.8 | 4.0 | 4.1 |
| T % (320 nm) | 76.1 | 76.2 | 76.9 | 77.0 | 77.8 | 76.9 | 75.4 |

TABLE 11

| | | No. | No. | No. | No. | No. | No. | No. | No. |
|---|---|---|---|---|---|---|---|---|---|
| | | 151 | 152 | 153 | 154 | 155 | 156 | 157 | 158 |
| Glass | SiO₂ | 65.7 | 65.9 | 65.9 | 66.0 | 66.0 | 66.9 | 66.9 | 68.7 |
| composition | Al₂O₃ | 15.2 | 15.0 | 14.9 | 14.0 | 14.0 | 14.0 | 14.0 | 13.6 |
| (mol %) | B₂O₃ | 2.0 | 2.0 | 2.1 | 1.9 | 1.9 | 1.9 | 1.0 | 1.1 |
| | Li₂O | 0.000 | 0.000 | 0.000 | 0.000 | 0.000 | 0.000 | 0.000 | 0.000 |
| | Na₂O | 0.020 | 0.032 | 0.020 | 0.018 | 0.016 | 0.015 | 0.015 | 0.015 |
| | K₂O | 0.004 | 0.003 | 0.003 | 0.003 | 0.003 | 0.001 | 0.001 | 0.001 |
| | MgO | 7.9 | 8.0 | 8.0 | 7.0 | 7.9 | 7.0 | 6.9 | 7.0 |
| | CaO | 4.1 | 4.1 | 4.1 | 7.0 | 6.0 | 6.0 | 7.0 | 9.0 |
| | SrO | 5.0 | 3.0 | 1.0 | 3.0 | 3.0 | 3.0 | 3.0 | 0.5 |
| | BaO | 0.0 | 2.0 | 4.0 | 1.0 | 1.0 | 1.0 | 1.0 | 0.0 |
| | SnO₂ | 0.1 | 0.1 | 0.1 | 0.1 | 0.1 | 0.1 | 0.1 | 0.1 |
| | Fe₂O₃ | 0.007 | 0.007 | 0.007 | 0.007 | 0.007 | 0.007 | 0.007 | 0.007 |
| | TiO₂ | 0.007 | 0.006 | 0.007 | 0.007 | 0.006 | 0.006 | 0.006 | 0.006 |
| | ZrO₂ | 0.001 | 0.001 | 0.001 | 0.001 | 0.001 | 0.001 | 0.001 | 0.001 |
| | MoO₃ | 0.00089 | 0.00061 | 0.00038 | 0.00056 | 0.00046 | 0.00023 | 0.00023 | 0.00040 |
| Glass | MoO₃ | 19 | 13 | 8 | 12 | 10 | 5 | 5 | 9 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.024 | 0.035 | 0.023 | 0.021 | 0.019 | 0.017 | 0.017 | 0.017 |
| MgO + CaO + SrO + | 17.0 | 17.1 | 17.1 | 18.0 | 18.0 | 17.1 | 18.0 | 16.5 |
| BaO | | | | | | | | |
| mol % ratio | 8.05 | 11.64 | 18.91 | 12.40 | 15.38 | 30.57 | 30.72 | 17.64 |
| Fe₂O₃/MoO₃ | | | | | | | | |
| mol % ratio | 7.57 | 9.58 | 17.79 | 12.40 | 12.66 | 25.17 | 25.29 | 14.52 |
| TiO₂/MoO₃ | | | | | | | | |
| CTE [×10⁻⁷/° C.] | 37.7 | 37.5 | 38.0 | 39.6 | 38.9 | 38.1 | 39.6 | 36.0 |
| ρ [g/cm³] | 2.590 | 2.613 | 2.640 | 2.590 | 2.588 | 2.579 | 2.597 | 2.507 |
| E [GPa] | 87 | 86 | 85 | 86 | 86 | 85 | 86 | 87 |
| E/ρ [GPa/g · cm⁻³] | 33.4 | 32.8 | 32.2 | 33.0 | 33.2 | 33.1 | 33.3 | 34.7 |
| Ps [° C.] | 742 | 740 | 740 | 733 | 733 | 737 | 744 | 753 |
| Ta [° C.] | 798 | 796 | 796 | 788 | 788 | 793 | 800 | 808 |
| Ts [° C.] | 1014 | 1016 | 1017 | 1007 | 1006 | 1015 | 1019 | 1029 |
| 10⁴ dPa · s [° C.] | 1305 | 1304 | 1310 | 1294 | 1295 | 1306 | 1309 | 1325 |
| 10³ dPa · s[° C.] | 1452 | 1452 | 1458 | 1442 | 1444 | 1456 | 1458 | 1479 |
| 10^{2.5} dPa · s [° C.] | 1549 | 1547 | 1555 | 1538 | 1540 | 1554 | 1556 | 1577 |
| TL [° C.] | 1294 | 1285 | 1282 | 1243 | 1245 | 1222 | 1266 | 1282 |
| Log₁₀ ηTL | 4.1 | 4.2 | 4.2 | 4.5 | 4.5 | 4.8 | 4.4 | 4.4 |
| T % (320 nm) | 76.1 | 76.2 | 76.2 | 76.4 | 76.0 | 76.1 | 76.0 | 75.6 |

| | | No. | No. | No. | No. | No. | No. | No. |
|---|---|---|---|---|---|---|---|---|
| | | 159 | 160 | 161 | 162 | 163 | 164 | 165 |
| Glass | SiO₂ | 68.8 | 68.8 | 68.8 | 68.9 | 68.7 | 68.1 | 67.8 |
| composition | Al₂O₃ | 13.5 | 13.5 | 13.6 | 13.5 | 13.5 | 13.4 | 13.6 |
| (mol %) | B₂O₃ | 1.0 | 1.0 | 0.9 | 1.0 | 1.0 | 1.1 | 1.0 |
| | Li₂O | 0.000 | 0.000 | 0.000 | 0.000 | 0.000 | 0.000 | 0.000 |
| | Na₂O | 0.017 | 0.014 | 0.016 | 0.014 | 0.012 | 0.012 | 0.015 |
| | K₂O | 0.001 | 0.001 | 0.001 | 0.001 | 0.001 | 0.001 | 0.001 |
| | MgO | 7.0 | 7.0 | 7.0 | 7.0 | 7.0 | 7.8 | 8.0 |
| | CaO | 7.0 | 7.1 | 5.1 | 5.1 | 5.1 | 8.9 | 7.0 |
| | SrO | 2.5 | 0.5 | 4.5 | 2.5 | 0.5 | 0.5 | 2.5 |
| | BaO | 0.0 | 2.0 | 0.1 | 2.0 | 4.0 | 0.0 | 0.0 |
| | SnO₂ | 0.1 | 0.1 | 0.1 | 0.1 | 0.1 | 0.1 | 0.1 |
| | Fe₂O₃ | 0.008 | 0.008 | 0.007 | 0.007 | 0.007 | 0.007 | 0.008 |
| | TiO₂ | 0.010 | 0.009 | 0.007 | 0.007 | 0.008 | 0.009 | 0.007 |
| | ZrO₂ | 0.002 | 0.001 | 0.001 | 0.001 | 0.001 | 0.001 | 0.001 |
| | MoO₃ | 0.00032 | 0.00028 | 0.00069 | 0.00094 | 0.00076 | 0.00045 | 0.00091 |
| Glass | MoO₃ | 7 | 6 | 15 | 20 | 16 | 10 | 20 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.018 | 0.015 | 0.017 | 0.015 | 0.013 | 0.014 | 0.016 |
| MgO + CaO + SrO + | 16.5 | 16.5 | 16.6 | 16.5 | 16.6 | 17.3 | 17.5 |
| BaO | | | | | | | |
| mol % ratio | 24.12 | 28.13 | 10.81 | 8.01 | 9.43 | 16.32 | 8.87 |
| Fe₂O₃/MoO₃ | | | | | | | |
| mol % ratio | 32.99 | 32.56 | 10.80 | 7.12 | 9.98 | 19.19 | 7.98 |
| TiO₂/MoO₃ | | | | | | | |
| CTE [×10⁻⁷/° C.] | 36.6 | 37.1 | 37.3 | 37.5 | 37.7 | 37.2 | 37.6 |
| ρ [g/cm³] | 2.538 | 2.564 | 2.569 | 2.592 | 2.620 | 2.518 | 2.548 |
| E [GPa] | 86 | 86 | 86 | 85 | 84 | 88 | 87 |
| E/ρ [GPa/g · cm⁻³] | 34.0 | 33.4 | 33.3 | 32.8 | 32.2 | 34.8 | 34.2 |
| Ps [° C.] | 750 | 750 | 750 | 749 | 750 | 747 | 747 |
| Ta [° C.] | 806 | 806 | 807 | 806 | 807 | 801 | 802 |
| Ts [° C.] | 1030 | 1032 | 1032 | 1034 | 1036 | 1018 | 1021 |
| 10⁴ dPa · s [° C.] | 1331 | 1336 | 1338 | 1343 | 1348 | 1310 | 1313 |
| 10³ dPa · s[° C.] | 1488 | 1492 | 1495 | 1501 | 1510 | 1461 | 1464 |
| 10^{2.5} dPa · s [° C.] | 1586 | 1590 | 1597 | 1600 | 1610 | 1559 | 1562 |
| TL [° C.] | 1263 | 1273 | 1259 | 1262 | 1262 | 1255 | 1243 |
| Log₁₀ ηTL | 4.6 | 4.5 | 4.7 | 4.7 | 4.7 | 4.5 | 4.6 |
| T % (320 nm) | 74.7 | 74.7 | 75.2 | 75.4 | 76.3 | 75.2 | 73.9 |

TABLE 12

| | | No. | No. | No. | No. | No. | No. | No. | No. |
|---|---|---|---|---|---|---|---|---|---|
| | | 166 | 167 | 168 | 169 | 170 | 171 | 172 | 173 |
| Glass | SiO₂ | 67.8 | 68.1 | 67.9 | 67.8 | 66.8 | 67.4 | 67.0 | 67.2 |
| composition | Al₂O₃ | 13.6 | 13.5 | 13.5 | 13.5 | 13.4 | 13.4 | 13.4 | 13.4 |
| (mol %) | B₂O₃ | 1.0 | 0.9 | 1.0 | 1.0 | 3.3 | 2.8 | 3.6 | 3.3 |
| | Li₂O | 0.000 | 0.000 | 0.000 | 0.000 | 0.000 | 0.000 | 0.000 | 0.000 |
| | Na₂O | 0.015 | 0.013 | 0.015 | 0.013 | 0.012 | 0.020 | 0.017 | 0.030 |
| | K₂O | 0.001 | 0.001 | 0.001 | 0.001 | 0.001 | 0.002 | 0.002 | 0.002 |
| | MgO | 8.0 | 7.9 | 7.9 | 7.9 | 6.4 | 6.3 | 5.9 | 5.7 |
| | CaO | 7.0 | 5.0 | 5.1 | 5.1 | 6.5 | 6.5 | 6.5 | 6.6 |
| | SrO | 0.5 | 4.5 | 2.5 | 0.5 | 1.8 | 1.8 | 1.6 | 1.6 |
| | BaO | 2.0 | 0.1 | 2.0 | 4.0 | 1.7 | 1.7 | 1.9 | 1.9 |
| | SnO₂ | 0.1 | 0.1 | 0.1 | 0.1 | 0.1 | 0.1 | 0.1 | 0.1 |
| | Fe₂O₃ | 0.008 | 0.007 | 0.007 | 0.008 | 0.007 | 0.008 | 0.007 | 0.007 |
| | TiO₂ | 0.007 | 0.007 | 0.007 | 0.008 | 0.009 | 0.006 | 0.006 | 0.006 |
| | ZrO₂ | 0.001 | 0.001 | 0.001 | 0.001 | 0.001 | 0.001 | 0.001 | 0.001 |
| | MoO₃ | 0.00028 | 0.00037 | 0.00084 | 0.01088 | 0.00065 | 0.00088 | 0.00061 | 0.00037 |
| Glass | MoO₃ | 6 | 8 | 18 | 230 | 14 | 19 | 13 | 8 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.016 | 0.014 | 0.016 | 0.014 | 0.014 | 0.023 | 0.019 | 0.032 |
| MgO + CaO + SrO + | 17.5 | 17.5 | 17.5 | 17.6 | 16.4 | 16.4 | 15.9 | 15.9 |
| BaO | | | | | | | | |
| mol % ratio | 28.14 | 20.27 | 8.89 | 0.70 | 11.15 | 8.53 | 11.72 | 19.15 |
| Fe₂O₃/MoO₃ | | | | | | | | |
| mol % ratio | 26.65 | 20.26 | 7.90 | 0.77 | 13.11 | 6.63 | 9.65 | 15.77 |
| TiO₂/MoO₃ | | | | | | | | |
| CTE [×10⁻⁷/° C.] | 37.7 | 38.2 | 38.3 | 38.7 | 37.5 | 37.3 | 37.2 | 37.1 |
| ρ [g/cm³] | 2.574 | 2.580 | 2.604 | 2.631 | 2.562 | 2.565 | 2.559 | 2.560 |
| E [GPa] | 87 | 87 | 86 | 85 | 83 | 84 | 83 | 83 |
| E/ρ [GPa/g · cm⁻³] | 33.6 | 33.5 | 32.9 | 32.3 | 32.6 | 32.8 | 32.4 | 32.5 |
| Ps [° C.] | 745 | 747 | 745 | 746 | 724 | 730 | 723 | 726 |
| Ta [° C.] | 801 | 802 | 801 | 802 | 780 | 786 | 780 | 783 |
| Ts [° C.] | 1022 | 1023 | 1025 | 1027 | 1006 | 1011 | 1007 | 1010 |
| 10⁴ dPa · s [° C.] | 1318 | 1316 | 1324 | 1329 | 1305 | 1314 | 1310 | 1314 |
| 10³ dPa · s[° C.] | 1471 | 1469 | 1478 | 1484 | 1460 | 1468 | 1463 | 1468 |
| 10^{2.5} dPa · s [° C.] | 1570 | 1568 | 1577 | 1585 | 1558 | 1568 | 1560 | 1566 |
| TL [° C.] | 1280 | 1273 | 1267 | 1278 | 1202 | 1207 | 1190 | 1200 |
| Log₁₀ ηTL | 4.3 | 4.4 | 4.5 | 4.4 | 4.9 | 5.0 | 5.1 | 5.0 |
| T % (320 nm) | 74.7 | 75.2 | 75.4 | 75.3 | 75.8 | 75.2 | 76.1 | 76.0 |

| | | No. | No. | No. | No. | No. | No. | No. |
|---|---|---|---|---|---|---|---|---|
| | | 174 | 175 | 176 | 177 | 178 | 179 | 180 |
| Glass | SiO₂ | 67.6 | 67.6 | 67.3 | 67.6 | 67.6 | 67.6 | 67.5 |
| composition | Al₂O₃ | 12.6 | 12.8 | 13.8 | 13.7 | 13.5 | 13.7 | 13.5 |
| (mol %) | B₂O₃ | 3.2 | 3.1 | 1.5 | 1.5 | 1.5 | 1.5 | 1.5 |
| | Li₂O | 0.000 | 0.000 | 0.000 | 0.000 | 0.000 | 0.000 | 0.000 |
| | Na₂O | 0.024 | 0.027 | 0.016 | 0.030 | 0.024 | 0.023 | 0.020 |
| | K₂O | 0.004 | 0.004 | 0.002 | 0.005 | 0.004 | 0.005 | 0.004 |
| | MgO | 6.5 | 6.4 | 7.5 | 7.5 | 7.5 | 7.5 | 7.5 |
| | CaO | 6.5 | 6.6 | 6.5 | 6.5 | 6.5 | 6.5 | 7.0 |
| | SrO | 1.5 | 1.6 | 2.8 | 2.8 | 3.0 | 3.0 | 2.7 |
| | BaO | 2.0 | 1.7 | 0.5 | 0.3 | 0.2 | 0.0 | 0.0 |
| | SnO₂ | 0.1 | 0.1 | 0.1 | 0.1 | 0.1 | 0.1 | 0.1 |
| | Fe₂O₃ | 0.013 | 0.007 | 0.007 | 0.007 | 0.007 | 0.008 | 0.008 |
| | TiO₂ | 0.007 | 0.007 | 0.007 | 0.007 | 0.007 | 0.006 | 0.007 |
| | ZrO₂ | 0.001 | 0.001 | 0.001 | 0.001 | 0.001 | 0.001 | 0.001 |
| | MoO₃ | 0.00056 | 0.00083 | 0.00064 | 0.00087 | 0.00059 | 0.00036 | 0.00055 |
| Glass | MoO₃ | 12 | 18 | 14 | 19 | 13 | 8 | 12 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.028 | 0.031 | 0.018 | 0.035 | 0.029 | 0.028 | 0.024 |
| MgO + CaO + SrO + | 16.5 | 16.4 | 17.3 | 17.1 | 17.3 | 17.1 | 17.3 |
| BaO | | | | | | | |
| mol % ratio | 23.37 | 8.53 | 11.67 | 8.57 | 12.47 | 21.42 | 14.31 |
| Fe₂O₃/MoO₃ | | | | | | | |
| mol % ratio | 12.08 | 8.02 | 10.37 | 7.61 | 11.08 | 15.78 | 12.05 |
| TiO₂/MoO₃ | | | | | | | |
| CTE [×10⁻⁷/° C.] | 37.6 | 37.4 | 37.6 | 37.0 | 37.7 | 37.1 | 37.4 |
| ρ [g/cm³] | 2.559 | 2.555 | 2.563 | 2.554 | 2.558 | 2.551 | 2.548 |
| E [GPa] | 82 | 83 | 86 | 86 | 86 | 87 | 87 |
| E/ρ [GPa/g · cm⁻³] | 32.2 | 32.5 | 33.6 | 33.8 | 33.7 | 33.9 | 33.9 |
| Ps [° C.] | 719 | 724 | 739 | 741 | 738 | 741 | 738 |
| Ta [° C.] | 776 | 780 | 794 | 796 | 794 | 796 | 793 |
| Ts [° C.] | 1004 | 1007 | 1015 | 1017 | 1015 | 1017 | 1014 |
| 10⁴ dPa · s [° C.] | 1309 | 1311 | 1311 | 1314 | 1313 | 1312 | 1312 |
| 10³ dPa · s[° C.] | 1465 | 1466 | 1462 | 1465 | 1464 | 1462 | 1462 |
| 10^{2.5} dPa · s [° C.] | 1564 | 1565 | 1557 | 1561 | 1560 | 1558 | 1557 |
| TL [° C.] | 1184 | 1196 | 1240 | 1255 | 1240 | 1246 | 1239 |
| Log₁₀ ηTL | 5.2 | 5.1 | 4.6 | 4.5 | 4.7 | 4.6 | 4.7 |
| T % (320 nm) | 64.7 | 76.0 | 75.1 | 75.2 | 75.2 | 74.4 | 74.4 |

TABLE 13

| | | No. | No. | No. | No. | No. | No. | No. | No. |
|---|---|---|---|---|---|---|---|---|---|
| | | 181 | 182 | 183 | 184 | 185 | 186 | 187 | 188 |
| Glass | SiO₂ | 67.6 | 67.3 | 67.6 | 67.5 | 67.5 | 67.5 | 67.3 | 67.6 |
| composition | Al₂O₃ | 13.5 | 13.5 | 13.5 | 13.4 | 13.4 | 13.4 | 13.4 | 13.4 |
| (mol %) | B₂O₃ | 1.4 | 1.5 | 1.4 | 3.2 | 3.2 | 3.2 | 3.2 | 3.2 |
| | Li₂O | 0.000 | 0.000 | 0.000 | 0.000 | 0.000 | 0.000 | 0.000 | 0.000 |
| | Na₂O | 0.032 | 0.020 | 0.018 | 0.016 | 0.015 | 0.015 | 0.014 | 0.014 |
| | K₂O | 0.003 | 0.003 | 0.003 | 0.003 | 0.001 | 0.001 | 0.001 | 0.001 |
| | MgO | 7.8 | 7.8 | 7.5 | 5.7 | 5.8 | 5.9 | 5.9 | 5.6 |
| | CaO | 7.0 | 7.0 | 6.8 | 6.5 | 6.6 | 6.6 | 6.6 | 6.5 |
| | SrO | 2.5 | 2.5 | 2.8 | 1.6 | 1.5 | 1.6 | 1.6 | 1.6 |
| | BaO | 0.0 | 0.3 | 0.3 | 2.0 | 2.0 | 1.8 | 1.9 | 1.9 |
| | SnO₂ | 0.1 | 0.1 | 0.1 | 0.1 | 0.1 | 0.1 | 0.1 | 0.1 |
| | Fe₂O₃ | 0.008 | 0.008 | 0.008 | 0.008 | 0.007 | 0.007 | 0.008 | 0.008 |
| | TiO₂ | 0.007 | 0.017 | 0.007 | 0.007 | 0.006 | 0.006 | 0.007 | 0.007 |
| | ZrO₂ | 0.001 | 0.001 | 0.001 | 0.001 | 0.001 | 0.001 | 0.001 | 0.001 |
| | MoO₃ | 0.00045 | 0.00023 | 0.00023 | 0.00042 | 0.00033 | 0.00028 | 0.00070 | 0.00093 |
| Glass | MoO₃ | 10 | 5 | 5 | 9 | 7 | 6 | 15 | 20 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.035 | 0.023 | 0.021 | 0.019 | 0.017 | 0.017 | 0.015 | 0.016 |
| MgO + CaO + SrO + | 17.3 | 17.5 | 17.3 | 15.8 | 15.9 | 15.8 | 16.0 | 15.7 |
| BaO | | | | | | | | |
| mol % ratio | 17.15 | 34.12 | 34.14 | 18.57 | 21.91 | 25.60 | 10.80 | 8.11 |
| Fe₂O₃/MoO₃ | | | | | | | | |
| mol % ratio | 14.44 | 75.38 | 28.74 | 15.63 | 18.03 | 21.07 | 9.60 | 7.20 |
| TiO₂/MoO₃ | | | | | | | | |
| CTE [×10⁻⁷/° C.] | 37.2 | 37.6 | 37.5 | 37.3 | 37.2 | 36.9 | 37.2 | 37.0 |
| ρ [g/cm³] | 2.544 | 2.554 | 2.555 | 2.561 | 2.559 | 2.555 | 2.559 | 2.556 |
| E [GPa] | 87 | 87 | 86 | 83 | 83 | 83 | 83 | 83 |
| E/ρ [GPa/g · cm⁻³] | 34.0 | 33.9 | 33.8 | 32.2 | 32.3 | 32.4 | 32.3 | 32.3 |
| Ps [° C.] | 739 | 738 | 738 | 724 | 724 | 725 | 723 | 725 |
| Ta [° C.] | 794 | 793 | 794 | 781 | 781 | 782 | 779 | 782 |
| Ts [° C.] | 1015 | 1013 | 1016 | 1011 | 1010 | 1011 | 1008 | 1011 |
| 10⁴ dPa · s [° C.] | 1310 | 1308 | 1312 | 1318 | 1315 | 1314 | 1314 | 1316 |
| 10³ dPa · s[° C.] | 1458 | 1455 | 1460 | 1473 | 1467 | 1468 | 1468 | 1471 |
| 10^{2.5} dPa · s [° C.] | 1553 | 1549 | 1555 | 1570 | 1563 | 1564 | 1566 | 1569 |
| TL [° C.] | 1247 | 1246 | 1228 | 1199 | 1199 | 1198 | 1191 | 1201 |
| Log₁₀ ηTL | 4.6 | 4.6 | 4.8 | 5.1 | 5.1 | 5.1 | 5.1 | 5.1 |
| T % (320 nm) | 74.4 | 74.5 | 74.5 | 74.8 | 76.0 | 76.0 | 75.3 | 75.2 |

| | | No. | No. | No. | No. | No. | No. | No. |
|---|---|---|---|---|---|---|---|---|
| | | 189 | 190 | 191 | 192 | 193 | 194 | 195 |
| Glass | SiO₂ | 67.8 | 67.6 | 67.7 | 67.3 | 67.4 | 67.7 | 67.8 |
| composition | Al₂O₃ | 12.8 | 12.9 | 12.9 | 13.4 | 13.1 | 13.3 | 13.4 |
| (mol %) | B₂O₃ | 3.2 | 3.2 | 3.2 | 3.2 | 3.2 | 3.3 | 3.2 |
| | Li₂O | 0.000 | 0.000 | 0.000 | 0.000 | 0.000 | 0.000 | 0.000 |
| | Na₂O | 0.014 | 0.014 | 0.013 | 0.014 | 0.014 | 0.014 | 0.018 |
| | K₂O | 0.001 | 0.001 | 0.001 | 0.001 | 0.001 | 0.001 | 0.003 |
| | MgO | 6.3 | 6.3 | 6.3 | 6.1 | 6.4 | 5.7 | 5.4 |
| | CaO | 6.6 | 6.5 | 6.6 | 6.5 | 6.6 | 6.6 | 6.6 |
| | SrO | 1.4 | 1.5 | 1.4 | 1.6 | 1.6 | 1.6 | 1.6 |
| | BaO | 1.8 | 1.8 | 1.8 | 1.7 | 1.7 | 1.8 | 1.8 |
| | SnO₂ | 0.1 | 0.1 | 0.1 | 0.1 | 0.1 | 0.1 | 0.1 |
| | Fe₂O₃ | 0.007 | 0.007 | 0.007 | 0.008 | 0.007 | 0.007 | 0.007 |
| | TiO₂ | 0.006 | 0.007 | 0.006 | 0.007 | 0.006 | 0.007 | 0.007 |
| | ZrO₂ | 0.001 | 0.001 | 0.001 | 0.001 | 0.001 | 0.001 | 0.001 |
| | MoO₃ | 0.00074 | 0.00046 | 0.00083 | 0.00070 | 0.00065 | 0.00089 | 0.00093 |
| Glass | MoO₃ | 16 | 10 | 18 | 15 | 14 | 19 | 20 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.015 | 0.015 | 0.014 | 0.015 | 0.015 | 0.015 | 0.021 |
| MgO + CaO + SrO + | 16.1 | 16.2 | 16.1 | 16.0 | 16.2 | 15.6 | 15.4 |
| BaO | | | | | | | |
| mol % ratio | 9.66 | 15.29 | 8.52 | 10.76 | 10.97 | 8.02 | 7.65 |
| Fe₂O₃/MoO₃ | | | | | | | |
| mol % ratio | 7.95 | 14.38 | 7.01 | 9.56 | 9.03 | 7.54 | 7.20 |
| TiO₂/MoO₃ | | | | | | | |
| CTE [×10⁻⁷/° C.] | 37.2 | 37.3 | 37.1 | 37.0 | 37.3 | 36.8 | 36.7 |
| ρ [g/cm³] | 2.549 | 2.552 | 2.550 | 2.552 | 2.553 | 2.552 | 2.551 |
| E [GPa] | 83 | 83 | 83 | 83 | 83 | 83 | 83 |
| E/ρ [GPa/g · cm⁻³] | 32.4 | 32.4 | 32.5 | 32.6 | 32.5 | 32.4 | 32.4 |
| Ps [° C.] | 721 | 721 | 720 | 725 | 722 | 723 | 725 |
| Ta [° C.] | 777 | 778 | 777 | 782 | 778 | 780 | 783 |
| Ts [° C.] | 1007 | 1007 | 1007 | 1010 | 1006 | 1010 | 1013 |
| 10⁴ dPa · s [° C.] | 1314 | 1310 | 1312 | 1313 | 1307 | 1317 | 1322 |
| 10³ dPa · s[° C.] | 1469 | 1463 | 1467 | 1467 | 1461 | 1470 | 1477 |
| 10^{2.5} dPa · s [° C.] | 1566 | 1561 | 1565 | 1565 | 1558 | 1566 | 1574 |
| TL [° C.] | 1191 | 1196 | 1180 | 1212 | 1194 | 1198 | 1181 |
| Log₁₀ ηTL | 5.1 | 5.1 | 5.2 | 4.9 | 5.0 | 5.1 | 5.3 |
| T % (320 nm) | 75.9 | 76.1 | 76.0 | 75.3 | 76.0 | 76.1 | 76.1 |

TABLE 14

| | | No. | No. | No. | No. | No. | No. | No. | No. |
|---|---|---|---|---|---|---|---|---|---|
| | | 196 | 197 | 198 | 199 | 200 | 201 | 202 | 203 |
| Glass | SiO₂ | 68.0 | 67.9 | 68.5 | 68.4 | 67.9 | 67.9 | 68.0 | 68.1 |
| composition | Al₂O₃ | 13.5 | 13.5 | 13.5 | 13.5 | 13.5 | 13.4 | 13.5 | 13.3 |
| (mol %) | B₂O₃ | 1.1 | 1.1 | 1.1 | 1.6 | 1.1 | 1.2 | 1.6 | 1.6 |
| | Li₂O | 0.000 | 0.000 | 0.000 | 0.000 | 0.000 | 0.000 | 0.000 | 0.000 |
| | Na₂O | 0.015 | 0.017 | 0.012 | 0.017 | 0.013 | 0.031 | 0.018 | 0.017 |
| | K₂O | 0.004 | 0.007 | 0.001 | 0.007 | 0.001 | 0.007 | 0.003 | 0.003 |
| | MgO | 7.9 | 8.0 | 7.4 | 7.5 | 8.0 | 8.0 | 7.5 | 7.5 |
| | CaO | 8.9 | 9.0 | 8.9 | 8.5 | 9.0 | 9.1 | 8.9 | 9.0 |
| | SrO | 0.4 | 0.4 | 0.4 | 0.4 | 0.4 | 0.4 | 0.4 | 0.4 |
| | BaO | 0.0 | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 | 0.1 |
| | Fe₂O₃ | 0.007 | 0.009 | 0.009 | 0.009 | 0.008 | 0.009 | 0.009 | 0.009 |
| | TiO₂ | 0.006 | 0.008 | 0.007 | 0.008 | 0.008 | 0.007 | 0.007 | 0.007 |
| | ZrO₂ | 0.001 | 0.002 | 0.001 | 0.001 | 0.001 | 0.001 | 0.001 | 0.001 |
| | MoO₃ | 0.00036 | 0.00053 | 0.00045 | 0.00022 | 0.00031 | 0.00040 | 0.00031 | 0.00027 |
| Glass | MoO₃ | 8 | 12 | 10 | 5 | 7 | 9 | 7 | 6 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.019 | 0.023 | 0.014 | 0.023 | 0.015 | 0.039 | 0.021 | 0.019 |
| MgO + CaO + SrO + | 17.3 | 17.4 | 16.8 | 16.3 | 17.4 | 17.4 | 16.9 | 16.8 |
| BaO | | | | | | | | |
| mol % ratio | 20.03 | 17.27 | 19.78 | 41.38 | 27.09 | 22.03 | 28.23 | 33.08 |
| Fe₂O₃/MoO₃ | | | | | | | | |
| mol % ratio | 16.48 | 15.01 | 16.18 | 35.97 | 25.79 | 18.02 | 23.09 | 27.06 |
| TiO₂/MoO₃ | | | | | | | | |
| CTE [×10⁻⁷/° C.] | 36.5 | 36.6 | 36.0 | 34.6 | 36.8 | 36.8 | 36.4 | 36.3 |
| ρ [g/cm³] | 2.515 | 2.516 | 2.509 | 2.500 | 2.515 | 2.514 | 2.507 | 2.505 |
| E [GPa] | 88 | 88 | 87 | 87 | 88 | 88 | 87 | 87 |
| E/ρ [GPa/g · cm⁻³] | 34.9 | 34.9 | 34.9 | 34.8 | 34.8 | 34.9 | 34.7 | 34.7 |
| Ps [° C.] | 747 | 747 | 749 | 746 | 747 | 745 | 743 | 743 |
| Ta [° C.] | 802 | 802 | 805 | 801 | 802 | 800 | 798 | 798 |
| Ts [° C.] | 1019 | 1018 | 1024 | 1021 | 1018 | 1017 | 1017 | 1017 |
| 10⁴ dPa · s [° C.] | 1311 | 1311 | 1320 | 1320 | 1311 | 1310 | 1313 | 1316 |
| 10³ dPa · s[° C.] | 1463 | 1463 | 1472 | 1474 | 1463 | 1461 | 1465 | 1469 |
| 10^{2.5} dPa · s [° C.] | 1560 | 1560 | 1569 | 1571 | 1559 | 1557 | 1561 | 1566 |
| TL [° C.] | 1261 | 1265 | 1263 | 1257 | 1253 | 1255 | 1247 | 1241 |
| Log₁₀ ηTL | 4.4 | 4.4 | 4.5 | 4.6 | 4.5 | 4.5 | 4.6 | 4.7 |
| T % (320 nm) | 75.4 | 71.2 | 72.1 | 71.3 | 72.8 | 72.0 | 72.1 | 72.0 |

| | | No. | No. | No. | No. | No. | No. | No. |
|---|---|---|---|---|---|---|---|---|
| | | 204 | 205 | 206 | 207 | 208 | 209 | 210 |
| Glass | SiO₂ | 70.3 | 68.8 | 68.7 | 67.3 | 67.3 | 67.3 | 65.8 |
| composition | Al₂O₃ | 13.5 | 13.5 | 13.5 | 13.5 | 13.5 | 13.5 | 13.5 |
| (mol %) | B₂O₃ | 0.0 | 0.0 | 0.0 | 0.0 | 0.0 | 0.0 | 0.0 |
| | Li₂O | 0.000 | 0.000 | 0.000 | 0.000 | 0.000 | 0.000 | 0.000 |
| | Na₂O | 0.021 | 0.010 | 0.010 | 0.010 | 0.010 | 0.010 | 0.010 |
| | K₂O | 0.003 | 0.002 | 0.002 | 0.001 | 0.001 | 0.001 | 0.001 |
| | MgO | 7.5 | 9.1 | 7.6 | 10.6 | 9.1 | 7.5 | 10.6 |
| | CaO | 8.0 | 8.0 | 9.5 | 8.0 | 9.5 | 11.0 | 9.5 |
| | SrO | 0.5 | 0.5 | 0.5 | 0.5 | 0.5 | 0.5 | 0.5 |
| | BaO | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 |
| | Fe₂O₃ | 0.009 | 0.008 | 0.009 | 0.008 | 0.009 | 0.009 | 0.009 |
| | TiO₂ | 0.008 | 0.006 | 0.007 | 0.006 | 0.006 | 0.007 | 0.007 |
| | ZrO₂ | 0.001 | 0.001 | 0.001 | 0.001 | 0.001 | 0.001 | 0.001 |
| | MoO₃ | 0.00067 | 0.00089 | 0.00071 | 0.00053 | 0.00089 | 0.00116 | 0.00106 |
| Glass | MoO₃ | 15 | 20 | 16 | 12 | 20 | 26 | 24 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.023 | 0.012 | 0.012 | 0.012 | 0.012 | 0.012 | 0.012 |
| MgO + CaO + SrO + | 16.1 | 17.6 | 17.6 | 19.2 | 19.1 | 19.1 | 20.6 |
| BaO | | | | | | | |
| mol % ratio | 13.21 | 9.51 | 12.34 | 15.92 | 10.32 | 7.60 | 8.35 |
| Fe₂O₃/MoO₃ | | | | | | | |
| mol % ratio | 12.01 | 7.24 | 10.09 | 12.13 | 7.17 | 6.21 | 6.83 |
| TiO₂/MoO₃ | | | | | | | |
| CTE [×10⁻⁷/° C.] | 34.7 | 36.2 | 36.8 | 37.0 | 39.2 | 40.4 | 39.4 |
| ρ [g/cm³] | 2.505 | 2.521 | 2.525 | 2.537 | 2.541 | 2.544 | 2.557 |
| E [GPa] | 88 | 89 | 88 | 90 | 89 | 89 | 91 |
| E/ρ [GPa/g · cm⁻³] | 35.1 | 35.3 | 35.0 | 35.6 | 35.2 | 34.9 | 35.4 |
| Ps [° C.] | 767 | 761 | 762 | 754 | 756 | 757 | 750 |
| Ta [° C.] | 823 | 815 | 817 | 808 | 809 | 810 | 801 |
| Ts [° C.] | 1044 | 1030 | 1031 | 1016 | 1018 | 1018 | 1005 |
| 10⁴ dPa · s [° C.] | 1348 | 1325 | 1326 | 1302 | 1303 | 1305 | 1282 |
| 10³ dPa · s[° C.] | 1505 | 1478 | 1479 | 1450 | 1452 | 1454 | 1426 |
| 10^{2.5} dPa · s [° C.] | 1603 | 1575 | 1575 | 1545 | 1548 | 1551 | 1519 |
| TL [° C.] | 1283 | 1288 | 1270 | 1289 | 1265 | 1293 | 1260 |
| Log₁₀ ηTL | 4.6 | 4.3 | 4.5 | 4.1 | 4.3 | 4.1 | 4.2 |
| T % (320 nm) | 72.0 | 72.7 | 72.1 | 72.7 | 71.3 | 72.1 | 71.8 |

TABLE 15

| | | No. | No. | No. | No. | No. | No. | No. | No. |
|---|---|---|---|---|---|---|---|---|---|
| | | 226 | 227 | 228 | 229 | 230 | 231 | 232 | 233 |
| Glass | SiO₂ | 65.8 | 68.8 | 68.1 | 67.3 | 66.6 | 69.7 | 68.2 | 68.2 |
| composition | Al₂O₃ | 14.5 | 12.5 | 12.5 | 12.5 | 12.5 | 13.0 | 13.0 | 13.0 |
| (mol %) | B₂O₃ | 0.0 | 0.0 | 0.0 | 0.0 | 0.0 | 2.1 | 2.1 | 2.1 |
| | Li₂O | 0.000 | 0.000 | 0.000 | 0.000 | 0.000 | 0.000 | 0.000 | 0.000 |
| | Na₂O | 0.010 | 0.010 | 0.020 | 0.010 | 0.010 | 0.020 | 0.021 | 0.010 |
| | K₂O | 0.001 | 0.001 | 0.002 | 0.002 | 0.002 | 0.002 | 0.005 | 0.003 |
| | MgO | 10.0 | 8.9 | 9.5 | 10.4 | 11.0 | 7.0 | 8.5 | 7.0 |
| | CaO | 9.0 | 9.1 | 9.3 | 9.1 | 9.3 | 8.0 | 8.0 | 9.5 |
| | SrO | 0.5 | 0.5 | 0.5 | 0.5 | 0.5 | 0.0 | 0.0 | 0.0 |
| | BaO | 0.0 | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 | 0.1 |
| | Fe₂O₃ | 0.009 | 0.009 | 0.009 | 0.009 | 0.009 | 0.009 | 0.008 | 0.008 |
| | TiO₂ | 0.007 | 0.007 | 0.007 | 0.007 | 0.007 | 0.007 | 0.007 | 0.007 |
| | ZrO₂ | 0.001 | 0.001 | 0.001 | 0.001 | 0.001 | 0.001 | 0.001 | 0.001 |
| | MoO₃ | 0.00076 | 0.00066 | 0.00044 | 0.00035 | 0.00070 | 0.00036 | 0.00084 | 0.00129 |
| Glass | MoO₃ | 17 | 15 | 10 | 8 | 16 | 8 | 19 | 29 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.012 | 0.012 | 0.023 | 0.012 | 0.012 | 0.022 | 0.025 | 0.013 |
| MgO + CaO + SrO + | 19.6 | 18.6 | 19.3 | 20.1 | 20.8 | 15.0 | 16.5 | 16.5 |
| BaO | | | | | | | | |
| mol % ratio | 12.24 | 13.94 | 19.87 | 25.97 | 13.53 | 26.56 | 10.01 | 6.50 |
| Fe₂O₃/MoO₃ | | | | | | | | |
| mol % ratio | 9.58 | 10.91 | 16.25 | 20.31 | 10.14 | 19.91 | 8.58 | 5.57 |
| TiO₂/MoO₃ | | | | | | | | |
| CTE [×10⁻⁷/° C.] | 38.5 | 37.8 | 38.5 | 39.1 | 39.7 | 33.9 | 35.1 | 36.3 |
| ρ [g/cm³] | 2.555 | 2.524 | 2.533 | 2.541 | 2.550 | 2.469 | 2.485 | 2.489 |
| E [GPa] | 91 | 88 | 89 | 90 | 90 | 86 | 87 | 86 |
| E/ρ [GPa/g · cm⁻³] | 35.6 | 35.0 | 35.1 | 35.3 | 35.3 | 34.7 | 34.9 | 34.6 |
| Ps [° C.] | 754 | 752 | 748 | 746 | 744 | 744 | 739 | 739 |
| Ta [° C.] | 807 | 806 | 802 | 799 | 795 | 800 | 794 | 794 |
| Ts [° C.] | 1012 | 1022 | 1015 | 1008 | 1002 | 1027 | 1014 | 1015 |
| 10⁴ dPa · s [° C.] | 1290 | 1317 | 1308 | 1295 | 1285 | 1338 | 1316 | 1315 |
| 10³ dPa · s[° C.] | 1433 | 1469 | 1457 | 1443 | 1431 | 1494 | 1468 | 1468 |
| 10^{2.5} dPa · s [° C.] | 1524 | 1568 | 1554 | 1538 | 1524 | 1595 | 1566 | 1565 |
| TL [° C.] | 1289 | 1264 | 1250 | 1242 | 1244 | 1260 | 1260 | 1229 |
| Log₁₀ ηTL | 4.0 | 4.5 | 4.5 | 4.5 | 4.4 | 4.7 | 4.5 | 4.8 |
| T % (320 nm) | 71.1 | 71.0 | 72.0 | 71.2 | 70.4 | 70.7 | 72.7 | 72.9 |

| | | No. | No. | No. | No. | No. | No. | No. |
|---|---|---|---|---|---|---|---|---|
| | | 234 | 235 | 236 | 237 | 238 | 239 | 240 |
| Glass | SiO₂ | 66.8 | 66.7 | 66.8 | 68.7 | 67.4 | 66.8 | 66.4 |
| composition | Al₂O₃ | 13.0 | 13.0 | 13.0 | 13.0 | 13.0 | 13.0 | 13.0 |
| (mol %) | B₂O₃ | 2.1 | 2.1 | 2.0 | 3.0 | 2.9 | 3.0 | 2.9 |
| | Li₂O | 0.000 | 0.000 | 0.000 | 0.000 | 0.000 | 0.000 | 0.000 |
| | Na₂O | 0.010 | 0.010 | 0.010 | 0.010 | 0.010 | 0.010 | 0.021 |
| | K₂O | 0.002 | 0.003 | 0.007 | 0.005 | 0.003 | 0.003 | 0.005 |
| | MgO | 10.0 | 8.5 | 7.0 | 7.0 | 8.5 | 7.9 | 9.1 |
| | CaO | 8.0 | 9.5 | 11.0 | 8.0 | 8.0 | 9.1 | 8.5 |
| | SrO | 0.0 | 0.0 | 0.0 | 0.0 | 0.0 | 0.0 | 0.0 |
| | BaO | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 |
| | Fe₂O₃ | 0.008 | 0.009 | 0.009 | 0.008 | 0.008 | 0.008 | 0.008 |
| | TiO₂ | 0.007 | 0.007 | 0.006 | 0.007 | 0.007 | 0.007 | 0.007 |
| | ZrO₂ | 0.001 | 0.001 | 0.001 | 0.001 | 0.001 | 0.001 | 0.001 |
| | MoO₃ | 0.00053 | 0.00044 | 0.00022 | 0.00022 | 0.00040 | 0.00031 | 0.00027 |
| Glass | MoO₃ | 12 | 10 | 5 | 5 | 9 | 7 | 6 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.013 | 0.017 | 0.015 | 0.014 | 0.013 | 0.025 |
| MgO + CaO + SrO + | 18.1 | 18.0 | 18.1 | 15.1 | 16.6 | 17.0 | 17.6 |
| BaO | | | | | | | |
| mol % ratio | 15.15 | 20.60 | 39.52 | 37.79 | 20.14 | 26.98 | 31.69 |
| Fe₂O₃/MoO₃ | | | | | | | |
| mol % ratio | 13.63 | 16.12 | 28.73 | 32.38 | 18.12 | 23.12 | 27.16 |
| TiO₂/MoO₃ | | | | | | | |
| CTE [×10⁻⁷/° C.] | 36.5 | 37.4 | 38.2 | 33.5 | 35.2 | 36.5 | 36.4 |
| ρ [g/cm³] | 2.501 | 2.505 | 2.510 | 2.466 | 2.481 | 2.489 | 2.493 |
| E [GPa] | 88 | 87 | 87 | 85 | 86 | 86 | 86 |
| E/ρ [GPa/g · cm⁻³] | 35.2 | 34.8 | 34.6 | 34.4 | 34.7 | 34.5 | 34.7 |
| Ps [° C.] | 734 | 733 | 733 | 734 | 728 | 727 | 725 |
| Ta [° C.] | 787 | 787 | 787 | 790 | 783 | 782 | 779 |
| Ts [° C.] | 1002 | 1002 | 1001 | 1017 | 1002 | 1000 | 994 |
| 10⁴ dPa · s [° C.] | 1294 | 1292 | 1296 | 1322 | 1300 | 1295 | 1286 |
| 10³ dPa · s[° C.] | 1439 | 1441 | 1446 | 1476 | 1450 | 1443 | 1432 |
| 10^{2.5} dPa · s [° C.] | 1533 | 1536 | 1542 | 1574 | 1547 | 1539 | 1526 |
| TL [° C.] | 1259 | 1226 | 1246 | 1245 | 1247 | 1201 | 1232 |
| Log₁₀ ηTL | 4.3 | 4.6 | 4.4 | 4.7 | 4.5 | 4.9 | 4.5 |
| T % (320 nm) | 73.5 | 71.3 | 72.1 | 72.9 | 73.5 | 72.9 | 72.7 |

TABLE 16

| | | No. | No. | No. | No. | No. | No. | No. | No. |
|---|---|---|---|---|---|---|---|---|---|
| | | 241 | 242 | 243 | 244 | 245 | 246 | 247 | 248 |
| Glass | SiO₂ | 65.8 | 65.9 | 68.3 | 67.5 | 66.8 | 68.2 | 67.8 | 67.3 |
| composition | Al₂O₃ | 13.0 | 13.0 | 13.0 | 13.0 | 13.0 | 13.5 | 13.5 | 13.0 |
| (mol %) | B₂O₃ | 3.0 | 2.9 | 2.0 | 2.1 | 2.0 | 2.1 | 2.1 | 2.9 |
| | Li₂O | 0.000 | 0.000 | 0.000 | 0.000 | 0.000 | 0.000 | 0.000 | 0.000 |
| | Na₂O | 0.010 | 0.010 | 0.010 | 0.021 | 0.010 | 0.010 | 0.010 | 0.010 |
| | K₂O | 0.004 | 0.002 | 0.003 | 0.001 | 0.001 | 0.001 | 0.001 | 0.003 |
| | MgO | 8.5 | 7.0 | 6.3 | 7.0 | 7.8 | 6.6 | 7.0 | 7.1 |
| | CaO | 9.5 | 11.0 | 10.3 | 10.3 | 10.3 | 9.5 | 9.3 | 9.5 |
| | SrO | 0.0 | 0.0 | 0.0 | 0.0 | 0.0 | 0.0 | 0.1 | 0.0 |
| | BaO | 0.0 | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 | 0.1 |
| | Fe₂O₃ | 0.009 | 0.008 | 0.008 | 0.008 | 0.008 | 0.008 | 0.008 | 0.008 |
| | TiO₂ | 0.006 | 0.007 | 0.006 | 0.007 | 0.001 | 0.007 | 0.007 | 0.007 |
| | ZrO₂ | 0.001 | 0.001 | 0.001 | 0.001 | 0.001 | 0.001 | 0.001 | 0.001 |
| | MoO₃ | 0.00067 | 0.00089 | 0.00071 | 0.00044 | 0.00089 | 0.00027 | 0.00036 | 0.00071 |
| Glass | MoO₃ | 15 | 20 | 16 | 10 | 20 | 6 | 8 | 16 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.014 | 0.012 | 0.013 | 0.022 | 0.012 | 0.012 | 0.012 | 0.014 |
| MgO + CaO + SrO + | 18.1 | 18.1 | 16.6 | 17.3 | 18.1 | 16.1 | 16.5 | 16.6 |
| BaO | | | | | | | | |
| mol % ratio | 13.19 | 9.42 | 11.82 | 18.07 | 8.59 | 28.30 | 21.44 | 11.30 |
| Fe₂O₃/MoO₃ | | | | | | | | |
| mol % ratio | 9.59 | 8.07 | 9.00 | 16.26 | 0.81 | 26.80 | 20.30 | 10.17 |
| TiO₂/MoO₃ | | | | | | | | |
| CTE [×10⁻⁷/° C.] | 37.6 | 38.6 | 36.8 | 37.4 | 37.9 | 35.9 | 36.1 | 36.3 |
| ρ [g/cm³] | 2.501 | 2.505 | 2.491 | 2.499 | 2.508 | 2.489 | 2.494 | 2.485 |
| E [GPa] | 86 | 86 | 86 | 86 | 87 | 86 | 86 | 85 |
| E/ρ [GPa/g · cm⁻³] | 34.5 | 34.2 | 34.4 | 34.5 | 34.6 | 34.6 | 34.6 | 34.4 |
| Ps [° C.] | 722 | 722 | 738 | 735 | 732 | 742 | 740 | 728 |
| Ta [° C.] | 776 | 776 | 794 | 790 | 786 | 798 | 795 | 784 |
| Ts [° C.] | 990 | 991 | 1015 | 1007 | 1000 | 1018 | 1015 | 1003 |
| 10⁴ dPa · s [° C.] | 1280 | 1280 | 1316 | 1304 | 1293 | 1316 | 1313 | 1301 |
| 10³ dPa · s[° C.] | 1427 | 1427 | 1471 | 1456 | 1444 | 1470 | 1467 | 1455 |
| 10^{2.5} dPa · s [° C.] | 1522 | 1522 | 1570 | 1554 | 1542 | 1568 | 1565 | 1552 |
| TL [° C.] | 1195 | 1234 | 1247 | 1237 | 1235 | 1243 | 1237 | 1234 |
| Log₁₀ ηTL | 4.8 | 4.4 | 4.6 | 4.6 | 4.5 | 4.6 | 4.7 | 4.6 |
| T % (320 nm) | 72.1 | 72.9 | 72.8 | 73.6 | 74.4 | 74.6 | 74.4 | 73.6 |

| | | No. | No. | No. | No. | No. | No. | No. |
|---|---|---|---|---|---|---|---|---|
| | | 249 | 250 | 251 | 252 | 253 | 254 | 255 |
| Glass | SiO₂ | 65.8 | 67.0 | 67.1 | 66.9 | 67.3 | 67.1 | 70.7 |
| composition | Al₂O₃ | 13.0 | 12.5 | 12.5 | 12.5 | 12.5 | 12.5 | 13.0 |
| (mol %) | B₂O₃ | 2.9 | 0.0 | 0.0 | 0.0 | 0.0 | 0.0 | 0.0 |
| | Li₂O | 0.000 | 0.000 | 0.000 | 0.000 | 0.000 | 0.000 | 0.000 |
| | Na₂O | 0.010 | 0.010 | 0.010 | 0.020 | 0.010 | 0.010 | 0.010 |
| | K₂O | 0.002 | 0.001 | 0.001 | 0.003 | 0.001 | 0.001 | 0.001 |
| | MgO | 7.8 | 10.4 | 10.4 | 10.4 | 10.3 | 10.2 | 8.1 |
| | CaO | 10.3 | 9.1 | 9.1 | 9.1 | 9.1 | 9.2 | 8.0 |
| | SrO | 0.0 | 0.7 | 0.5 | 0.7 | 0.5 | 0.5 | 0.0 |
| | BaO | 0.0 | 0.0 | 0.2 | 0.2 | 0.2 | 0.4 | 0.0 |
| | SnO₂ | 0.1 | 0.1 | 0.1 | 0.1 | 0.1 | 0.1 | 0.1 |
| | Fe₂O₃ | 0.008 | 0.008 | 0.009 | 0.009 | 0.009 | 0.009 | 0.009 |
| | TiO₂ | 0.007 | 0.006 | 0.006 | 0.007 | 0.006 | 0.007 | 0.007 |
| | ZrO₂ | 0.001 | 0.001 | 0.001 | 0.002 | 0.001 | 0.001 | 0.001 |
| | MoO₃ | 0.00044 | 0.00088 | 0.00026 | 0.00035 | 0.00300 | 0.00035 | 0.00071 |
| Glass | MoO₃ | 10 | 20 | 6 | 8 | 68 | 8 | 16 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.012 | 0.012 | 0.023 | 0.012 | 0.012 | 0.012 |
| MgO + CaO + SrO + | 18.1 | 20.3 | 20.3 | 20.5 | 20.1 | 20.3 | 16.1 |
| BaO | | | | | | | |
| mol % ratio | 17.17 | 9.10 | 32.98 | 25.84 | 2.91 | 24.70 | 12.35 |
| Fe₂O₃/MoO₃ | | | | | | | |
| mol % ratio | 16.26 | 7.28 | 23.97 | 20.21 | 2.12 | 20.20 | 10.10 |
| TiO₂/MoO₃ | | | | | | | |
| CTE [×10⁻⁷/° C.] | 38.0 | 39.3 | 39.7 | 39.8 | 39.3 | 39.6 | 34.2 |
| ρ [g/cm³] | 2.503 | 2.547 | 2.550 | 2.555 | 2.548 | 2.556 | 2.491 |
| E [GPa] | 86 | 90 | 89 | 89 | 89 | 89 | 88 |
| E/ρ [GPa/g · cm⁻³] | 34.3 | 35.2 | 35.0 | 35.0 | 35.0 | 34.8 | 35.5 |
| Ps [° C.] | 722 | 744 | 742 | 742 | 743 | 743 | 761 |
| Ta [° C.] | 777 | 796 | 796 | 795 | 797 | 796 | 818 |
| Ts [° C.] | 991 | 1006 | 1005 | 1004 | 1007 | 1006 | 1045 |
| 10⁴ dPa · s [° C.] | 1280 | 1292 | 1294 | 1292 | 1297 | 1294 | 1348 |
| 10³ dPa · s[° C.] | 1428 | 1439 | 1443 | 1443 | 1447 | 1445 | 1508 |
| 10^{2.5} dPa · s [° C.] | 1524 | 1534 | 1539 | 1541 | 1544 | 1542 | 1607 |
| TL [° C.] | 1216 | 1253 | 1255 | 1250 | 1250 | 1247 | 1291 |
| Log₁₀ ηTL | 4.6 | 4.3 | 4.3 | 4.4 | 4.4 | 4.4 | 4.5 |
| T % (320 nm) | 74.4 | 73.5 | 72.1 | 71.3 | 72.0 | 72.1 | 72.1 |

TABLE 17

| | | No. | No. | No. | No. | No. | No. | No. | No. |
|---|---|---|---|---|---|---|---|---|---|
| | | 241 | 242 | 243 | 244 | 245 | 246 | 247 | 248 |
| Glass | SiO₂ | 65.8 | 65.9 | 68.3 | 67.5 | 66.8 | 68.2 | 67.8 | 67.3 |
| composition | Al₂O₃ | 13.0 | 13.0 | 13.0 | 13.0 | 13.0 | 13.5 | 13.5 | 13.0 |
| (mol %) | B₂O₃ | 3.0 | 2.9 | 2.0 | 2.1 | 2.0 | 2.1 | 2.1 | 2.9 |
| | Li₂O | 0.000 | 0.000 | 0.000 | 0.000 | 0.000 | 0.000 | 0.000 | 0.000 |
| | Na₂O | 0.010 | 0.010 | 0.010 | 0.021 | 0.010 | 0.010 | 0.010 | 0.010 |
| | K₂O | 0.004 | 0.002 | 0.003 | 0.001 | 0.001 | 0.001 | 0.001 | 0.003 |
| | MgO | 8.5 | 7.0 | 6.3 | 7.0 | 7.8 | 6.6 | 7.0 | 7.1 |
| | CaO | 9.5 | 11.0 | 10.3 | 10.3 | 10.3 | 9.5 | 9.3 | 9.5 |
| | SrO | 0.0 | 0.0 | 0.0 | 0.0 | 0.0 | 0.0 | 0.1 | 0.0 |
| | BaO | 0.0 | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 | 0.1 |
| | Fe₂O₃ | 0.009 | 0.008 | 0.008 | 0.008 | 0.008 | 0.008 | 0.008 | 0.008 |
| | TiO₂ | 0.006 | 0.007 | 0.006 | 0.007 | 0.001 | 0.007 | 0.007 | 0.007 |
| | ZrO₂ | 0.001 | 0.001 | 0.001 | 0.001 | 0.001 | 0.001 | 0.001 | 0.001 |
| | MoO₃ | 0.00067 | 0.00089 | 0.00071 | 0.00044 | 0.00089 | 0.00027 | 0.00036 | 0.00071 |
| Glass | MoO₃ | 15 | 20 | 16 | 10 | 20 | 6 | 8 | 16 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.014 | 0.012 | 0.013 | 0.022 | 0.012 | 0.012 | 0.012 | 0.014 |
| MgO + CaO + SrO + | 18.1 | 18.1 | 16.6 | 17.3 | 18.1 | 16.1 | 16.5 | 16.6 |
| BaO | | | | | | | | |
| mol % ratio | 13.19 | 9.42 | 11.82 | 18.07 | 8.59 | 28.30 | 21.44 | 11.30 |
| Fe₂O₃/MoO₃ | | | | | | | | |
| mol % ratio | 9.59 | 8.07 | 9.00 | 16.26 | 0.81 | 26.80 | 20.30 | 10.17 |
| TiO₂/MoO₃ | | | | | | | | |
| CTE [×10⁻⁷/° C.] | 37.6 | 38.6 | 36.8 | 37.4 | 37.9 | 35.9 | 36.1 | 36.3 |
| ρ [g/cm³] | 2.501 | 2.505 | 2.491 | 2.499 | 2.508 | 2.489 | 2.494 | 2.485 |
| E [GPa] | 86 | 86 | 86 | 86 | 87 | 86 | 86 | 85 |
| E/ρ [GPa/g · cm⁻³] | 34.5 | 34.2 | 34.4 | 34.5 | 34.6 | 34.6 | 34.6 | 34.4 |
| Ps [° C.] | 722 | 722 | 738 | 735 | 732 | 742 | 740 | 728 |
| Ta [° C.] | 776 | 776 | 794 | 790 | 786 | 798 | 795 | 784 |
| Ts [° C.] | 990 | 991 | 1015 | 1007 | 1000 | 1018 | 1015 | 1003 |
| 10⁴ dPa · s [° C.] | 1280 | 1280 | 1316 | 1304 | 1293 | 1316 | 1313 | 1301 |
| 10³ dPa · s[° C.] | 1427 | 1427 | 1471 | 1456 | 1444 | 1470 | 1467 | 1455 |
| 10^{2.5} dPa · s [° C.] | 1522 | 1522 | 1570 | 1554 | 1542 | 1568 | 1565 | 1552 |
| TL [° C.] | 1195 | 1234 | 1247 | 1237 | 1235 | 1243 | 1237 | 1234 |
| Log₁₀ ηTL | 4.8 | 4.4 | 4.6 | 4.6 | 4.5 | 4.6 | 4.7 | 4.6 |
| T % (320 nm) | 72.1 | 72.9 | 72.8 | 73.6 | 74.4 | 74.6 | 74.4 | 73.6 |

| | | No. | No. | No. | No. | No. | No. | No. |
|---|---|---|---|---|---|---|---|---|
| | | 249 | 250 | 251 | 252 | 253 | 254 | 255 |
| Glass | SiO₂ | 65.8 | 67.0 | 67.1 | 66.9 | 67.3 | 67.1 | 70.7 |
| composition | Al₂O₃ | 13.0 | 12.5 | 12.5 | 12.5 | 12.5 | 12.5 | 13.0 |
| (mol %) | B₂O₃ | 2.9 | 0.0 | 0.0 | 0.0 | 0.0 | 0.0 | 0.0 |
| | Li₂O | 0.000 | 0.000 | 0.000 | 0.000 | 0.000 | 0.000 | 0.000 |
| | Na₂O | 0.010 | 0.010 | 0.010 | 0.020 | 0.010 | 0.010 | 0.010 |
| | K₂O | 0.002 | 0.001 | 0.001 | 0.003 | 0.001 | 0.001 | 0.001 |
| | MgO | 7.8 | 10.4 | 10.4 | 10.4 | 10.3 | 10.2 | 8.1 |
| | CaO | 10.3 | 9.1 | 9.1 | 9.1 | 9.1 | 9.2 | 8.0 |
| | SrO | 0.0 | 0.7 | 0.5 | 0.7 | 0.5 | 0.5 | 0.0 |
| | BaO | 0.0 | 0.0 | 0.2 | 0.2 | 0.2 | 0.4 | 0.0 |
| | SnO₂ | 0.1 | 0.1 | 0.1 | 0.1 | 0.1 | 0.1 | 0.1 |
| | Fe₂O₃ | 0.008 | 0.008 | 0.009 | 0.009 | 0.009 | 0.009 | 0.009 |
| | TiO₂ | 0.007 | 0.006 | 0.006 | 0.007 | 0.006 | 0.007 | 0.007 |
| | ZrO₂ | 0.001 | 0.001 | 0.001 | 0.002 | 0.001 | 0.001 | 0.001 |
| | MoO₃ | 0.00044 | 0.00088 | 0.00026 | 0.00035 | 0.00300 | 0.00035 | 0.00071 |
| Glass | MoO₃ | 10 | 20 | 6 | 8 | 68 | 8 | 16 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.012 | 0.012 | 0.023 | 0.012 | 0.012 | 0.012 |
| MgO + CaO + SrO + | 18.1 | 20.3 | 20.3 | 20.5 | 20.1 | 20.3 | 16.1 |
| BaO | | | | | | | |
| mol % ratio | 17.17 | 9.10 | 32.98 | 25.84 | 2.91 | 24.70 | 12.35 |
| Fe₂O₃/MoO₃ | | | | | | | |
| mol % ratio | 16.26 | 7.28 | 23.97 | 20.21 | 2.12 | 20.20 | 10.10 |
| TiO₂/MoO₃ | | | | | | | |
| CTE [×10⁻⁷/° C.] | 38.0 | 39.3 | 39.7 | 39.8 | 39.3 | 39.6 | 34.2 |
| ρ [g/cm³] | 2.503 | 2.547 | 2.550 | 2.555 | 2.548 | 2.556 | 2.491 |
| E [GPa] | 86 | 90 | 89 | 89 | 89 | 89 | 88 |
| E/ρ [GPa/g · cm⁻³] | 34.3 | 35.2 | 35.0 | 35.0 | 35.0 | 34.8 | 35.5 |
| Ps [° C.] | 722 | 744 | 742 | 742 | 743 | 743 | 761 |
| Ta [° C.] | 777 | 796 | 796 | 795 | 797 | 796 | 818 |
| Ts [° C.] | 991 | 1006 | 1005 | 1004 | 1007 | 1006 | 1045 |
| 10⁴ dPa · s [° C.] | 1280 | 1292 | 1294 | 1292 | 1297 | 1294 | 1348 |
| 10³ dPa · s[° C.] | 1428 | 1439 | 1443 | 1443 | 1447 | 1445 | 1508 |
| 10^{2.5} dPa · s [° C.] | 1524 | 1534 | 1539 | 1541 | 1544 | 1542 | 1607 |
| TL [° C.] | 1216 | 1253 | 1255 | 1250 | 1250 | 1247 | 1291 |
| Log₁₀ ηTL | 4.6 | 4.3 | 4.3 | 4.4 | 4.4 | 4.4 | 4.5 |
| T % (320 nm) | 74.4 | 73.5 | 72.1 | 71.3 | 72.0 | 72.1 | 72.1 |

TABLE 18

| | | No. | No. | No. | No. | No. | No. | No. | No. |
|---|---|---|---|---|---|---|---|---|---|
| | | 256 | 257 | 258 | 259 | 260 | 261 | 262 | 263 |
| Glass | SiO₂ | 70.8 | 71.0 | 70.8 | 70.9 | 71.0 | 71.2 | 70.9 | 71.8 |
| composition | Al₂O₃ | 13.0 | 12.9 | 13.0 | 13.0 | 12.9 | 12.8 | 12.9 | 13.0 |
| (mol %) | B₂O₃ | 0.0 | 0.0 | 0.0 | 0.0 | 0.0 | 0.0 | 0.0 | 0.0 |
| | Li₂O | 0.000 | 0.000 | 0.000 | 0.000 | 0.000 | 0.000 | 0.000 | 0.000 |
| | Na₂O | 0.010 | 0.011 | 0.011 | 0.010 | 0.021 | 0.011 | 0.011 | 0.011 |
| | K₂O | 0.002 | 0.001 | 0.001 | 0.002 | 0.001 | 0.001 | 0.001 | 0.002 |
| | MgO | 8.0 | 8.0 | 6.0 | 6.0 | 6.0 | 6.0 | 4.0 | 7.5 |
| | CaO | 6.1 | 4.0 | 10.0 | 8.0 | 6.0 | 4.0 | 8.0 | 7.5 |
| | SrO | 1.0 | 2.0 | 0.0 | 1.0 | 2.0 | 2.9 | 2.0 | 0.0 |
| | BaO | 1.0 | 2.0 | 0.0 | 1.0 | 2.0 | 3.0 | 2.0 | 0.0 |
| | SnO₂ | 0.1 | 0.1 | 0.1 | 0.1 | 0.1 | 0.1 | 0.1 | 0.1 |
| | Fe₂O₃ | 0.008 | 0.008 | 0.008 | 0.008 | 0.007 | 0.007 | 0.006 | 0.006 |
| | TiO₂ | 0.010 | 0.008 | 0.008 | 0.008 | 0.007 | 0.008 | 0.007 | 0.001 |
| | ZrO₂ | 0.001 | 0.001 | 0.001 | 0.001 | 0.001 | 0.001 | 0.001 | 0.001 |
| | MoO₃ | 0.00045 | 0.00037 | 0.00067 | 0.00091 | 0.00074 | 0.00028 | 0.00037 | 0.00071 |
| Glass | MoO₃ | 10 | 8 | 15 | 20 | 16 | 6 | 8 | 16 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.012 | 0.012 | 0.012 | 0.012 | 0.023 | 0.012 | 0.012 | 0.013 |
| MgO + CaO + SrO + | 16.1 | 16.0 | 16.1 | 16.0 | 16.0 | 15.9 | 16.0 | 15.1 |
| BaO | | | | | | | | |
| mol % ratio | 18.54 | 22.06 | 11.86 | 8.84 | 9.93 | 23.53 | 17.15 | 8.90 |
| Fe₂O₃/MoO₃ | | | | | | | | |
| mol % ratio | 22.95 | 22.05 | 12.47 | 8.84 | 9.93 | 26.46 | 18.28 | 1.19 |
| TiO₂/MoO₃ | | | | | | | | |
| CTE [×10⁻⁷/° C.] | 34.6 | 36.0 | 36.0 | 36.6 | 37.4 | 38.0 | 38.7 | 33.2 |
| ρ [g/cm³] | 2.535 | 2.578 | 2.497 | 2.540 | 2.583 | 2.628 | 2.588 | 2.480 |
| E [GPa] | 87 | 86 | 87 | 86 | 85 | 84 | 84 | 88 |
| E/ρ [GPa/g · cm⁻³] | 34.4 | 33.5 | 34.9 | 34.0 | 33.0 | 32.1 | 32.6 | 35.4 |
| Ps [° C.] | 763 | 761 | 766 | 763 | 760 | 762 | 764 | 768 |
| Ta [° C.] | 820 | 820 | 822 | 820 | 820 | 822 | 823 | 825 |
| Ts [° C.] | 1043 | 1050 | 1050 | 1048 | 1051 | 1057 | 1055 | 1053 |
| 10⁴ dPa · s [° C.] | 1362 | 1364 | 1355 | 1363 | 1371 | 1381 | 1374 | 1369 |
| 10³ dPa · s[° C.] | 1521 | 1524 | 1514 | 1523 | 1533 | 1544 | 1537 | 1531 |
| 10^{2.5} dPa · s [° C.] | 1622 | 1625 | 1615 | 1626 | 1636 | 1649 | 1643 | 1633 |
| TL [° C.] | 1289 | 1298 | 1292 | 1259 | 1250 | 1251 | 1298 | 1329 |
| Log₁₀ ηTL | 4.6 | 4.6 | 4.5 | 4.9 | 5.1 | 5.1 | 4.6 | 4.3 |
| T % (320 nm) | 73.2 | 74.0 | 73.8 | 73.9 | 75.5 | 77.1 | 77.5 | 77.0 |

| | | No. | No. | No. | No. | No. | No. | No. |
|---|---|---|---|---|---|---|---|---|
| | | 264 | 265 | 266 | 267 | 268 | 269 | 270 |
| Glass | SiO₂ | 71.8 | 71.7 | 71.8 | 71.8 | 71.9 | 71.7 | 71.9 |
| composition | Al₂O₃ | 13.0 | 13.0 | 13.0 | 13.0 | 12.9 | 12.9 | 13.0 |
| (mol %) | B₂O₃ | 0.0 | 0.0 | 0.0 | 0.0 | 0.0 | 0.0 | 0.0 |
| | Li₂O | 0.000 | 0.000 | 0.000 | 0.000 | 0.000 | 0.000 | 0.000 |
| | Na₂O | 0.010 | 0.011 | 0.011 | 0.010 | 0.011 | 0.011 | 0.011 |
| | K₂O | 0.001 | 0.002 | 0.001 | 0.001 | 0.001 | 0.002 | 0.001 |
| | MgO | 7.5 | 7.6 | 5.5 | 5.5 | 5.5 | 5.6 | 3.5 |
| | CaO | 5.5 | 3.5 | 9.5 | 7.5 | 5.5 | 3.5 | 7.5 |
| | SrO | 1.0 | 2.0 | 0.0 | 1.0 | 2.0 | 3.1 | 2.0 |
| | BaO | 1.0 | 2.0 | 0.0 | 1.0 | 2.0 | 3.1 | 2.0 |
| | SnO₂ | 0.1 | 0.1 | 0.1 | 0.1 | 0.1 | 0.1 | 0.1 |
| | Fe₂O₃ | 0.008 | 0.007 | 0.007 | 0.007 | 0.007 | 0.007 | 0.006 |
| | TiO₂ | 0.006 | 0.007 | 0.007 | 0.006 | 0.007 | 0.008 | 0.008 |
| | ZrO₂ | 0.001 | 0.001 | 0.001 | 0.001 | 0.001 | 0.001 | 0.001 |
| | MoO₃ | 0.00045 | 0.00037 | 0.00040 | 0.00091 | 0.00265 | 0.00086 | 0.00070 |
| Glass | MoO₃ | 10 | 8 | 9 | 20 | 57 | 18 | 15 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.013 | 0.012 | 0.012 | 0.012 | 0.013 | 0.012 |
| MgO + CaO + SrO + | 15.1 | 15.2 | 15.1 | 15.1 | 15.0 | 15.3 | 15.0 |
| BaO | | | | | | | |
| mol % ratio | 16.75 | 19.80 | 17.73 | 7.95 | 2.63 | 7.83 | 9.16 |
| Fe₂O₃/MoO₃ | | | | | | | |
| mol % ratio | 14.10 | 17.59 | 16.68 | 7.07 | 2.78 | 8.80 | 10.99 |
| TiO₂/MoO₃ | | | | | | | |
| CTE [×10⁻⁷/° C.] | 34.0 | 34.6 | 34.7 | 35.0 | 35.7 | 37.5 | 37.8 |
| ρ [g/cm³] | 2.523 | 2.567 | 2.485 | 2.528 | 2.571 | 2.621 | 2.576 |
| E [GPa] | 87 | 86 | 87 | 86 | 85 | 84 | 84 |
| E/ρ [GPa/g · cm⁻³] | 34.4 | 33.4 | 34.8 | 33.9 | 33.0 | 32.0 | 32.6 |
| Ps [° C.] | 766 | 765 | 771 | 768 | 767 | 765 | 770 |
| Ta [° C.] | 824 | 825 | 828 | 827 | 826 | 826 | 830 |
| Ts [° C.] | 1056 | 1060 | 1055 | 1058 | 1063 | 1065 | 1067 |
| 10⁴ dPa · s [° C.] | 1379 | 1386 | 1374 | 1381 | 1392 | 1398 | 1394 |
| 10³ dPa · s[° C.] | 1540 | 1549 | 1534 | 1545 | 1556 | 1564 | 1557 |
| 10^{2.5} dPa · s [° C.] | 1644 | 1652 | 1637 | 1646 | 1663 | 1670 | 1659 |
| TL [° C.] | 1307 | 1315 | 1318 | 1276 | 1251 | 1254 | 1290 |
| Log₁₀ ηTL | 4.6 | 4.6 | 4.5 | 4.9 | 5.2 | 5.2 | 4.9 |
| T % (320 nm) | 74.8 | 75.6 | 75.5 | 75.5 | 76.3 | 77.1 | 77.5 |

TABLE 19

| | | No. | No. | No. | No. | No. | No. | No. | No. |
|---|---|---|---|---|---|---|---|---|---|
| | | 271 | 272 | 273 | 274 | 275 | 276 | 277 | 278 |
| Glass | SiO₂ | 72.8 | 72.9 | 72.8 | 72.8 | 73.0 | 73.9 | 74.0 | 73.9 |
| composition | Al₂O₃ | 13.0 | 13.0 | 13.0 | 13.0 | 13.0 | 13.0 | 13.0 | 12.9 |
| (mol %) | B₂O₃ | 0.0 | 0.0 | 0.0 | 0.0 | 0.0 | 0.0 | 0.0 | 0.0 |
| | Li₂O | 0.000 | 0.000 | 0.000 | 0.000 | 0.000 | 0.000 | 0.000 | 0.000 |
| | Na₂O | 0.011 | 0.011 | 0.011 | 0.011 | 0.011 | 0.022 | 0.021 | 0.011 |
| | K₂O | 0.002 | 0.006 | 0.004 | 0.003 | 0.003 | 0.001 | 0.002 | 0.002 |
| | MgO | 7.1 | 7.0 | 5.0 | 5.0 | 5.0 | 6.5 | 6.5 | 4.5 |
| | CaO | 5.0 | 3.0 | 7.0 | 5.0 | 3.0 | 4.5 | 2.5 | 6.5 |
| | SrO | 1.0 | 2.0 | 1.0 | 2.0 | 3.0 | 1.0 | 2.0 | 1.0 |
| | BaO | 1.0 | 2.0 | 1.0 | 2.0 | 3.0 | 1.0 | 2.0 | 1.0 |
| | SnO₂ | 0.1 | 0.1 | 0.1 | 0.1 | 0.1 | 0.1 | 0.1 | 0.1 |
| | Fe₂O₃ | 0.006 | 0.007 | 0.007 | 0.007 | 0.007 | 0.006 | 0.007 | 0.007 |
| | TiO₂ | 0.007 | 0.012 | 0.013 | 0.007 | 0.008 | 0.008 | 0.007 | 0.008 |
| | ZrO₂ | 0.001 | 0.002 | 0.001 | 0.001 | 0.001 | 0.001 | 0.001 | 0.001 |
| | MoO₃ | 0.00064 | 0.00088 | 0.00059 | 0.00037 | 0.00057 | 0.00046 | 0.00023 | 0.00823 |
| Glass | MoO₃ | 14 | 19 | 13 | 8 | 12 | 10 | 5 | 180 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.013 | 0.016 | 0.014 | 0.013 | 0.014 | 0.024 | 0.023 | 0.013 |
| MgO + CaO + SrO + | 14.1 | 14.1 | 14.1 | 14.0 | 13.9 | 13.0 | 13.0 | 13.1 |
| BaO | | | | | | | | |
| mol % ratio | 9.94 | 7.90 | 11.97 | 17.67 | 11.76 | 13.19 | 29.98 | 0.81 |
| Fe₂O₃/MoO₃ | | | | | | | | |
| mol % ratio | 10.60 | 13.94 | 22.51 | 19.87 | 13.23 | 16.95 | 31.73 | 1.02 |
| TiO₂/MoO₃ | | | | | | | | |
| CTE [×10⁻⁷/° C.] | 32.4 | 33.1 | 33.9 | 34.6 | 35.6 | 31.0 | 31.8 | 32.7 |
| ρ [g/cm³] | 2.511 | 2.554 | 2.517 | 2.559 | 2.602 | 2.500 | 2.542 | 2.505 |
| E [GPa] | 86 | 85 | 86 | 85 | 84 | 86 | 85 | 85 |
| E/ρ [GPa/g · cm⁻³] | 34.4 | 33.4 | 34.0 | 33.1 | 32.1 | 34.5 | 33.4 | 34.0 |
| Ps [° C.] | 768 | 770 | 773 | 771 | 773 | 775 | 775 | 777 |
| Ta [° C.] | 829 | 830 | 833 | 832 | 835 | 835 | 837 | 839 |
| Ts [° C.] | 1066 | 1071 | 1070 | 1074 | 1081 | 1076 | 1082 | 1081 |
| 10⁴ dPa · s [° C.] | 1391 | 1399 | 1396 | 1405 | 1416 | 1403 | 1411 | 1412 |
| 10³ dPa · s[° C.] | 1555 | 1564 | 1560 | 1570 | 1584 | 1568 | 1578 | 1578 |
| 10^{2.5} dPa · s [° C.] | 1661 | 1671 | 1668 | 1676 | 1695 | 1675 | 1688 | 1686 |
| TL [° C.] | 1322 | 1312 | 1296 | 1257 | 1274 | 1365 | 1359 | 1323 |
| Log₁₀ ηTL | 4.6 | 4.7 | 4.8 | 5.3 | 5.2 | 4.3 | 4.4 | 4.7 |
| T % (320 nm) | 77.3 | 76.3 | 75.8 | 77.1 | 77.1 | 78.0 | 76.3 | 76.5 |

| | | No. | No. | No. | No. | No. | No. | No. |
|---|---|---|---|---|---|---|---|---|
| | | 279 | 280 | 281 | 282 | 283 | 284 | 285 |
| Glass | SiO₂ | 73.9 | 74.0 | 71.0 | 70.9 | 70.8 | 72.0 | 71.9 |
| composition | Al₂O₃ | 13.0 | 13.0 | 13.4 | 13.4 | 13.5 | 13.4 | 13.5 |
| (mol %) | B₂O₃ | 0.0 | 0.0 | 0.0 | 0.0 | 0.0 | 0.0 | 0.0 |
| | Li₂O | 0.000 | 0.000 | 0.000 | 0.000 | 0.000 | 0.000 | 0.000 |
| | Na₂O | 0.011 | 0.011 | 0.011 | 0.011 | 0.011 | 0.011 | 0.011 |
| | K₂O | 0.002 | 0.001 | 0.002 | 0.001 | 0.002 | 0.002 | 0.003 |
| | MgO | 4.5 | 4.5 | 5.5 | 6.0 | 6.0 | 5.0 | 5.5 |
| | CaO | 4.5 | 2.5 | 6.0 | 6.0 | 6.0 | 5.5 | 5.5 |
| | SrO | 2.0 | 3.0 | 2.0 | 1.5 | 2.0 | 2.0 | 1.5 |
| | BaO | 2.0 | 3.0 | 2.0 | 2.0 | 1.5 | 2.0 | 2.0 |
| | SnO₂ | 0.1 | 0.1 | 0.1 | 0.1 | 0.1 | 0.1 | 0.1 |
| | Fe₂O₃ | 0.007 | 0.006 | 0.006 | 0.007 | 0.007 | 0.014 | 0.007 |
| | TiO₂ | 0.007 | 0.008 | 0.008 | 0.007 | 0.008 | 0.008 | 0.008 |
| | ZrO₂ | 0.001 | 0.001 | 0.001 | 0.001 | 0.001 | 0.001 | 0.001 |
| | MoO₃ | 0.00042 | 0.00186 | 0.00028 | 0.00070 | 0.00079 | 0.00075 | 0.00047 |
| Glass | MoO₃ | 9 | 39 | 6 | 15 | 17 | 16 | 10 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.013 | 0.012 | 0.013 | 0.012 | 0.013 | 0.013 | 0.014 |
| MgO + CaO + SrO + | 13.0 | 13.0 | 15.5 | 15.5 | 15.5 | 14.5 | 14.5 |
| BaO | | | | | | | |
| mol % ratio | 15.71 | 3.39 | 21.46 | 9.64 | 9.03 | 18.72 | 14.47 |
| Fe₂O₃/MoO₃ | | | | | | | |
| mol % ratio | 17.67 | 4.07 | 27.58 | 9.64 | 9.56 | 10.03 | 16.28 |
| TiO₂/MoO₃ | | | | | | | |
| CTE [×10⁻⁷/° C.] | 33.4 | 34.3 | 36.6 | 36.0 | 36.0 | 35.4 | 34.7 |
| ρ [g/cm³] | 2.547 | 2.589 | 2.583 | 2.574 | 2.567 | 2.570 | 2.562 |
| E [GPa] | 84 | 83 | 86 | 86 | 86 | 85 | 86 |
| E/ρ [GPa/g · cm⁻³] | 33.0 | 32.1 | 33.2 | 33.4 | 33.5 | 33.1 | 33.4 |
| Ps [° C.] | 777 | 779 | 766 | 766 | 766 | 771 | 771 |
| Ta [° C.] | 840 | 842 | 826 | 824 | 824 | 831 | 831 |
| Ts [° C.] | 1085 | 1092 | 1057 | 1055 | 1056 | 1068 | 1066 |
| 10⁴ dPa · s [° C.] | 1426 | 1435 | 1377 | 1372 | 1372 | 1392 | 1389 |
| 10³ dPa · s[° C.] | 1594 | 1604 | 1538 | 1532 | 1533 | 1556 | 1552 |
| 10^{2.5} dPa · s [° C.] | 1702 | 1711 | 1640 | 1634 | 1636 | 1661 | 1657 |
| TL [° C.] | 1311 | 1300 | 1245 | 1270 | 1266 | 1275 | 1270 |
| Log₁₀ ηTL | 4.9 | 5.1 | 5.2 | 4.9 | 4.9 | 5.0 | 5.0 |
| T % (320 nm) | 77.1 | 77.9 | 78.2 | 76.8 | 76.0 | 63.0 | 76.8 |

TABLE 20

| | | No. | No. | No. | No. | No. | No. | No. | No. |
|---|---|---|---|---|---|---|---|---|---|
| | | 286 | 287 | 288 | 289 | 290 | 291 | 292 | 293 |
| Glass | SiO₂ | 71.9 | 72.8 | 73.8 | 71.8 | 71.8 | 71.7 | 72.7 | 72.7 |
| composition | Al₂O₃ | 13.5 | 13.0 | 13.0 | 13.0 | 13.0 | 13.1 | 13.0 | 13.1 |
| (mol %) | B₂O₃ | 0.0 | 0.0 | 0.0 | 0.0 | 1.1 | 1.1 | 1.1 | 1.1 |
| | Li₂O | 0.000 | 0.000 | 0.000 | 0.000 | 0.000 | 0.000 | 0.000 | 0.000 |
| | Na₂O | 0.011 | 0.011 | 0.011 | 0.011 | 0.011 | 0.011 | 0.022 | 0.011 |
| | K₂O | 0.001 | 0.003 | 0.003 | 0.003 | 0.002 | 0.002 | 0.002 | 0.003 |
| | MgO | 5.5 | 3.0 | 2.5 | 4.5 | 4.5 | 5.0 | 4.0 | 4.5 |
| | CaO | 5.5 | 7.0 | 6.5 | 6.5 | 5.5 | 5.0 | 5.0 | 4.5 |
| | SrO | 1.0 | 2.0 | 2.0 | 2.0 | 2.0 | 2.0 | 2.0 | 2.0 |
| | BaO | 2.5 | 2.0 | 2.0 | 2.0 | 2.0 | 2.0 | 2.0 | 2.0 |
| | SnO₂ | 0.1 | 0.1 | 0.1 | 0.1 | 0.1 | 0.1 | 0.1 | 0.1 |
| | Fe₂O₃ | 0.007 | 0.007 | 0.007 | 0.007 | 0.008 | 0.007 | 0.007 | 0.007 |
| | TiO₂ | 0.008 | 0.008 | 0.008 | 0.008 | 0.008 | 0.008 | 0.008 | 0.008 |
| | ZrO₂ | 0.001 | 0.001 | 0.002 | 0.001 | 0.001 | 0.001 | 0.001 | 0.001 |
| | MoO₃ | 0.00093 | 0.00028 | 0.00038 | 0.00084 | 0.00070 | 0.00065 | 0.00089 | 0.00061 |
| Glass | MoO₃ | 20 | 6 | 8 | 18 | 15 | 14 | 19 | 13 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.012 | 0.014 | 0.014 | 0.014 | 0.013 | 0.013 | 0.024 | 0.014 |
| MgO + CaO + SrO + | 14.5 | 14.0 | 13.1 | 15.0 | 14.0 | 14.0 | 13.1 | 13.1 |
| BaO | | | | | | | | |
| mol % ratio | 7.19 | 23.96 | 18.00 | 8.07 | 10.79 | 10.95 | 7.56 | 11.11 |
| Fe₂O₃/MoO₃ | | | | | | | | |
| mol % ratio | 8.09 | 26.94 | 20.25 | 9.07 | 10.79 | 11.59 | 8.50 | 12.49 |
| TiO₂/MoO₃ | | | | | | | | |
| CTE [×10⁻⁷/° C.] | 34.7 | 36.4 | 35.0 | 36.9 | 35.2 | 34.6 | 33.8 | 33.3 |
| ρ [g/cm³] | 2.568 | 2.563 | 2.553 | 2.574 | 2.555 | 2.553 | 2.544 | 2.543 |
| E [GPa] | 85 | 84 | 83 | 84 | 83 | 84 | 83 | 83 |
| E/ρ [GPa/g · cm⁻³] | 33.2 | 32.6 | 32.5 | 32.8 | 32.6 | 32.8 | 32.6 | 32.7 |
| Ps [° C.] | 770 | 778 | 784 | 769 | 759 | 758 | 763 | 763 |
| Ta [° C.] | 831 | 839 | 847 | 829 | 820 | 819 | 826 | 825 |
| Ts [° C.] | 1066 | 1079 | 1091 | 1065 | 1060 | 1058 | 1070 | 1070 |
| 10⁴ dPa · s [° C.] | 1392 | 1405 | 1425 | 1385 | 1385 | 1388 | 1405 | 1404 |
| 10³ dPa · s[° C.] | 1555 | 1572 | 1593 | 1550 | 1550 | 1553 | 1572 | 1570 |
| 10^{2.5} dPa · s [° C.] | 1659 | 1678 | 1700 | 1658 | 1654 | 1658 | 1679 | 1676 |
| TL [° C.] | 1277 | 1281 | 1286 | 1261 | 1234 | 1250 | 1277 | 1291 |
| Log₁₀ ηTL | 5.0 | 5.1 | 5.2 | 5.1 | 5.3 | 5.2 | 5.1 | 4.9 |
| T % (320 nm) | 76.9 | 76.9 | 76.9 | 76.8 | 75.3 | 76.0 | 76.9 | 76.8 |

| | | No. | No. | No. | No. | No. | No. | No. |
|---|---|---|---|---|---|---|---|---|
| | | 294 | 295 | 296 | 297 | 298 | 299 | 300 |
| Glass | SiO₂ | 73.7 | 71.2 | 71.2 | 70.8 | 71.3 | 71.8 | 72.8 |
| composition | Al₂O₃ | 13.1 | 13.0 | 13.5 | 13.5 | 13.2 | 13.0 | 13.0 |
| (mol %) | B₂O₃ | 1.1 | 0.6 | 1.1 | 1.0 | 0.0 | 0.0 | 1.0 |
| | Li₂O | 0.000 | 0.000 | 0.000 | 0.000 | 0.000 | 0.000 | 0.000 |
| | Na₂O | 0.011 | 0.011 | 0.032 | 0.022 | 0.011 | 0.011 | 0.011 |
| | K₂O | 0.001 | 0.002 | 0.004 | 0.003 | 0.002 | 0.003 | 0.002 |
| | MgO | 3.5 | 5.3 | 4.6 | 4.6 | 5.6 | 5.1 | 3.1 |
| | CaO | 4.5 | 5.7 | 5.5 | 6.0 | 5.8 | 6.0 | 6.0 |
| | SrO | 2.0 | 2.0 | 2.0 | 2.0 | 2.0 | 2.0 | 2.0 |
| | BaO | 2.0 | 2.0 | 2.0 | 2.0 | 2.0 | 2.0 | 2.0 |
| | SnO₂ | 0.1 | 0.1 | 0.1 | 0.1 | 0.1 | 0.1 | 0.1 |
| | Fe₂O₃ | 0.006 | 0.006 | 0.005 | 0.005 | 0.005 | 0.005 | 0.005 |
| | TiO₂ | 0.008 | 0.008 | 0.007 | 0.007 | 0.008 | 0.008 | 0.007 |
| | ZrO₂ | 0.001 | 0.001 | 0.001 | 0.001 | 0.001 | 0.001 | 0.001 |
| | MoO₃ | 0.00038 | 0.00056 | 0.00084 | 0.00066 | 0.00089 | 0.00061 | 0.00038 |
| Glass | MoO₃ | 8 | 12 | 18 | 14 | 19 | 13 | 8 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.013 | 0.037 | 0.025 | 0.013 | 0.014 | 0.013 |
| MgO + CaO + SrO + | 12.1 | 15.0 | 14.1 | 14.6 | 15.4 | 15.1 | 13.1 |
| BaO | | | | | | | |
| mol % ratio | 16.82 | 11.35 | 6.46 | 7.72 | 5.73 | 9.01 | 14.53 |
| Fe₂O₃/MoO₃ | | | | | | | |
| mol % ratio | 22.42 | 13.61 | 7.95 | 10.29 | 8.59 | 12.46 | 17.88 |
| TiO₂/MoO₃ | | | | | | | |
| CTE [×10⁻⁷/° C.] | 32.6 | 35.9 | 34.8 | 35.8 | 36.3 | 36.2 | 34.6 |
| ρ [g/cm³] | 2.533 | 2.568 | 2.560 | 2.566 | 2.577 | 2.572 | 2.546 |
| E [GPa] | 82 | 85 | 84 | 84 | 85 | 85 | 82 |
| E/ρ [GPa/g · cm⁻³] | 32.6 | 32.9 | 32.7 | 32.7 | 33.1 | 32.9 | 32.3 |
| Ps [° C.] | 768 | 761 | 761 | 759 | 768 | 769 | 766 |
| Ta [° C.] | 832 | 819 | 820 | 818 | 826 | 827 | 827 |
| Ts [° C.] | 1081 | 1056 | 1058 | 1054 | 1059 | 1064 | 1073 |
| 10⁴ dPa · s [° C.] | 1420 | 1380 | 1382 | 1376 | 1380 | 1389 | 1409 |
| 10³ dPa · s[° C.] | 1592 | 1546 | 1545 | 1538 | 1542 | 1552 | 1576 |
| 10^{2.5} dPa · s [° C.] | 1703 | 1656 | 1649 | 1642 | 1644 | 1656 | 1684 |
| TL [° C.] | 1340 | 1243 | 1267 | 1240 | 1249 | 1240 | 1254 |
| Log₁₀ ηTL | 4.6 | 5.2 | 5.0 | 5.2 | 5.1 | 5.3 | 5.3 |
| T % (320 nm) | 77.7 | 77.6 | 79.3 | 80.1 | 80.0 | 79.3 | 79.3 |

TABLE 21

| | | No. | No. | No. | No. | No. | No. | No. | No. |
|---|---|---|---|---|---|---|---|---|---|
| | | 301 | 302 | 303 | 304 | 305 | 306 | 307 | 308 |
| Glass | SiO₂ | 72.8 | 71.4 | 70.9 | 70.9 | 70.9 | 70.8 | 70.9 | 70.9 |
| composition | Al₂O₃ | 13.0 | 13.5 | 13.0 | 13.0 | 13.0 | 13.0 | 13.0 | 13.0 |
| (mol %) | B₂O₃ | 0.0 | 0.0 | 2.0 | 1.9 | 1.9 | 2.0 | 1.9 | 1.8 |
| | Li₂O | 0.000 | 0.000 | 0.000 | 0.000 | 0.000 | 0.000 | 0.000 | 0.000 |
| | Na₂O | 0.011 | 0.022 | 0.010 | 0.011 | 0.011 | 0.011 | 0.011 | 0.011 |
| | K₂O | 0.002 | 0.003 | 0.002 | 0.002 | 0.002 | 0.002 | 0.001 | 0.001 |
| | MgO | 4.1 | 5.3 | 7.0 | 5.5 | 5.5 | 4.0 | 4.0 | 4.0 |
| | CaO | 6.0 | 5.8 | 5.0 | 6.5 | 5.0 | 8.0 | 6.5 | 5.0 |
| | SrO | 2.0 | 2.0 | 1.0 | 1.0 | 2.5 | 1.0 | 2.5 | 4.0 |
| | BaO | 2.0 | 2.0 | 1.0 | 1.0 | 1.0 | 1.0 | 1.0 | 1.0 |
| | SnO₂ | 0.1 | 0.1 | 0.1 | 0.1 | 0.1 | 0.1 | 0.1 | 0.1 |
| | Fe₂O₃ | 0.006 | 0.005 | 0.006 | 0.006 | 0.006 | 0.006 | 0.006 | 0.006 |
| | TiO₂ | 0.008 | 0.007 | 0.006 | 0.008 | 0.007 | 0.008 | 0.007 | 0.008 |
| | ZrO₂ | 0.001 | 0.001 | 0.001 | 0.001 | 0.001 | 0.001 | 0.001 | 0.001 |
| | MoO₃ | 0.00056 | 0.00047 | 0.00023 | 0.00357 | 0.00055 | 0.00028 | 0.00070 | 0.00094 |
| Glass | MoO₃ | 12 | 10 | 5 | 78 | 12 | 6 | 15 | 20 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.013 | 0.025 | 0.012 | 0.013 | 0.013 | 0.013 | 0.012 | 0.012 |
| MgO + CaO + SrO + | 14.1 | 15.1 | 14.0 | 14.1 | 14.1 | 14.1 | 14.1 | 14.1 |
| BaO | | | | | | | | |
| mol % ratio | 9.82 | 11.74 | 24.72 | 1.61 | 10.41 | 21.20 | 8.33 | 6.25 |
| Fe₂O₃/MoO₃ | | | | | | | | |
| mol % ratio | 13.59 | 14.44 | 28.24 | 2.30 | 13.38 | 27.24 | 10.70 | 8.03 |
| TiO₂/MoO₃ | | | | | | | | |
| CTE [×10⁻⁷/° C.] | 35.4 | 36.0 | 32.6 | 33.9 | 34.2 | 34.9 | 35.5 | 35.9 |
| ρ [g/cm³] | 2.561 | 2.577 | 2.500 | 2.504 | 2.526 | 2.508 | 2.529 | 2.551 |
| E [GPa] | 84 | 85 | 85 | 84 | 83 | 83 | 83 | 82 |
| E/ρ [GPa/g · cm⁻³] | 32.8 | 33.1 | 33.9 | 33.5 | 33.0 | 33.2 | 32.7 | 32.3 |
| Ps [° C.] | 776 | 770 | 748 | 749 | 748 | 750 | 751 | 751 |
| Ta [° C.] | 836 | 829 | 806 | 807 | 807 | 809 | 810 | 810 |
| Ts [° C.] | 1076 | 1062 | 1040 | 1042 | 1043 | 1043 | 1046 | 1047 |
| 10⁴ dPa · s [° C.] | 1409 | 1382 | 1357 | 1359 | 1361 | 1362 | 1367 | 1371 |
| 10³ dPa · s[° C.] | 1574 | 1544 | 1518 | 1520 | 1526 | 1524 | 1530 | 1534 |
| 10^{2.5} dPa · s [° C.] | 1683 | 1648 | 1618 | 1624 | 1630 | 1627 | 1633 | 1637 |
| TL [° C.] | 1250 | 1242 | 1285 | 1258 | 1249 | 1240 | 1225 | 1233 |
| Log₁₀ ηTL | 5.4 | 5.2 | 4.6 | 4.9 | 5.0 | 5.1 | 5.3 | 5.2 |
| T % (320 nm) | 79.2 | 79.2 | 78.7 | 78.4 | 78.6 | 78.4 | 78.6 | 78.6 |

| | | No. | No. | No. | No. | No. | No. | No. |
|---|---|---|---|---|---|---|---|---|
| | | 309 | 310 | 311 | 312 | 313 | 314 | 315 |
| Glass | SiO₂ | 70.8 | 70.9 | 70.7 | 70.8 | 70.9 | 70.9 | 70.7 |
| composition | Al₂O₃ | 13.0 | 13.0 | 12.9 | 12.9 | 13.0 | 12.9 | 13.0 |
| (mol %) | B₂O₃ | 2.0 | 1.9 | 2.2 | 2.1 | 2.0 | 2.0 | 2.2 |
| | Li₂O | 0.000 | 0.000 | 0.000 | 0.000 | 0.000 | 0.000 | 0.000 |
| | Na₂O | 0.011 | 0.011 | 0.011 | 0.011 | 0.011 | 0.011 | 0.011 |
| | K₂O | 0.001 | 0.001 | 0.001 | 0.001 | 0.001 | 0.002 | 0.001 |
| | MgO | 5.5 | 4.0 | 4.0 | 5.5 | 4.0 | 4.0 | 4.1 |
| | CaO | 5.0 | 6.5 | 5.0 | 3.5 | 5.0 | 3.5 | 6.9 |
| | SrO | 1.0 | 1.0 | 1.0 | 2.5 | 2.5 | 4.0 | 2.0 |
| | BaO | 2.5 | 2.5 | 4.0 | 2.5 | 2.5 | 2.5 | 1.0 |
| | SnO₂ | 0.1 | 0.1 | 0.1 | 0.1 | 0.1 | 0.1 | 0.1 |
| | Fe₂O₃ | 0.006 | 0.005 | 0.005 | 0.006 | 0.006 | 0.006 | 0.005 |
| | TiO₂ | 0.008 | 0.008 | 0.008 | 0.009 | 0.009 | 0.009 | 0.008 |
| | ZrO₂ | 0.001 | 0.001 | 0.001 | 0.001 | 0.001 | 0.001 | 0.001 |
| | MoO₃ | 0.00075 | 0.00047 | 0.00086 | 0.00071 | 0.00066 | 0.00091 | 0.00092 |
| Glass | MoO₃ | 16 | 10 | 18 | 15 | 14 | 19 | 20 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.012 | 0.012 | 0.013 | 0.012 | 0.013 | 0.013 |
| MgO + CaO + SrO + | 14.1 | 14.1 | 14.1 | 14.1 | 14.0 | 14.1 | 14.0 |
| BaO | | | | | | | |
| mol % ratio | 7.36 | 11.67 | 6.37 | 7.92 | 8.34 | 6.11 | 5.61 |
| Fe₂O₃/MoO₃ | | | | | | | |
| mol % ratio | 10.19 | 16.15 | 8.82 | 12.17 | 12.82 | 9.39 | 8.42 |
| TiO₂/MoO₃ | | | | | | | |
| CTE [×10⁻⁷/° C.] | 34.4 | 35.6 | 36.3 | 35.0 | 36.1 | 36.4 | 35.1 |
| ρ [g/cm³] | 2.546 | 2.549 | 2.589 | 2.568 | 2.571 | 2.592 | 2.523 |
| E [GPa] | 83 | 82 | 81 | 82 | 82 | 81 | 83 |
| E/ρ [GPa/g · cm⁻³] | 32.6 | 32.3 | 31.3 | 32.1 | 31.8 | 31.4 | 32.8 |
| Ps [° C.] | 749 | 748 | 748 | 748 | 749 | 749 | 748 |
| Ta [° C.] | 808 | 808 | 808 | 808 | 809 | 810 | 807 |
| Ts [° C.] | 1045 | 1046 | 1050 | 1047 | 1049 | 1051 | 1046 |
| 10⁴ dPa · s [° C.] | 1369 | 1371 | 1378 | 1372 | 1377 | 1380 | 1367 |
| 10³ dPa · s[° C.] | 1531 | 1534 | 1543 | 1537 | 1541 | 1545 | 1532 |
| 10^{2.5} dPa · s [° C.] | 1635 | 1638 | 1648 | 1644 | 1646 | 1649 | 1638 |
| TL [° C.] | 1243 | 1201 | 1187 | 1241 | 1191 | 1218 | 1225 |
| Log₁₀ ηTL | 5.1 | 5.5 | 5.8 | 5.1 | 5.7 | 5.4 | 5.3 |
| T % (320 nm) | 79.2 | 79.3 | 79.5 | 79.1 | 79.3 | 79.4 | 79.7 |

TABLE 22

| | | No. | No. | No. | No. | No. | No. | No. | No. |
|---|---|---|---|---|---|---|---|---|---|
| | | 316 | 317 | 318 | 319 | 320 | 321 | 322 | 323 |
| Glass | SiO₂ | 70.7 | 70.8 | 70.8 | 70.8 | 70.8 | 72.4 | 72.3 | 71.3 |
| composition | Al₂O₃ | 13.0 | 13.6 | 13.5 | 13.5 | 13.5 | 13.0 | 13.0 | 13.5 |
| (mol %) | B₂O₃ | 2.2 | 2.9 | 2.9 | 3.0 | 2.9 | 2.9 | 3.0 | 3.0 |
| | Li₂O | 0.000 | 0.000 | 0.000 | 0.000 | 0.000 | 0.000 | 0.000 | 0.000 |
| | Na₂O | 0.032 | 0.011 | 0.010 | 0.011 | 0.011 | 0.011 | 0.010 | 0.011 |
| | K₂O | 0.002 | 0.003 | 0.001 | 0.002 | 0.001 | 0.002 | 0.001 | 0.002 |
| | MgO | 4.1 | 5.1 | 5.1 | 3.6 | 3.6 | 4.6 | 4.6 | 5.1 |
| | CaO | 7.5 | 7.5 | 6.0 | 9.0 | 7.5 | 7.0 | 5.5 | 7.0 |
| | SrO | 1.5 | 0.0 | 1.5 | 0.0 | 1.5 | 0.0 | 1.5 | 0.0 |
| | BaO | 1.0 | 0.0 | 0.0 | 0.0 | 0.0 | 0.0 | 0.0 | 0.0 |
| | SnO₂ | 0.1 | 0.1 | 0.1 | 0.1 | 0.1 | 0.1 | 0.1 | 0.1 |
| | Fe₂O₃ | 0.006 | 0.006 | 0.006 | 0.006 | 0.006 | 0.006 | 0.006 | 0.006 |
| | TiO₂ | 0.007 | 0.007 | 0.007 | 0.007 | 0.008 | 0.015 | 0.008 | 0.016 |
| | ZrO₂ | 0.002 | 0.001 | 0.001 | 0.002 | 0.001 | 0.001 | 0.001 | 0.001 |
| | MoO₃ | 0.00037 | 0.00054 | 0.00036 | 0.00023 | 0.00032 | 0.00040 | 0.00032 | 0.00234 |
| Glass | MoO₃ | 8 | 12 | 8 | 5 | 7 | 9 | 7 | 52 |
| composition | | | | | | | | | |
| (ppm by | | | | | | | | | |
| mass) | | | | | | | | | |

| | | | | | | | | |
|---|---|---|---|---|---|---|---|---|
| Li₂O + Na₂O + K₂O | 0.034 | 0.013 | 0.012 | 0.013 | 0.012 | 0.013 | 0.012 | 0.013 |
| MgO + CaO + SrO + | 14.0 | 12.6 | 12.7 | 12.6 | 12.6 | 11.6 | 11.6 | 12.1 |
| BaO | | | | | | | | |
| mol % ratio | 15.84 | 11.52 | 15.62 | 27.25 | 17.85 | 14.28 | 17.85 | 2.45 |
| Fe₂O₃/MoO₃ | | | | | | | | |
| mol % ratio | 20.35 | 13.81 | 20.07 | 32.69 | 25.50 | 36.70 | 25.49 | 6.64 |
| TiO₂/MoO₃ | | | | | | | | |
| CTE [×10⁻⁷/° C.] | 35.0 | 31.1 | 31.5 | 32.2 | 32.6 | 29.8 | 30.1 | 30.1 |
| ρ [g/cm³] | 2.516 | 2.446 | 2.468 | 2.449 | 2.471 | 2.429 | 2.451 | 2.439 |
| E [GPa] | 83 | 83 | 83 | 83 | 82 | 83 | 82 | 83 |
| E/ρ [GPa/g · cm⁻³] | 32.9 | 34.1 | 33.7 | 33.9 | 33.4 | 34.1 | 33.6 | 34.2 |
| Ps [° C.] | 749 | 746 | 744 | 749 | 747 | 747 | 744 | 748 |
| Ta [° C.] | 808 | 804 | 803 | 807 | 806 | 807 | 804 | 807 |
| Ts [° C.] | 1044 | 1037 | 1039 | 1041 | 1043 | 1048 | 1048 | 1042 |
| 10⁴ dPa · s [° C.] | 1366 | 1356 | 1358 | 1357 | 1362 | 1374 | 1379 | 1360 |
| 10³ dPa · s[° C.] | 1529 | 1517 | 1520 | 1518 | 1524 | 1539 | 1546 | 1523 |
| 10^{2.5} dPa · s [° C.] | 1632 | 1617 | 1620 | 1618 | 1627 | 1643 | 1651 | 1626 |
| TL [° C.] | 1236 | 1361 | 1357 | 1333 | 1320 | 1378 | 1383 | 1377 |
| Log₁₀ ηTL | 5.1 | 4.0 | 4.0 | 4.2 | 4.3 | 4.0 | 4.0 | 3.9 |
| T % (320 nm) | 78.4 | 77.4 | 78.6 | 77.6 | 78.6 | 78.3 | 78.6 | 78.3 |

| | | No. | No. | No. | No. | No. | No. | No. |
|---|---|---|---|---|---|---|---|---|
| | | 324 | 325 | 326 | 327 | 328 | 329 | 330 |
| Glass | SiO₂ | 71.3 | 71.3 | 71.3 | 71.3 | 70.8 | 70.1 | 66.2 |
| composition | Al₂O₃ | 13.5 | 13.5 | 13.5 | 13.4 | 13.0 | 12.6 | 12.8 |
| (mol %) | B₂O₃ | 3.0 | 3.0 | 3.0 | 0.0 | 1.9 | 0.7 | 6.3 |
| | Li₂O | 0.000 | 0.000 | 0.000 | 0.000 | 0.000 | 0.000 | 0.000 |
| | Na₂O | 0.010 | 0.011 | 0.011 | 0.011 | 0.011 | 0.011 | 0.015 |
| | K₂O | 0.001 | 0.001 | 0.001 | 0.001 | 0.001 | 0.002 | 0.002 |
| | MgO | 5.1 | 3.6 | 3.6 | 5.3 | 4.0 | 5.7 | 4.2 |
| | CaO | 5.5 | 8.5 | 7.0 | 5.8 | 6.5 | 4.6 | 7.6 |
| | SrO | 1.5 | 0.0 | 1.5 | 2.0 | 2.6 | 2.2 | 0.3 |
| | BaO | 0.0 | 0.0 | 0.0 | 2.0 | 1.0 | 4.0 | 2.5 |
| | SnO₂ | 0.1 | 0.1 | 0.1 | 0.1 | 0.1 | 0.1 | 0.1 |
| | Fe₂O₃ | 0.006 | 0.006 | 0.006 | 0.005 | 0.005 | 0.004 | 0.005 |
| | TiO₂ | 0.008 | 0.016 | 0.015 | 0.007 | 0.007 | 0.007 | 0.007 |
| | ZrO₂ | 0.001 | 0.001 | 0.001 | 0.001 | 0.001 | 0.001 | 0.070 |
| | MoO₃ | 0.00068 | 0.00090 | 0.00073 | 0.00070 | 0.00046 | 0.00144 | 0.00141 |
| Glass | MoO₃ | 15 | 20 | 16 | 15 | 10 | 30 | 30 |
| composition | | | | | | | | |
| (ppm by | | | | | | | | |
| mass) | | | | | | | | |

| | | | | | | | |
|---|---|---|---|---|---|---|---|
| Li₂O + Na₂O + K₂O | 0.012 | 0.012 | 0.012 | 0.012 | 0.012 | 0.013 | 0.017 |
| MgO + CaO + SrO + | 12.1 | 12.1 | 12.1 | 15.1 | 14.1 | 16.5 | 14.6 |
| BaO | | | | | | | |
| mol % ratio | 8.31 | 6.35 | 7.82 | 7.77 | 11.79 | 2.79 | 3.55 |
| Fe₂O₃/MoO₃ | | | | | | | |
| mol % ratio | 11.87 | 17.23 | 20.09 | 9.55 | 14.50 | 4.67 | 4.98 |
| TiO₂/MoO₃ | | | | | | | |
| CTE [×10⁻⁷/° C.] | 30.6 | 31.4 | 31.6 | 35.9 | 35.3 | 39.2 | 37.0 |
| ρ [g/cm³] | 2.461 | 2.443 | 2.465 | 2.577 | 2.530 | 2.643 | 2.522 |
| E [GPa] | 83 | 83 | 82 | 85 | 83 | 83 | 78 |
| E/ρ [GPa/g · cm⁻³] | 33.7 | 33.9 | 33.4 | 33.2 | 32.7 | 31.4 | 30.9 |
| Ps [° C.] | 746 | 751 | 747 | 770 | 749 | 749 | 687 |
| Ta [° C.] | 805 | 810 | 807 | 828 | 809 | 807 | 743 |
| Ts [° C.] | 1042 | 1044 | 1045 | 1061 | 1045 | 1041 | 977 |
| 10⁴ dPa · s [° C.] | 1363 | 1366 | 1369 | 1383 | 1368 | 1365 | 1285 |
| 10³ dPa · s[° C.] | 1525 | 1529 | 1532 | 1545 | 1531 | 1528 | 1440 |
| 10^{2.5} dPa · s [° C.] | 1628 | 1631 | 1635 | 1650 | 1635 | 1632 | 1540 |
| TL [° C.] | 1381 | 1361 | 1357 | 1257 | 1229 | 1215 | 1123 |
| Log₁₀ ηTL | 3.9 | 4.0 | 4.1 | 5.1 | 5.2 | 5.3 | 5.6 |
| T % (320 nm) | 78.6 | 78.4 | 78.6 | 79.3 | 79.2 | 82.3 | 80.2 |

First, glass raw materials were mixed to give a glass composition presented in the tables, and the glass batch was charged into a platinum crucible and melted at a temperature of from 1550° C. to 1680° C. for 24 hours. At the time of melting, the glass batch was homogenized by stirring with a platinum stirrer. Next, the molten glass was poured onto a carbon sheet, formed into a sheet shape, and then annealed at a temperature near the annealing point for 30 minutes. Each of the obtained samples was evaluated for the average thermal expansion coefficient CTE in a temperature range of from 30° C. to 380° C., the density ρ, the Young's modulus E, the specific Young's modulus E/ρ, the strain point Ps, the annealing point Ta, the softening point Ts, the temperature at a viscosity in high temperature of 10⁴ dPa·s, the temperature at a viscosity in high temperature of 10³ dPa·s, the temperature at a viscosity in high temperature of 10^{2.5} dPa·s, the liquidus temperature TL, the viscosity log₁₀ ηTL at the liquidus temperature TL, and the transmittance at 320 nm (T % (320 nm)).

The average thermal expansion coefficient CTE in a temperature range of from 30° C. to 380° C. is a value measured with a dilatometer.

The density ρ is a value measured using the well-known Archimedes method.

The Young's modulus E refers to a value measured by a well-known resonance method.

The specific Young's modulus E/ρ is a value obtained by dividing the Young's modulus by the density.

The strain point Ps, the annealing point Ta, and the softening point Ts are values measured based on methods in ASTM C336 and C338.

The temperatures at a viscosity in high temperature of 10⁴ dPa·s, 10³ dPa·s, and 10^{2.5} dPa·s are values measured by a platinum sphere pull up method.

The liquidus temperature TL is a temperature at which crystals precipitate after a glass powder that has passed through a standard 30-mesh sieve (500 μm) and remained on a 50-mesh sieve (300 μm) is charged into a platinum boat and then kept in a temperature gradient furnace for 24 hours.

The liquidus viscosity log₁₀ ηTL is a value obtained by measuring the viscosity of glass at the liquidus temperature TL by a platinum sphere pull up method.

The transmittance at 320 nm (T % (320 nm)) is a value measured by preparing a glass having a sheet thickness of 0.5 mm and measuring it with a UV3100 manufactured by Shimadzu Corporation.

As is clear from the tables, in Sample Nos. 1 to 330, since the glass composition is regulated within a predetermined range, the Young's modulus is 72 GPa or more, the strain point is 651° C. or higher, the liquidus temperature is 1388° C. or lower, and the liquidus viscosity is 10^{3.3} dPa·s or more. Thus, Sample Nos. 1 to 330 are excellent in productivity and sufficiently high in strain point and Young's modulus, and are thus suitable for substrates of organic EL devices.

### INDUSTRIAL APPLICABILITY

The alkali-free glass sheet according to the present invention is suitable as a substrate of a display panel for an organic EL device, particularly, an organic EL television, or a carrier for manufacturing an organic EL display panel, and is also suitable as a substrate of a flat panel display such as a liquid crystal display, cover glass for an image sensor such as a charge-coupled device (CCD) or an equal-size contact solid state image sensor (CIS), a substrate and cover glass for a solar cell, a substrate for an organic EL illumination, and the like.

In addition, the alkali-free glass sheet according to the present invention is sufficiently high in strain point and Young's modulus, and is thus also suitable as a glass substrate for a magnetic recording medium. When the strain point is high, the glass sheet is less likely to deform even when a heat treatment at a high temperature such as a thermally assisted treatment or laser irradiation is performed. As a result, in the case of achieving a high Ku, a higher heat treatment temperature can be adopted, making it easier to manufacture a magnetic recording device having a high recording density. In addition, when the Young's modulus is high, warping and flapping (that is, fluttering) of the glass substrate is less likely to occur during high-speed rotation, making it possible to prevent collision between the magnetic recording medium and the magnetic head.

### REFERENCE SIGNS LIST

1 disk substrate (glass substrate for magnetic recording medium)

1: An alkali-free glass sheet comprising, as a glass composition, in mol %, from 60% to 77% of SiO₂, from 8% to 20% of Al₂O₃, from 0% to 10% of B₂O₃, from 0% to 0.5% of Li₂O+Na₂O+K₂O, from 0% to 12% of MgO, from 0% to 12% of CaO, from 0% to 12% of SrO, from 0% to 12% of BaO, from 10% to 25% of MgO+CaO+SrO+BaO, and from 0.1 ppm by mass to 1000 ppm by mass of MoO₃.

2: An alkali-free glass sheet comprising, as a glass composition, in mol %, from 65% to 77% of SiO₂, from 10% to 17% of Al₂O₃, from 0% to 9% of B₂O₃, from 0% to 0.5% of Li₂O+Na₂O+K₂O, from 0% to 12% of MgO, from 0% to 12% of CaO, from 0% to 10% of SrO, from 0% to 10% of BaO, from 10% to 25% of MgO+CaO+SrO+BaO, and from 0.1 ppm by mass to 1000 ppm by mass of MoO₃.

3: The alkali-free glass sheet according to claim 1, wherein the glass composition does not substantially contain As₂O₃ and Sb₂O₃, and further contains from 0.001 mol % to 1 mol % of SnO₂.

4: The alkali-free glass sheet according to claim 1, wherein a mol % ratio Fe₂O₃/MoO₃ is from 0.001 to 1.5 as a glass composition.

5: The alkali-free glass sheet according to claim 1, wherein a mol % ratio TiO₂/MoO₃ is from 0.001 to 1.5 as a glass composition.

6: The alkali-free glass sheet according to claim 1, wherein a Young's modulus is 70 GPa or more, a strain point is 650° C. or higher, and a liquidus temperature is 1400° C. or lower.

7: The alkali-free glass sheet according to claim 1, wherein a strain point is 700° C. or higher.

8: The alkali-free glass sheet according to claim 1, wherein a Young's modulus is more than 75 GPa.

9: The alkali-free glass sheet according to claim 1, wherein a specific Young's modulus is 30 GPa/g·cm⁻³ or more.

10: The alkali-free glass sheet according to claim 1, wherein an average thermal expansion coefficient in a temperature range of from 30° C. to 380° C. is from 30×10⁻⁷/° C. to 50×10⁻⁷/° C.

11: The alkali-free glass sheet according to claim 1, wherein an annealing point is 730° C. or higher.

12: The alkali-free glass sheet according to claim 1, wherein a liquidus viscosity is 10^{3.3} dPa·s or more.

13: The alkali-free glass sheet according to claim 1, which is for use in an organic EL device.

14: The alkali-free glass sheet according to claim 1, which is for use in a magnetic recording medium.
